(19) United States
(12) Patent Application Publication
(10) Pub. No.: US 2009/0251203 A1
(43) Pub. Date: Oct. 8, 2009

(54) REFERENCE VOLTAGE CIRCUIT

(75) Inventor: Katsuji KIMURA, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki (JP)

(21) Appl. No.: 12/418,273

(22) Filed: Apr. 3, 2009

(30) Foreign Application Priority Data
Apr. 4, 2008 (JP) 2008-098298

(51) Int. Cl. G05F 1/10

(52) U.S. Cl. 327/538

(57) ABSTRACT

Disclosed is a reference voltage circuit including a first I-V(current-to-voltage) converter, a second I-V converter, a current mirror and a control circuit. The first I-V converter includes a parallel connection of a diode and a resistor, and the second I-V converter includes parallel-connected diodes, series-connected resistors connected in parallel with the diodes, and a resistor connected between the diodes and the ground. The current mirror supplies currents to the first and second I-V converters. The control circuit controls so that a preset output voltages of the first and second I-V converters will be equal. A mid-point terminal voltage of the first or second I-V converter is used as a reference voltage Vref.

### REFERENCE TO RELATED APPLICATION

This application is based upon and claims the benefit of the priority of Japanese patent application No. 2008-098298, filed on Apr. 4, 2008, the disclosure of which is incorporated herein in its entirety by reference thereto.

### TECHNICAL FIELD

This invention relates to a CMOS reference voltage circuit and, more particularly, to a CMOS reference voltage circuit of a small area and a small temperature characteristic when formed on a semiconductor integrated circuit and which operates from a low voltage to supply a reference voltage of not higher than IV.

### BACKGROUND

A reference voltage circuit outputting a temperature-compensated reference voltage of the order of 1.2V has so far been customary. U.S. Pat. No. 3,617,859 (R. C. Dobkin and R. J. Widlar, “Electrical Regulator Apparatus Including a Zero Temperature Coefficient Voltage Reference Circuit” (Nov. 2, 1971) has disclosed a well-known reference voltage circuit (see FIG. 1). From a thesis appearing in IEEE in the sole name of Widlar, this reference voltage circuit is now known with the name of Widlar who is a co-inventor or a second inventor. This might be said to be a perplexing situation.

Dobkin et al. in UP Patent is the U.S. Pat. No. 3,617,859, with the name of Widlar being not appearing. The Widlar voltage reference, however, denotes the circuit stated in ISSCC '78 (see FIG. 2).

The circuit of FIG. 2 is asserted to output a temperature-compensated reference voltage of the order of 0.2V. This circuit has, however, been disregarded for the quarter of a century by many besides Widlar, the author. The reason may be such that circuit analysis has not been made, or there are used two resistors R1 and R4 that render the circuit analysis difficult.

The sole exception is Nagano (Patent Document 1: U.S. Pat. No. 4,319,180) that has disclosed a circuit operating under the same principle as the Widlar voltage reference. It should be noted in this connection that the operating principle of the Widlar voltage reference has been made clear in the ESSCIRC'2006. The Nagano's case was filed in June 1979 under a filing number of 54-80099 (JP Patent Kokai Publication No. JP-A-56-4818). The operating principle of the Widlar voltage reference is discussed in detail in a readily intelligible manner in the specification of the gazette of JP Patent Kokai Publication No. JP-A-56-4818. However, this technology has been discounted and forgotten both at home and abroad.

In 1970s, ISSCC was a small conference, while the IEEE's journal of proceeding ‘Journal of Solid-State Circuits’ was issued only every other month. In addition, the number of 1C designers is limited. What is more noteworthy is that the power supply voltage at the time was usually high, as represented by 24V or 12V for car batteries, and was not lower than 8V. In 1980s, the power supply voltage of 5V was accepted in general. In 1990s, the power supply was decreased rapidly to 3.3V. At present, a power supply of 1.2V or even lower has become customary.

It is well-known that such lowering in the power supply voltage is a phenomenon attendant on miniaturization of the fabrication process of semiconductor integrated circuits. At the current technical stage, the ‘low voltage’ may be felt to become a minor matter. In the latter 1970s, an electronic device operating on a sole dry battery (pocket bell/pager) has made its debut. ‘RC-13’ (pocket bell) was put on sale in 1977, while ‘Walkman’ was put on sale in 1979. There is thus a sufficient reason the lecture on “Low Voltage Techniques” was presented in ISSCC'78 in 1978.

These concepts of Widlar and Nagano were discounted for a quarter of a century and have been presented again in ISCAS'2005.

If the power supply becomes IV or less, one may naturally seek after a reference voltage circuit operating at this power supply. A conventional reference voltage of 1.2V might have much to be desired and one might feel that even a reference voltage 0.2V or less would be usable.

One of the circuits of this sort is disclosed in Ozawa (Patent Document 2: U.S. Pat. No. 7,053,694) filed in August 2004. However, the circuit operation, described in the specification of Patent Document 2, appears to be dubious for the present inventor who has registered the largest number of patents for long in this technical field.

In continuation to JP Patent Kokai Publication No. JP2008-123480 (corresponding to JP patent application Nos. 2007-121032 and 2006-281619) and in JP Patent Application No. 2007-233003, not laid open as of the filing date of the present application, the present application provides a technique in which the Ozawa's circuit, as a basic circuit, has been improved to perform a more reliable operation.

The following is an analysis of the relevant art given by the present invention.

Reference voltage circuits, shown in FIGS. 5, 3 and 4, are now described in detail by way of illustrating circuits of the related art.

FIG. 5 shows a typical reference voltage circuit that outputs a reference voltage of 1.2V. Although the precise source of the circuit may not be clear, the circuit itself is widely known. One of conventional reference voltage circuits, outputting a reference voltage of 1.2V, is shown herein in FIG. 1. However, this circuit of FIG. 1 gives no useful results on analysis. Here, the circuit of FIG. 5, which is easier to understand, is analyzed.

The circuit of FIG. 5 includes a first current-to-voltage converter, comprised of a diode D1, and a second current-to-voltage converter (I-V2), comprised of an N-number of parallel-connected diodes D2 and a resistor R1 connected in series with the parallel connected diodes D2. The circuit of FIG. 5 also includes a third current-to-voltage converter, comprised of a series connection of a resistor R2 and a diode D3, and p-channel MOS transistors M1, M2 and M3, having sources connected to a power supply VDD and having gates connected in common to constitute a current mirror circuit. The circuit of FIG. 5 further includes an operational amplifier (OP amp) (AP1). This OP amp has an inverting terminal (−) connected to a junction of a drain of the transistor M1 and an anode of the diode D1, while having a non-inverting terminal (+) connected to a connection node of a drain of the transistor M2 and the resistor R1 and having an output connected to coupled gates of the MOS transistors M1 to M3. A reference voltage Vref is derived from a connection node of the drain of the transistor M3 and the resistor R2.

Let it be assumed that the current mirror ratio is equal, and that output currents I1, I2 and I3 of the transistors M1 to M3 are all equal to one another. The current I1 directly flows through the diode D1 of the first current-to-voltage converter (I-V1) so as to be converted to voltage. With the second current-to-voltage converter (I-V2), the current I2 flows via resistor R1 to the parallel connection of the diodes D2.

In FIG. 5, the OP amp exercises control so that VA=VB.

### Hence,

V_{A}=V_{F1}=V_{B} (1)

The current I2 is expressed by a difference between the forward voltage VF1 of the diode D1 and the forward voltage VF2 of the diode D2 divided by the resistance of resistor R1. Hence,

$$\begin{matrix}{I}_{1} = {I}_{2} \\ = {I}_{3} \\ = ( {V}_{F 1} - {V}_{F 2} ) / {R}_{1} \\ = Δ {V}_{F} / {R}_{1}\end{matrix} \qquad ( 2 )$$

With D1 as a diode, V_{F1}=V_{T}ln(I₁/I_{S}) and V_{F2}=V_{T}ln{I₁/(NI_{S})}, where I_{S} is a saturation current, V_{T} is a thermal temperature and given by V_{T}=kT/q, where T is an absolute temperature [K], k is the Bolzmann constant and q is the unit electron charge. Hence,

ΔV_{F}=V_{F1}−V_{F2}=V_{T}ln(N) (3)

Thus, we have:

Vref=V_{F3}+R₂I₃=V_{F3}+(R₂/R₁)V_{T}ln(N) (4)

Thus, in order for the reference voltage Vref to be a temperature-compensated voltage, the following equation:

$$\frac{\partial Vref}{\partial T} = \frac{\partial {V}_{F 3}}{\partial T} + \frac{{R}_{2}}{{R}_{1}} ln ( N ) \frac{\partial {V}_{T}}{\partial T} = \frac{\partial {V}_{F 3}}{\partial T} + \frac{{R}_{2}}{{R}_{1}} ln ( N ) \frac{k}{q} \qquad ( 5 )$$

has to hold.

V_{F3} has a temperature coefficient (characteristic) approximately equal to −1.9 mV/° C. The temperature coefficient of the thermal voltage is 0.0853 mV/° C. That is, the temperature coefficient of Vref may substantially be compensated by summing V_{F3} with the negative temperature coefficient and V_{T} having the positive temperature coefficient with weighting of (R2/R1)ln(N).

Thus, if, with V_{F3} set to 600 mV at the ambient temperature, the value of (R2/R1)ln(N) is set approximately to 23, it is possible to compensate the temperature characteristic in the equation (4).

In this case, the value of Vref is approximately 1.2V, That is, 1.2V≈600 mV+23×26 mV. It is seen that, if both sides of the equation (4) are divided by ((R₂/R₁)ln(N)=23), the result is

$$\frac{Vref}{\frac{{R}_{2}}{{R}_{1}} ln ( N ) } = \frac{{V}_{F 3}}{\frac{{R}_{2}}{{R}_{1}} ln ( N )} + {V}_{1} \approx 52 mV \qquad ( 6 )$$

The reference voltage circuit may not be a circuit that derives the band gap voltage 1.205V at 0K (zero absolute temperature) of silicon Si, and is simply a circuit that cancels out the negative temperature characteristic and the positive temperature characteristic. The fact is that the circuit shown in FIG. 1 or FIG. 5 happens to give a voltage approximate to the hand gap voltage 1.205V at 0K of silicon Si.

The operation of the reference circuit that outputs the reference voltage not higher than 250 mV has been described definitely for the first time by FIG. 3. This reference voltage circuit by Nagano is set to output a reference voltage of 200 mV.

Referring to FIG. 3, an emitter-grounded transistor Q7 has its base connected to a mid-point terminal of series-connected resistors R5 and R6. The transistor Q7 and the series-connected resistors R5 and R6 are driven by a constant current source lo which supplies 100 μA. Of the current of 100 μA, 50 μA flows through the transistor Q7 and 50 μA flows through the series-connected R5-R6.

A transistor Q8 is grounded via an emitter resistor R10, whilst transistors Q7 and Q8 form a Widlar current mirror circuit. The transistors Q9 and Q8 are connected together in cascode so that the common current flows through these transistors.

Hence, a current of 1.71 μA, which is about 1/29 of the current that flows through the transistor Q7, flows through the transistors Q8 and Q9.

The collector of transistor Q9 is directly connected to a power supply+Vcc so that its emitter outputs a reference voltage Vref (=200 mV).

In FIG. 3, if the bipolar transistors Q7 to Q9 are all unit-transistors,

Vref=(1+α)V_{BE7}−V_{BE9}=αV_{BE7}+ΔV_{BE} (7)

where

α=R5/R6 (α<1) (8)

and

$$Δ {V}_{BE} = {V}_{T} ln ( \frac{{I}_{C 7}}{{I}_{C 9}} ) . \qquad ( 9 )$$

where V_{T} denotes a thermal voltage.

Hence, in order for the reference voltage Vref to be a temperature-compensated voltage, the following equation:

$$\begin{matrix}\frac{\partial Vref}{\partial T} = α \frac{\partial {V}_{F 3}}{\partial T} + ln ( \frac{{I}_{C 7}}{{I}_{C 9}} ) \frac{\partial {V}_{T}}{\partial T} + {V}_{T} \frac{\partial }{\partial T} \{ ln ( \frac{{I}_{C 7}}{{I}_{C 9}} ) \} \\ = α \frac{\partial {V}_{F 3}}{\partial T} + ln ( \frac{{I}_{C 7}}{{I}_{C 9}} ) \frac{k}{q} + {V}_{T} \frac{\partial }{\partial T} \{ ln ( \frac{{I}_{C 7}}{{I}_{C 9}} ) \} \\ \approx 0\end{matrix} \qquad ( 10 )$$

has to hold.

In FIG. 3, the bipolar transistors Q7 and Q8 form a Widlar current mirror circuit. Hence, I_{C8}(=I_{C9}) has a positive temperature characteristic with respect to I_{C7}, with

$$\frac{\partial }{\partial T} \{ ln ( \frac{{I}_{C 7}}{{I}_{C 9}} ) \} < 0$$

with the gradient of ΔV_{BE} with respect to temperature increasing progressively with rise in temperature.

Conversely, the gradient (differential coefficient) of V_{BE} with respect to temperature

$$\frac{\partial {V}_{F 1}}{\partial T}$$

increases progressively with rise in temperature.

It is noted that the gradient of ΔV_{BE} with respect to temperature and the gradient of V_{BE} with respect to temperature are opposite to each other in sign. Hence, if a tangential line drawn to a curve of ΔV_{BE} at the maximum temperature is an asymptote, ΔV_{BE} of the equation (9) is at a position appreciably higher than the asymptote at lower temperatures, and progressively approaches to the asymptote. That is, the reference voltage circuit may be considered to have the function of improving the temperature non-linearity of V_{BE} of the bipolar transistor.

Thus, although Widlar has named the reference voltage circuit of FIG. 2 a curvature-corrected reference, the reference voltage circuit of Nagano, shown in FIG. 3, may be worthier of the name.

Also, from the equations (7) to (10), we have:

$$\frac{Vref}{ln ( \frac{{I}_{C 7 }}{{I}_{C 9}} )} = \frac{{V}_{BE 7}}{\frac{1}{α} ln ( \frac{{I}_{C 7}}{{I}_{C 9}} )} + {V}_{T} \approx 52 mV \qquad ( 11 )$$

This is equivalent to the expression (6).

That is, the Nagano's reference voltage circuit, outputting 200 mV, and the conventional reference voltage circuit, outputting 1.2V, are based on the same theoretical ground, there being noticed no difference between the two circuits.

It will be appreciated that the name of the reference voltage circuit attached with a band-gap voltage might not be appropriate.

On the other hand, in certain treatises in the relevant field, possibly written by an amateur writer, it is stated that, by setting α=⅙, the reference voltage output by the reference voltage circuit of similar sort is necessarily equal to one-sixth of 1.2V, that is, 200 mV, for all time. This, however, is a serious mistake.

As a matter of course, the value of the output reference voltage is determined by the value of ln(I_{C7}/I_{C9}) included in the expression (11).

The fact that the output voltages of many reference voltage circuits of this sort are unanimously 200 mV may be in support of the apparent well-grounded character of the above treatises. This mistake, however, ought to be corrected.

There is a further questionable point in the circuit of FIG. 4, as now described. It is doubtful whether this sort of the circuit operates as set forth in the specification. The concept of the reference voltage circuit, which forms the basis of this circuit, may be illustrated as a reference case in FIG. 6, wherein a voltage summing circuit is added to the Bamba's circuit disclosed in U.S. Pat. No. 3,586,073.

Referring to FIG. 6, the voltages at points N1 and N2 are controlled to be equal to each other. Since I1=I2, and two parallel resistor paths (R1+R2+Rp) are equal to each other, equal currents flow through transistors (diodes) Q1 and Q2.

Hence, the voltage ΔV_{BE}, obtained on conversion by the grounding resistor Rp of the transistor (diode) Q2, may be expressed as

ΔV_{BE}=V_{T}ln(N) (12)

because the emitter area ratio of the transistors (diodes) Q1 and Q2 is 1:N. Thus, the voltage, obtained on conversion with resistor R2, is

$${V}_{D} = \frac{{R}_{2}}{{R}_{1} + {R}_{2} + {R}_{p}} {V}_{BE 1} = α {V}_{BE 1} \qquad ( 13 )$$

Hence, we have:

Vref=V_{D}+ΔV_{BE}=αV_{BE1}+Vᵣln(N) (14)

which is equivalent to the equation (7).

Moreover, if the reference voltage Vref is to be a temperature-compensated voltage, the following expression:

$$\frac{\partial Vref}{\partial T} = α \frac{\partial {V}_{BE 1}}{\partial T} + ln ( N ) \frac{\partial {V}_{T}}{\partial T} = α \frac{\partial {V}_{BE 1}}{\partial T} + ln ( N ) \frac{k}{q} \approx 0 \qquad ( 15 )$$

has to hold.

In the Bamba's reference voltage circuit, the driving currents I1, I2 are temperature-compensated currents. Thus, in the first current-to-voltage conversion circuit, the current flowing through the series-connected resistors (R1+R2+Rp), connected parallel to the diode D1, is proportional to the temperature characteristic of the diode D1, and has a negative temperature characteristic. Conversely, the current flowing through the diode D1 is a current proportional to the thermal voltage V_{T} or PTAT (Proportional to Absolute Temperature) current, and hence has a positive temperature characteristic.

However, in FIG. 4, the grounding resistor Rp of the transistor (diode) Q2 is also the resistor Rp of the parallel resistors (R1+R2+Rp), thus leading to a non-consistent operation.

Since the current which is in keeping with the base-emitter voltage V_{BE2} of the transistor Q2 flows through the resistors R1 and R2, this current has a negative temperature characteristic. It is this current that flows via resistor Rp to ground.

It is however desirable that a current having a positive temperature characteristic consistent with the voltage ΔVBE flows through the resistor Rp.

There are no measures to satisfy these contradictory requirements, and hence the circuit may not be expected to operate as set forth in the specification.

### [Patent Document 1]

U.S. Pat. No. 4,319,180 (Mar. 9, 1982)

### [Patent Document 2]

U.S. Pat. No. 7,053,694 (May 30, 2006) or JP Patent Kokai Publication No. JP2006-59315 (Mar. 2, 2006)

### [Non-Patent Document 1]

R. J . Wildar, “Low Voltage Techniques”, 1978 IEEE Int. Solid-State Circuits Conf. Dig. Tech. Papers. Feb. 15-17, 1978, pp. 238-239

### [Non-Patent Document 2]

H. Lin an C. -J. Liang, “A Sub-IV Bandgap Reference Circuit Using Subthreshold Current”, IEEE Int. Symp. Circuits and Systems (ISCAS), pp. 4253-4256, May 2005.

### SUMMARY

With the above-described Ozawa's reference voltage circuit, the voltage generated across the resistor Rp is to have a positive temperature coefficient. However, in reality, the voltage generated across the resistor Rp has a negative temperature coefficient to render it difficult to implement a desirable circuit operation.

A first problem is that it is difficult to realize a desired circuit operation.

The reason is that the voltage generated across the resistor Rp has a temperature characteristic contrary to the temperature characteristic required for a desired circuit operation

A second problem is that bipolar transistors are indispensable.

The reason is that a resistor is introduced between a base and a collector.

A third problem is that the circuit includes a redundant configuration.

The reason is that an OP amp is needed as control means even though bipolar transistors are used.

It is an object of the present invention to provide a reference voltage circuit which can be formed on a semiconductor integrated circuit with a reduced chip size and which is in operation from a low voltage to supply a sub-1 volt reference voltage that has a low temperature characteristic.

The invention disclosed in the present application may be summarized as follows:

In accordance with one aspect of the present invention, there is provided a reference voltage circuit comprising: a first current-to-voltage converter and a second current-to-voltage converter, a current mirror circuit that deliver current to the first and second current-to-voltage converters, and a control circuit for exercising control so that a preset output voltage of the first current-to-voltage converter will be equal to a preset output voltage of the second current-to-voltage converter. A mid-point terminal voltage of the first current-to-voltage converter and/or a mid-point terminal voltage of the second current-to-voltage converter is used as a reference voltage.

In the present invention, the first current-to-voltage converter may include a diode, and a resistor connected in parallel with the diode. The second current-to-voltage converter may include a plurality of diodes connected in parallel, a resistor connected in parallel with the parallel-connected diodes, and another resistor connected in series with the parallel connection of the diodes and the first-stated resistor. A mid-point terminal voltage of the first-stated parallel connected resistor of the second current-to-voltage converter is used as the reference voltage.

In the present invention, the first current-to-voltage converter may include a diode, and the second current-to-voltage converter may include a plurality of diodes connected in parallel, a resistor connected in parallel with the diodes, and another resistor connected in series with the parallel connection of the diodes and the first-stated resistor. A mid-point terminal voltage of the first-stated parallel-connected resistor of the second current-to-voltage converter is used as the reference voltage.

In the present invention, the first current-to-voltage converter may include a diode, and the second current-to-voltage converter may include a plurality of diodes connected in parallel, a resistor connected in parallel with the diodes, another resistor connected in series with the parallel connection of the diodes and the first-stated resistor, and a further resistor connected in parallel with the series connection of the parallel connection and the second resistor. A mid-point terminal voltage of the first-stated parallel-connected resistor of the second current-to-voltage converter is used as a reference voltage.

In the present invention, the first current-to-voltage converter may include a diode and a resistor connected in parallel with the diode. The second current-to-voltage converter may include a plurality of diodes connected in parallel, a resistor connected in parallel with the diodes, another resistor connected in series with the parallel connection of the diodes and the first-stated resistor, and a further resistor connected in parallel with the series connection of the parallel connection and the other resistor. A mid-point terminal voltage of the first-stated parallel connected resistor of the second current-to-voltage converter is used as a reference voltage.

In the present invention, the first current-to-voltage converter may includes a diode, a resistor connected in parallel with the diode, and another resistor connected in series with the parallel connection of the diode and the first-stated resistor. The second current-to-voltage converter may include a plurality of diodes connected in parallel, a resistor connected in parallel with the diodes, another resistor connected in series with the parallel connection of the diodes and the first-stated resistor, and a further resistor connected in parallel with the series connection of the parallel connection and the other resistor. A mid-point terminal voltage of the first-stated parallel-connected resistor of the second current-to-voltage converter is used as a reference voltage.

In the present invention, the first current-to-voltage converter may include a diode, a resistor connected in parallel with the diode, another resistor connected in series with the parallel connection of the diode and the first-stated resistor, and a further resistor connected in parallel with the series connection of the parallel connection and the other resistor. The second current-to-voltage converter may include a plurality of diodes connected in parallel, a resistor connected in parallel with the diodes, another resistor connected in series with the parallel connection and a further resistor connected in parallel with the series connection of the parallel connection and the other resistor. A mid-point terminal voltage of the first-stated parallel-connected resistor of the first current-to-voltage converter and/or a mid-point terminal voltage of the first-stated parallel-connected resistor of the second current-to-voltage converter are used as a reference voltage(s).

In accordance with another aspect of the present invention, there is provided a reference voltage circuit comprising a first current-to-voltage converter and a second current-to-voltage converter,

a resistor connected in common to the first current-to-voltage converter and the second current-to-voltage converter, a current mirror circuit that supplies currents to the first current-to-voltage converter and the second current-to-voltage converter, and a control circuit for controlling a preset output voltage of the first current-to-voltage converter and a preset output voltage of the second current-to-voltage converter to be equal to each other. A mid-point terminal voltage(s) of the first current-to-voltage converter or the second current-to-voltage converter is used as a reference voltage(s). The control circuit may include an operational amplifier (OP amp) that receives two terminal voltages at its non-inverting terminal and at its inverting terminal. An output terminal of the OP amp is connected to a common gate of the current mirror circuits.

In the present invention, the control circuit include a first current mirror circuit and a second current mirror circuit. The first current mirror circuit includes transistors differing in polarity from transistors that constitute the second current mirror circuit. First and second transistors that constitute the first current mirror circuit have sources connected to the first and second current-to-voltage converters. The first transistor has a gate and a drain connected in common and is connected to a drain of a third transistor of the second current mirror circuit. The fourth transistor of the second current mirror circuit has a gate and a drain connected in common and is connected to a drain of the second transistor.

In the present invention, the control circuit may include first to fourth current mirror circuits. The transistors that constitute the first and second current mirror circuits are of the same polarity. The transistors that constitute the third and fourth current mirror circuits are of the same polarity and differ in polarity from the transistors of the first and second current mirror circuits. The sources of first and second transistors that constitute the first current mirror circuit are respectively connected to the first and second current-to-voltage converters. The coupled gates of the first and second transistors are connected to the drain of a third transistor out of the third and fourth transistors that constitute the second current mirror circuit. The fourth transistor has a gate and a drain connected in common. The drain of the first transistor and the drain of the second transistor are respectively connected to fifth and seventh transistors, having the gates and the drains connected in common, out of fifth and sixth transistors making up the third current mirror circuit and seventh and eighth transistors making up the fourth current mirror circuit, and are connected via the sixth and eighth transistors to the third and fourth transistors, respectively. The sources of the third and fourth transistors are respectively connected to third and fourth current-to-voltage converters that are equivalent to the first current-to-voltage converter or to the second current-to-voltage converter.

In the present invention, the control circuit may include first and second current mirror circuits. The first to third transistors, making up the first current mirror circuit, differ in polarity from the fourth to sixth transistors making up the second current mirror circuit. The sources of the first and second transistors in the first current mirror circuit are respectively connected to the first and second current-to-voltage converters. The coupled gates of the first and second transistors are connected to the gate and the drain of the third transistor connected in common. The source of the third transistor is connected to a third current-to-voltage converter equivalent to the first or second current-to-voltage converter. The fourth transistor in the second current mirror circuit has a gate and a drain connected in common and is connected to the drain of the first transistor. The fourth transistor has a source connected via a resistor to a power supply. The fourth and fifth transistors have gates connected in common to form a reverse Widlar current mirror circuit. The fifth transistor has a drain connected to a drain of the second transistor and to a gate of the sixth transistor. The sixth transistor has a drain connected to a drain of the third transistor and has a source connected to a power supply. According to the present invention, the diodes may be including diode-connected transistors.

According to the present invention, the temperature characteristic may be compensated out extremely readily because the circuit has now been changed to a circuit simplified in operation.

According to the present invention, no bipolar transistors are needed because the circuit may be implemented using diodes.

According to the present invention, output voltage variations may be suppressed because an output is not taken out via a current mirror circuit.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a circuit diagram showing a configuration of a conventional reference voltage circuit by Dobkin et al. (related technique).

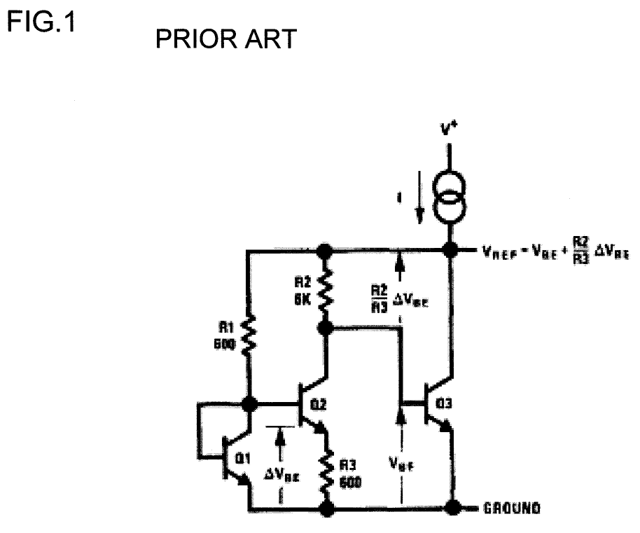

FIG. 2 is a circuit diagram showing a configuration of a conventional reference voltage circuit by Widlar (related art).

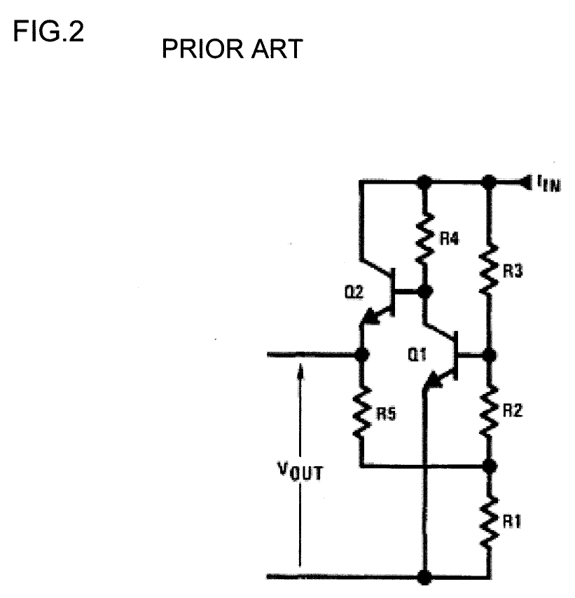

FIG. 3 is a circuit diagram showing a configuration of a conventional reference voltage circuit by Nagano (related art).

FIG. 4 is a circuit diagram showing a configuration of a conventional reference voltage circuit by Ozawa (related art).

FIG. 5 is a circuit diagram showing a configuration of a reference voltage circuit (related art) that outputs 1.2 V.

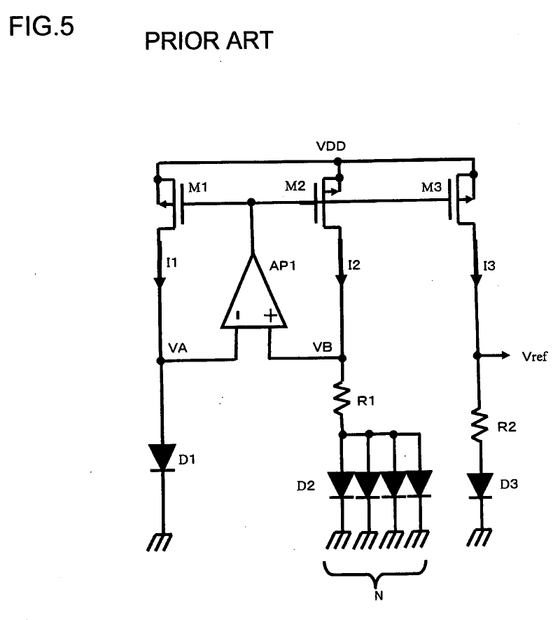

FIG. 6 is a circuit diagram of a conventional reference voltage circuit (reference case) that outputs a voltage not higher than 0.25V based on a Bamba's reference voltage circuit as a model.

FIG. 7 is a circuit diagram, partially shown in blocks, showing a reference voltage circuit according to claim 1 of the present invention.

FIG. 8 is a circuit diagram showing an Example 1 of the reference voltage circuit according to claim 2 of the present invention.

FIG. 9 is a circuit diagram showing an Example 1 of the reference voltage circuit according to claim 3 of the present invention.

FIG. 10 is a circuit diagram showing an Example 1 of the reference voltage circuit according to claim 4 of the present invention.

FIG. 11 is a circuit diagram showing an Example 1 of the reference voltage circuit according to claim 5 of the present invention.

FIG. 12 is a circuit diagram showing an Example 1 of the reference voltage circuit according to claim 6 of the present invention.

FIG. 13 is a circuit diagram showing an Example 1 of the reference voltage circuit according to claim 7 of the present invention.

FIG. 14 is a second circuit diagram, partially shown in blocks, showing the reference voltage circuit according to claim 1 of the present invention.

FIG. 15 is a circuit diagram showing an Example 2 of the reference voltage circuit according to claim 2 of the present invention.

FIG. 16 is a circuit diagram showing an Example 2 of the reference voltage circuit according to claim 3 of the present invention.

FIG. 17 is a circuit diagram showing an Example 2 of the reference voltage circuit according to claim 4 of the present invention.

FIG. 18 is a circuit diagram showing an Example 2 of the reference voltage circuit according to claim 5 of the present invention.

FIG. 19 is a circuit diagram showing an Example 2 of the reference voltage circuit according to claim 6 of the present invention.

FIG. 20 is a circuit diagram showing an Example 2 of the reference voltage circuit according to claim 7 of the present invention.

FIG. 21 is a third circuit diagram, partially shown in blocks, showing the reference voltage circuit according to claim 1 of the present invention.

FIG. 22 is a circuit diagram showing an Example 3 of the reference voltage circuit according to claim 2 of the present invention.

FIG. 23 is a circuit diagram showing an Example 3 of the reference voltage circuit according to claim 3 of the present invention.

FIG. 24 is a circuit diagram showing an Example 3 of the reference voltage circuit according to claim 4 of the present invention.

FIG. 25 is a circuit diagram showing an Example 3 of the reference voltage circuit according to claim 5 of the present invention.

FIG. 26 is a circuit diagram showing an Example 3 of the reference voltage circuit according to claim 6 of the present invention.

FIG. 27 is a circuit diagram showing an Example 3 of the reference voltage circuit according to claim 7 of the present invention.

FIG. 28 is a third circuit diagram, partially shown in blocks, showing the reference voltage circuit according to claim 1 of the present invention.

FIG. 29 is a circuit diagram showing an Example 3 of the reference voltage circuit according to claim 2 of the present invention.

FIG. 30 is a circuit diagram showing an Example 3 of the reference voltage circuit according to claim 3 of the present invention.

FIG. 31 is a circuit diagram showing an Example 3 of the reference voltage circuit according to claim 4 of the present invention.

FIG. 32 is a circuit diagram showing an Example 3 of the reference voltage circuit according to claim 5 of the present invention.

FIG. 33 is a circuit diagram showing an Example 3 of the reference voltage circuit according to claim 6 of the present invention.

FIG. 34 is a circuit diagram showing an Example 3 of the reference voltage circuit according to claim 7 of the present invention.

FIG. 35 is a first circuit diagram, partially shown in blocks, showing the reference voltage circuit according to claim 8 of the present invention.

FIG. 36 is a circuit diagram showing an Example 1 of the reference voltage circuit according to claim 8 of the present invention.

FIG. 37 is a circuit diagram showing an Example 2 of the reference voltage circuit according to claim 8 of the present invention.

FIG. 38 is a circuit diagram showing an Example 3 of the reference voltage circuit according to claim 8 of the present invention.

FIG. 39 is a circuit diagram showing an Example 4 of the reference voltage circuit according to claim 8 of the present invention.

FIG. 40 is a circuit diagram showing an Example 5 of the reference voltage circuit according to claim 8 of the present invention.

FIG. 41 is a circuit diagram showing an Example 6 of the reference voltage circuit according to claim 8 of the present invention.

FIG. 42 is a second circuit diagram, partially shown in blocks, showing the reference voltage circuit according to claim 8 of the present invention.

FIG. 43 is a circuit diagram showing an Example 7 of the reference voltage circuit according to claim 8 of the present invention.

FIG. 44 is a circuit diagram showing an Example 8 of the reference voltage circuit according to claim 8 of the present invention.

FIG. 45 is a circuit diagram showing an Example 9 of the reference voltage circuit according to claim 8 of the present invention.

FIG. 46 is a circuit diagram showing an Example 10 of the reference voltage circuit according to claim 8 of the present invention.

FIG. 47 is a circuit diagram showing an Example 11 of the reference voltage circuit according to claim 8 of the present invention.

FIG. 48 is a circuit diagram showing an Example 12 of the reference voltage circuit according to claim 8 of the present invention.

FIG. 49 is a third circuit diagram, partially shown in blocks, showing the reference voltage circuit according to claim 8 of the present invention.

FIG. 50 is a circuit diagram showing an Example 13 of the reference voltage circuit according to claim 8 of the present invention.

FIG. 51 is a circuit diagram showing an Example 14 of the reference voltage circuit according to claim 8 of the present invention.

FIG. 52 is a circuit diagram showing an Example 15 of the reference voltage circuit according to claim 8 of the present invention.

FIG. 53 is a circuit diagram showing an Example 16 of the reference voltage circuit according to claim 8 of the present invention.

FIG. 54 is a circuit diagram showing an Example 17 of the reference voltage circuit according to claim 8 of the present invention.

FIG. 55 is a circuit diagram showing an Example 18 of the reference voltage circuit according to claim 8 of the present invention.

FIG. 56 is a third circuit diagram, partially shown in blocks, showing the reference voltage circuit according to claim 8 of the present invention.

FIG. 57 is a circuit diagram showing an Example 19 of the reference voltage circuit according to claim 8 of the present invention.

FIG. 58 is a circuit diagram showing an Example 20 of the reference voltage circuit according to claim 8 of the present invention.

FIG. 59 is a circuit diagram showing an Example 21 of the reference voltage circuit according to claim 8 of the present invention.

FIG. 60 is a circuit diagram showing an Example 22 of the reference voltage circuit according to claim 8 of the present invention.

FIG. 61 is a circuit diagram showing an Example 23 of the reference voltage circuit according to claim 7 of the present invention.

FIG. 62 is a circuit diagram showing an Example 24 of the reference voltage circuit according to claim 7 of the present invention.

### PREFERRED MODES

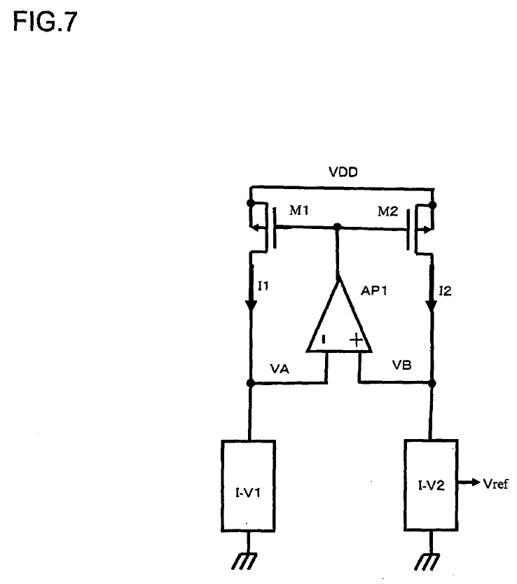

FIG. 7 depicts a diagram, partially shown in blocks, showing an arrangement of a reference voltage circuit of claim 1 of the present application in a generalized form. Referring to FIG. 7, this reference voltage circuit has a network including a resistor(s) and a diode(s) in each of a first current-to-voltage converter (I-V1) and a second current-to-voltage converter (I-V2). The circuit of FIG. 7 has a circuit topology of high versatility in which redundancy is dispensed with and the so simplified circuit may be applied to many circuits such as to take account of a variety of circuit size and current consumption.

The operation of the circuit of FIG. 7 is now described. A current I1 is supplied to the first current-to-voltage converter (I-V1) to generate a terminal voltage VA, whilst a current I2 is supplied to the second current-to-voltage converter (I-V2) to generate a terminal voltage VB. A mid-point terminal voltage of the second current-to-voltage converter (I-V2) is output as a reference voltage Vref. Alternatively, a mid-point terminal voltage of the second current-to-voltage converter (I-V2) is output as a reference voltage Vref1, and a mid-point terminal voltage of the first current-to-voltage converter (I-V2) is output as a reference voltage Vref2.

In FIG. 7, p-channel transistors M1 and M2 are used in the current mirror circuit, with a view to reducing the power supply voltage. It is also possible to use n-channel transistors as the current mirror circuit and to interchange the non-inverting input terminal (+) and the inverting input terminal (−) of the OP amp. However, in such case, the power supply voltage would be unavoidably increased to surpass the threshold voltage.

### EXAMPLE 1

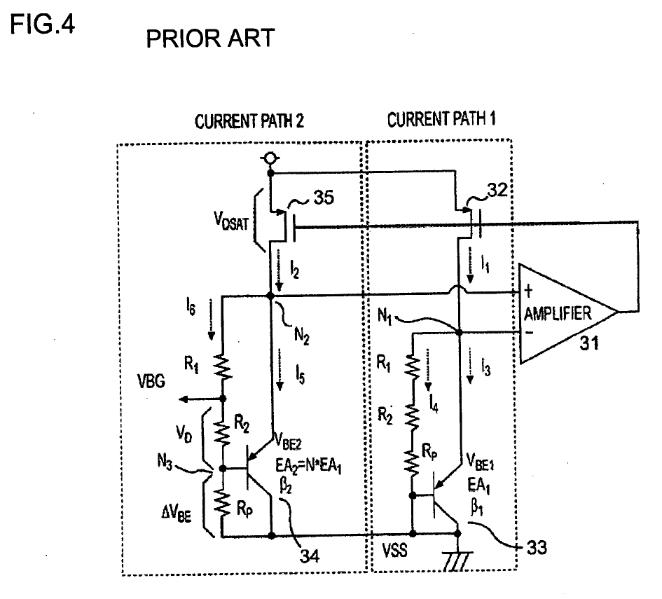

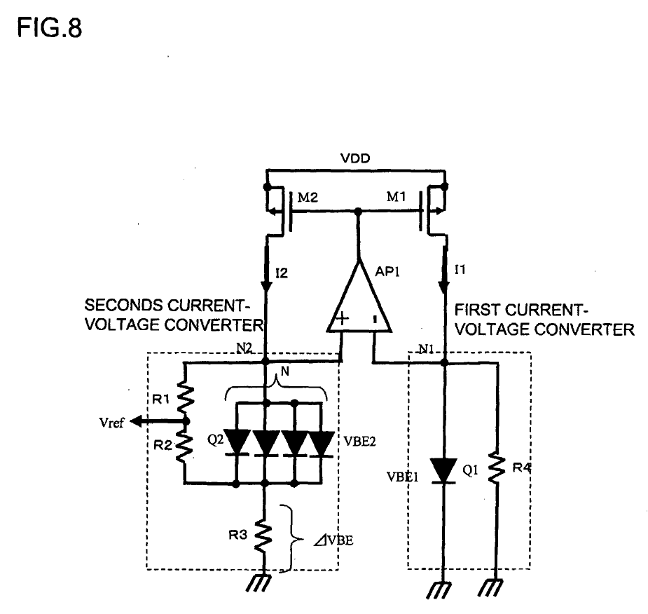

FIG. 8 depicts a circuit diagram showing a specific example of a reference voltage circuit according to claim 2 of the present application. In FIG. 8, a diode Q1 is a unit diode, whilst N-number of diodes Q2 are connected in parallel. The diodes Q1 and Q2 are provided for contrast to the Ozawa's circuit shown in FIG. 4. A first current-to-voltage converter (I-V1) includes a parallel connection of the diode Q1 and a resistor 4 both of which are grounded. A second current-to-voltage converter (I-V2) includes a parallel connection of the diodes Q2 and series-connected resistors R1 and R2, and a resistor R3 connected in series with this parallel connection of the diodes Q2 and (R1, R2) and grounded. A mid-point terminal of the series-connected resistors R1 and R2 operates as a reference voltage output and also constitutes a circuit that outputs a reference voltage Vref. The diodes Q1 and Q2 (or denoted as D1 and D2) may be including diode-connected bipolar transistors. This applies for exemplary embodiments described subsequently.

The terminal voltages of the first current-to-voltage converter (I-V1) and the second current-to-voltage converter (I-V2) are connected to an inverting input terminal (−) and a non-inverting input terminal (+) of an OP amp, respectively.

The first current-to-voltage converter (I-V1) and the second current-to-voltage converter (I-V2) are driven with currents I1 and I2, respectively, by the transistors M1 and M2 that constitute a current mirror circuit. The coupled gates of the transistors M1 and M2 of the current mirror circuit are connected to an output terminal of the OP amp so that the voltages at respective terminals N1, N2 are controlled to be equal to each other.

The operation of the circuit of FIG. 8 is now described. In FIG. 8, the following equation holds:

V_{BE1}=V_{BE2}+R₃I₂ (16)

From the equation (16), we have:

ΔV_{BE}=V_{BE1}−V_{BE2}=R₃I₂ (17)

The reference voltage Vref is expressed by the sum of ΔV_{BE} and a voltage obtained by dividing a voltage across the diode Q2, and is given as follows:

$$Vref = \frac{{R}_{1}}{{R}_{1} + {R}_{2}} {V}_{BE 2} + Δ {V}_{BE} = α {V}_{BE 2} + Δ {V}_{BE} \qquad ( 18 )$$

This equation (18) is equivalent to the equation (7) and also to the equation (14).

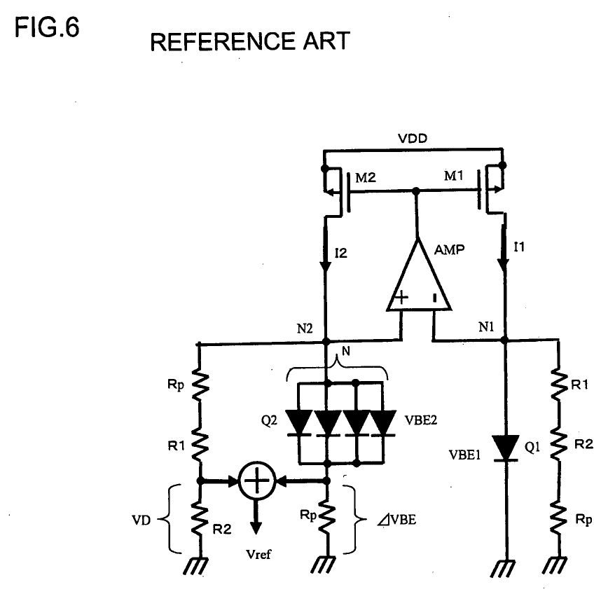

That is, the circuit of FIG. 8 is equivalent to the conceptualized circuit diagram of FIG. 6, and represents an example of an actual circuit that outputs a reference voltage not higher than 250 mV.

Strictly speaking, there is an obvious difference between the two circuits. That is, in the circuit of FIG. 6, the driving current supplied from the current mirror circuit is a temperature-compensated current or a nearly-temperature-compensated current, whereas the current in the circuit of FIG. 8 is a current approximately proportional to absolute temperature (PTAT).

In actuality, if expressed like the equation (10), ΔV_{BE} may be expressed as

$$Δ {V}_{BE} = {V}_{T} ln \{ \frac{N ( {I}_{1} - \frac{{V}_{BE 1}}{{R}_{4}} )}{{I}_{2} - \frac{{V}_{BE 2}}{{R}_{1} + {R}_{2}}} \} = {V}_{1} ln \{ \frac{N ( 1 - \frac{{V}_{BE 1}}{{R}_{4} {I}_{1}} )}{1 - \frac{{V}_{BE 2}}{( {R}_{1} + {R}_{2} ) {I}_{1}}} \} \\ where I 1 = I 2. \qquad ( 19 )$$

Hence, in order for the reference voltage Vref to be a temperature-compensated voltage, the following expression:

$$\begin{matrix}\frac{\partial Vref}{\partial T} = α \frac{\partial {V}_{BE 2}}{\partial T} + ln ( \frac{N ( 1 - \frac{{N}_{BE 1}}{{R}_{4} {I}_{1}} )}{1 - \frac{{V}_{BE 2}}{( {R}_{1} + {R}_{2} ) {I}_{1}}} ) \frac{\partial {V}_{T}}{\partial T} + {V}_{T} \frac{\partial }{\partial T} \\ [ ln ( \frac{N ( 1 - \frac{{V}_{BE 1}}{{R}_{4} {I}_{1}} )}{1 - \frac{{V}_{BE 2}}{( {R}_{1} + {R}_{2} ) {I}_{1}}} \} ] \\ = α \frac{\partial {V}_{BE 2}}{\partial T} + ln ( \frac{N ( 1 - \frac{{V}_{BE 1}}{{R}_{4} {I}_{1}} )}{1 - \frac{{V}_{BE 2}}{( {R}_{1} + {R}_{2} ) {I}_{1}}} ) \frac{k}{q} + {V}_{T} \frac{\partial }{\partial T} \\ [ ln \{ \frac{N ( 1 - \frac{{V}_{BE 1}}{{R}_{4} {I}_{1}} )}{1 - \frac{{V}_{BE 2}}{( {R}_{1} + {R}_{2} ) {I}_{1}}} \} ] \\ \approx 0\end{matrix} \qquad ( 20 )$$

has to hold.

If

$$\frac{{V}_{BE 1}}{{R}_{4}} \approx \frac{{V}_{BE 2}}{{R}_{1} + {R}_{2}} \qquad ( 21 )$$

is set,

Vref≈αV_{BE2}+V_{T}ln(N) (22)

holds, such that

$$\frac{\partial Vref}{\partial T} \approx α \frac{\partial {V}_{BE 2}}{\partial T} + ln ( N ) \frac{\partial {V}_{T}}{\partial T} = α \frac{\partial {V}_{BE 2}}{\partial T} + ln ( N ) \frac{k}{q} \approx 0 \qquad ( 23 )$$

holds.

If

$$\frac{{V}_{BE 1}}{{R}_{4}} < \frac{{V}_{BE 2}}{{R}_{1} + {R}_{2}} \qquad ( 24 )$$

is set, it is possible to enlarge the variable range, with temperature, of the value of the denominator in ln of the equation (19) as well as to render the anti-log of ln large or small at lower and higher temperatures, respectively.

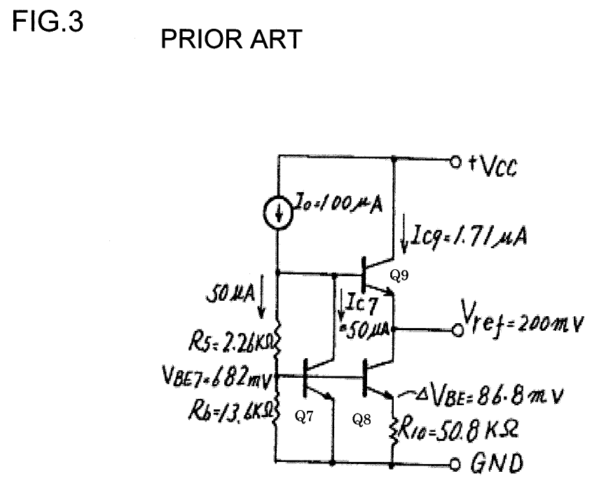

That is, by making the temperature characteristic of the product of this log value and V_{T}, that is, ΔV_{BE}, a curved line, it is possible to compensate diode's temperature non-linearity more readily than with the Nagano's reference voltage circuit shown in FIG. 3.

The reference voltage circuit, outputting a reference voltage not higher than 250 mV, has now been obtained.

As regards the power supply voltage, the diode's forward voltage VF is varied in a range from approximately 1 V to approximately 0.5V for a temperature range of about −50° C. to 125° C. Hence, if V_{DS}≧0.2V, which allows for the operation in a saturation range of the transistors M1 and M2 of the current mirror circuit, is assured, the minimum power supply voltage is 1.2V.

The method for compensation of temperature non-linearity of bipolar transistors or diodes in a reference voltage circuit (curvature compensation) dates back to the Nagano's method described above. There is also a method in which, in a ΔV_{BE} circuit or a ΔV_{F} circuit composed of two bipolar transistors or diodes, and in which a differential voltage of two V_{BE}S or V_{F}S is output, a resistor is connected in parallel with a parallel connection of diodes or between the base and the emitter of the bipolar transistor having a larger emitter area. This may be deduced from the other applications of the present inventor including JP Patent Kokai Publication No. JP2008-123480 (corresponding to JP patent application Nos. 2007-121032 and 2006-281619) and JP patent application No. 2007-233003 and from the present application.

### EXAMPLE 2

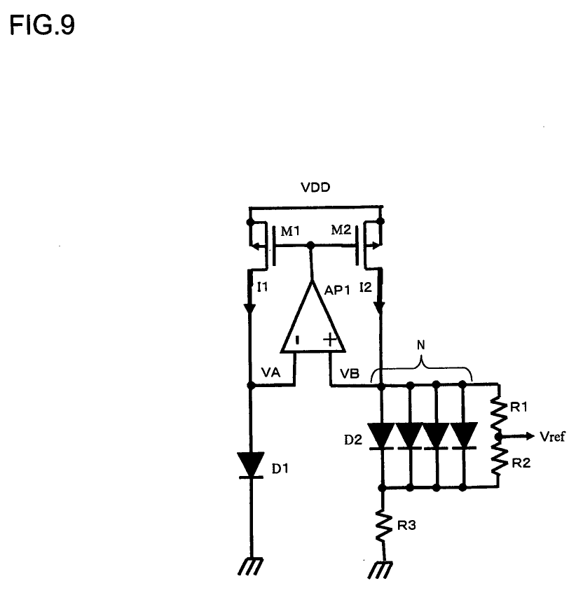

FIG. 9 shows an example of a real reference voltage circuit according to claim 3 of the present application. In FIG. 9, a diode D1 is a unit diode, whilst N-number of diodes Q2 are connected in parallel. A first current-to-voltage converter (I-V1) includes a grounded diode D1. A second current-to-voltage converter (I-V2) includes a parallel connection of series-connected resistors R1 and R2 and a plurality of diodes D2, and a resistor R3 connected in series with the parallel connection and grounded. A mid-point terminal between the series-connected resistors R1 and R2 operates as a reference voltage output to constitute a circuit that outputs a reference voltage Vref.

The terminal voltages of the first current-to-voltage converter (I-V1) and the second current-to-voltage converter (I-V2) are respectively connected to an inverting input terminal (−) and a non-inverting input terminal (+) of an OP amp.

The first current-to-voltage converter (I-V1) and the second current-to-voltage converter (I-V2) are respectively driven with currents I1 and I2 by the transistors M1 and M2 that constitute a current mirror circuit. The coupled gates of the transistors M1 and M2 of the current mirror circuit are connected to an output terminal of the OP amp so that the voltages at respective terminals VA and VB are controlled to be equal to each other.

The operation of the circuit of FIG. 9 is now described. In FIG. 9,

V_{F1}=V_{F2}+R₃I₂ (25)

If we put

ΔV_{F}=V_{F1}−V_{F2}=R₃I₂ (26)

the reference voltage Vref is expressed by the sum of ΔV_{F} and the voltage obtained by dividing the voltage across the diode D2, and is found by

$$Vref = \frac{{R}_{1}}{{R}_{1} + {R}_{2}} {V}_{F 2} + Δ {V}_{F} = α {V}_{F 2} + Δ {V}_{F} \qquad ( 27 )$$

The equation (27) is equivalent to the equation (7) and also equivalent to the equation (14).

That is, the circuit of FIG. 9 is equivalent to the conceptualized circuit diagram of FIG. 6, and is an example of an actual circuit that outputs a reference voltage equal to or less than 250 mV. Strictly speaking, there is an obvious difference between the two circuits. That is, in the circuit of FIG. 6, the driving current supplied from the current mirror circuit is a temperature-compensated current or a nearly-temperature-compensated current, whereas the current in the circuit of FIG. 8 is a current approximately proportional to absolute temperature (PTAT).

In actuality, if expressed like the equation (10), ΔV_{F} may be expressed as

$$Δ {V}_{F} = {V}_{T} ln \{ \frac{{NI}_{1}}{{I}_{2} - \frac{{V}_{F 2}}{{R}_{1} + {R}_{2}}} \} = {V}_{T} ln \{ \frac{N}{1 - \frac{{V}_{F 2}}{( {R}_{1} + {R}_{2} ) {I}_{1}}} \} \qquad ( 28 )$$

where I1=I2.

Hence, in order for the reference voltage Vref to be a temperature-compensated voltage, the following expression:

$$\begin{matrix}\frac{\partial Vref}{\partial T} = α \frac{\partial {V}_{F 1}}{\partial T} + ln ( \frac{N}{1 - \frac{{V}_{F 2}}{( {R}_{1} + {R}_{2} ) {I}_{1}}} ) \frac{\partial {V}_{T}}{\partial T} + \\ {V}_{T} \frac{\partial }{\partial T} [ ln \{ \frac{N}{1 - \frac{{V}_{F 2}}{( {R}_{1} + {R}_{2} ) {I}_{1}}} \} ] \\ = α \frac{\partial {V}_{BE 1}}{\partial T} + ln ( \frac{N}{1 - \frac{{V}_{F 2}}{( {R}_{1} + {R}_{2} ) {I}_{1}}} ) \frac{k}{q} + \\ {V}_{T} \frac{\partial }{\partial T} [ ln [ \frac{N}{1 - \frac{{V}_{F 2}}{( {R}_{1} + {R}_{2} ) {I}_{1}}} \} ] \\ \approx 0\end{matrix} \qquad ( 29 )$$

has to hold.

It is possible to enlarge the variable range, with temperature, of the value of the denominator in ln of the equation (28) as well as to render the anti-log large or small at lower and higher temperatures, respectively.

That is, by making the temperature characteristic of the product of this log value and V_{T}, that is, ΔV_{BE}, a curved line, it is possible to compensate the temperature non-linearity proper to a diode more readily than with the Nagano's reference voltage circuit shown in FIG. 3.

The values used for the circuit simulations are now shown. With VDD=1,3V, N is set to 8 (N=8). With R1=100 kΩ, R2=5.703 kΩ and R3=5 kΩ, the values of Vref obtained were 101.71 mV at −53° C., 101.797 mV at −20° C., 101.88 mV at 27° C., 101.882 mV at 40° C. and 101.702 mV at 107° C. Thus, a bell-shaped characteristic was obtained. The width of temperature variations was 0.18%. Thus, such a reference voltage circuit that outputs a reference voltage not higher than 250 mV has now been obtained.

The diode's forward voltage is varied in an approximate range from 1V to 0.5V for a temperature range from −50° C. to 125° C. Hence, as regards the power supply voltage, the minimum power supply voltage is 1.2V if V_{DS}≧0.2V, which allows for the operation in the saturation range of the transistors M1 and M2 of the current mirror circuit, is secured.

### EXAMPLE 3

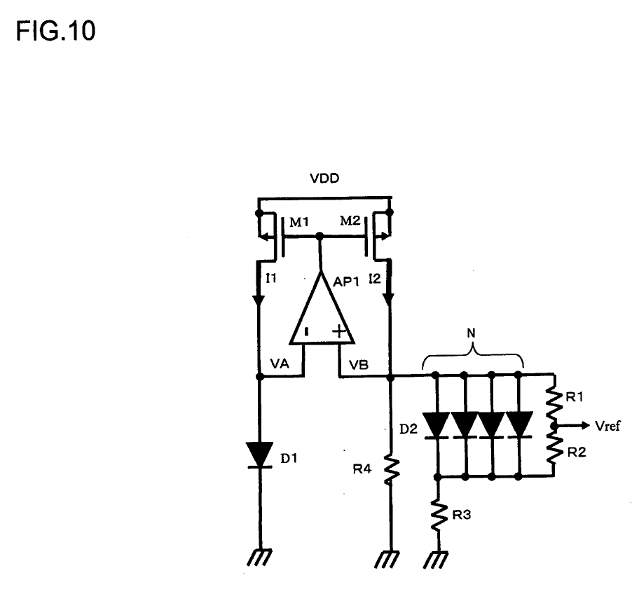

FIG. 10 depicts a circuit diagram showing a specific example of a reference voltage circuit according to claim 4 of the present application. In FIG. 10, a diode D1 is a unit diode, whilst an N-number of diodes D2 are connected in parallel. A first current-to-voltage converter is a sole diode, and a second current-to-voltage converter (I-V2) includes a parallel connection of the diodes D2 and series-connected resistors R1 and R2, a resistor 3 connected in series with the resulting parallel connection and which is grounded, and a resistor R4 connected in parallel with the series connection. A mid-point terminal between the series-connected resistors R1 and R2 operates as a reference voltage output and also constitutes a circuit that outputs a reference voltage Vref.

The terminal voltages of the first current-to-voltage converter (I-V1) and the second current-to-voltage converter (I-V2) are connected to an inverting input terminal (−) and a non-inverting input terminal (+) of an OP amp (AP1), respectively.

The first current-to-voltage converter (I-V1) and the second current-to-voltage converter (I-V2) are driven with currents I1 and I2, respectively, by the transistors M1 and M2 that constitute the current mirror circuit. The coupled gates of the transistors M1 and M2 of the current mirror circuit are connected to an output terminal of the OP amp (AP1) so that the voltages VA and VB are controlled to he equal to each other.

The operation of the circuit of FIG. 8 is now described. In FIG. 10, the following equation holds:

V_{F1}=V_{F2}+R₃(I₂−V_{F1}/R₄) (30)

Thus we have:

ΔV_{F}=V_{F1}−V_{F2}=R₃(I₂−V_{F1}/R₄) (31)

The reference voltage Vref is expressed by the sum of ΔV_{F} and the voltage obtained by dividing the voltage across the diode D2, and is given by

$$Vref = \frac{{R}_{1}}{{R}_{1} + {R}_{2}} {V}_{F 2} + Δ {V}_{F} = α {V}_{F 2} + Δ {V}_{F} \qquad ( 32 )$$

The equation (32) is equivalent to the equation (7) and also equivalent to the equation (14). That is, the circuit of FIG. 10 is equivalent to the circuit diagram of FIG. 6, and is an example of an actual circuit that outputs a reference voltage equal to or less than 250 mV.

In both the circuits of FIGS. 6 and 10, the driving current supplied from the current mirror circuit is a temperature-compensated current or a nearly-temperature-compensated current. The current in the circuit of FIG. 10 may be a current approximately proportional to absolute temperature (PTAT).

Even though the driving current has some negative temperature characteristic, the current of a negative temperature characteristic flows through resistors R4 (and R5), so that, if the current flowing through the diode D1 (and diode D2) has a positive temperature characteristic, the voltage generated across the resistor R3 has a positive temperature characteristic. The divided voltage by the resistors R1 and R2 has a negative temperature characteristic. Thus, by addition with weights, it is possible to cancel out the temperature characteristics in the reference voltage Vref.

In actuality, if expressed like the equation (10), ΔV_{F} may be expressed as

$$\begin{matrix}Δ {V}_{F} = {V}_{T} ln \{ \frac{N}{{I}_{2} - \frac{{V}_{F 2}}{{R}_{1} + {R}_{2}} - \frac{{V}_{F 1}}{{R}_{4}}} \} \\ = {V}_{T} ln \{ \frac{N}{1 - \frac{{V}_{F 2}}{( {R}_{1} + {R}_{2} ) {I}_{1}} - \frac{{V}_{F 1}}{{R}_{4}}} \}\end{matrix} \\ where 11 = 12. \qquad ( 33 )$$

Hence, in order for the reference voltage Vref to be a temperature-compensated voltage, the following expression:

$$\begin{matrix}\frac{\partial Vref}{\partial T} = α \frac{\partial {V}_{F 1}}{\partial T} + ln ( \frac{N}{1 - \frac{{V}_{F 2}}{( {R}_{1} + {R}_{2} ) {I}_{1}} - \frac{{V}_{F 1}}{{R}_{4}}} ) + \\ {V}_{T} \frac{\partial }{\partial T} [ ln \{ \frac{N}{1 - \frac{{V}_{F 2}}{( {R}_{1} + {R}_{2} ) {I}_{1}} - \frac{{V}_{F 1}}{{R}_{4}}} \} ] \\ = α \frac{\partial {V}_{F 1}}{\partial T} + ln ( \frac{N}{1 - \frac{{V}_{F 2}}{( {R}_{1} + {R}_{2} ) {I}_{1}} - \frac{{V}_{F 1}}{{R}_{4}}} ) \frac{k}{q} + \\ {V}_{T} \frac{\partial }{\partial T} [ ln \{ \frac{N}{1 - \frac{{V}_{F 2}}{( {R}_{1} + {R}_{2} ) {I}_{1}} - \frac{{V}_{F 1}}{{R}_{4}}} \} ] \\ \approx 0\end{matrix} \qquad ( 34 )$$

has to hold.

It is possible to enlarge the variable range, with temperature, of the value of the denominator in ln of the equation (33) as well as to render the anti-log of ln large or small at lower and higher temperatures, respectively. That is, by making the temperature characteristic of the product of this log value and V_{T}, that is, ΔV_{BE}, a curved line, it is possible to compensate the temperature non-linearity proper to a diode more readily than with the Nagano's reference voltage circuit shown in FIG. 3. A reference voltage circuit that outputs a reference voltage not higher than 250 mV may thus be produced.

The diode's forward voltage is varied in an approximate range from 1V to 0.5V for a temperature range from −50° C. to 125° C. Hence, the minimum power supply voltage is 1.2V if V_{DS}≧0.2V, which allows for the operation in the saturation range of the transistors M1 and M2 of the current mirror circuit, is secured.

### EXAMPLE 4

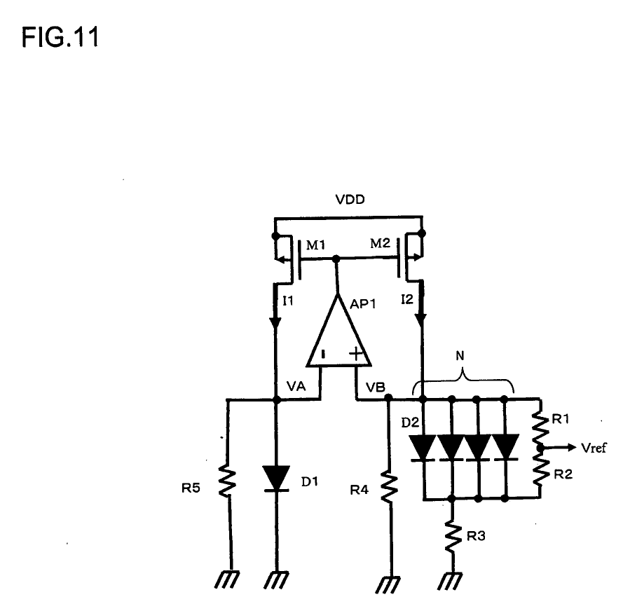

FIG. 11 depicts a circuit diagram showing a specific example of a reference voltage circuit according to claim 5 of the present application. In FIG. 11, a diode D1 is a unit diode, whilst an N-number of diodes D2 are connected in parallel. A first current-to-voltage converter (I-V1) is a parallel connection of the sole diode D1 and a resistor R1, both of which are grounded. A second current-to-voltage converter (I-V2) includes the parallel connection of the diodes D2 and series-connected resistors R1 and R2, a resistor R3 connected in series with the parallel connection and which is grounded, and a resistor R4 connected in parallel with the series connection. A mid-point terminal between the series-connected resistors R1 and R2 operates as a reference voltage output and also constitutes a circuit that outputs a reference voltage Vref.

The terminal voltages of the first current-to-voltage converter (I-V1) and the second current-to-voltage converter (I-V2) are connected to an inverting input terminal (−) and a non-inverting input terminal (+) of an OP amp (AP1), respectively.

The first current-to-voltage converter (I-V1) and the second current-to-voltage converter (I-V2) are respectively driven with currents I1 and I2 by the transistors M1 and M2 that constitute a current mirror circuit. The coupled gates of the transistors M1 and M2 of the current mirror circuit are connected to an output terminal of the OP amp (AP1) so that the voltages at respective terminals VA and VB are controlled to be equal to each other.

The operation of the circuit of FIG. 11 is now described. In FIG. 11,

V_{F1}=V_{F2}+R₃(I₂−V_{F1}/R₄) (35)

ΔV_{F} is given by

ΔV_{F}=V_{F1}−V_{F2}=R₃(I₂−V_{F1}/R₄) (36)

The reference voltage is expressed by the sum of ΔV_{F} and the voltage by dividing the voltage across the diode D2, and is given by

$$Vref = \frac{{R}_{1}}{{R}_{1} {R}_{2}} {V}_{F 2} + Δ {V}_{f} = α {V}_{F 2} + Δ {V}_{F} \qquad ( 37 )$$

The equation (37) is equivalent to the equation (7) and also equivalent to the equation (14). That is, the circuit of FIG. 11 is equivalent to the conceptualized circuit diagram of FIG. 6, and is an example of an actual circuit that outputs a reference voltage equal to or less than 250 mV.

In both the circuits of FIGS. 6 and 11, the driving current supplied from the current mirror circuit is a temperature-compensated current or a nearly-temperature-compensated current. The current in the circuit of FIG. 11 may be a current approximately proportional to absolute temperature (PTAT).

Even though the driving current has some negative temperature characteristic, the current of a negative temperature characteristic flows through resistor R4 (and R5), so that, if the current flowing through the diode D1 (and diodes D2) has a positive temperature characteristic, the voltage generated across the resistor R3 has a positive temperature characteristic. The divided voltage by the resistors R1 and R2 has a negative temperature characteristic. Thus, by addition with weights, it is possible to cancel out the temperature characteristics in the reference voltage Vref.

In actuality, if expressed like the equation (10), ΔV_{F} may be expressed as

$$\begin{matrix}Δ {V}_{F} = {V}_{T} ln \{ \frac{N ( {I}_{1} - \frac{{V}_{F 1}}{{R}_{5}} )}{{I}_{2} - \frac{{V}_{F 2}}{{R}_{1} + {R}_{2}} - \frac{{V}_{F 1}}{{R}_{4}}} \} \\ = {V}_{T} ln \{ \frac{N ( 1 - \frac{{V}_{F 1}}{{R}_{5} {I}_{1}} )}{1 - \frac{{V}_{F 2}}{( {R}_{1} + {R}_{2} ) {I}_{1}} - \frac{{V}_{F 1}}{{R}_{4}}} \} .\end{matrix} \\ where 11 = 12. \qquad ( 38 )$$

Thus, in order for the reference voltage to be a temperature-compensated voltage, the following expression:

$$\begin{matrix}\frac{\partial Vref}{\partial T} = α \frac{\partial {V}_{F 1}}{\partial T} + ln ( \frac{N ( 1 - \frac{{V}_{F 1}}{{R}_{5} {I}_{1}} )}{1 - \frac{{V}_{F 2}}{( {R}_{1} + {R}_{2} ) {I}_{1}} - \frac{{V}_{F 1}}{{R}_{4}}} ) \frac{\partial {V}_{T}}{\partial T} + \\ {V}_{T} \frac{\partial }{\partial T} [ ln \{ \frac{N ( 1 - \frac{{V}_{F 1}}{{R}_{5} {I}_{1}} )}{1 - \frac{{V}_{F 2}}{( {R}_{1} + {R}_{2} ) {I}_{1}} - \frac{{V}_{F 1}}{{R}_{4}}} \} ] \\ = α \frac{\partial {V}_{F 1}}{\partial T} + ln ( \frac{N ( 1 - \frac{{V}_{F 1}}{{R}_{5} {I}_{1}} )}{1 - \frac{{V}_{F 2}}{( {R}_{1} + {R}_{2} ) {I}_{1}} - \frac{{V}_{F 1}}{{R}_{4}}} ) \\ \frac{k}{q} + {V}_{T} \frac{\partial }{\partial T} [ ln \{ \frac{N ( 1 - \frac{{V}_{F 1}}{{R}_{5} {I}_{1}} )}{1 - \frac{{V}_{F 2}}{( {R}_{1} + {R}_{2} ) {I}_{2}} - \frac{{V}_{F 1}}{{R}_{4}}} \} ] \\ \approx 0\end{matrix} \qquad ( 39 )$$

has to hold.

It is possible to enlarge the variable range, with temperature, of the value of the denominator in ln according to the equation (38) as well as to render the anti-log in ln large or small at lower and higher temperatures, respectively. That is, by making the temperature characteristic of the product of this log value and V_{T}, that is, ΔV_{BE}, a curved line, it is possible to compensate the temperature non-linearity proper to a diode more readily than with the Nagano's reference voltage circuit shown in FIG. 3.

A reference voltage circuit that outputs a reference voltage not higher than 250 mV has now been produced. The diode's forward voltage is varied in an approximate range from 1V to 0.5V for a temperature range from −50° C. to 125° C. Hence, the minimum power supply voltage is 1.2V if VDS≧0.2V, which allows for the operation in the saturation range of the transistors M1 and M2 of the current mirror circuit, is secured.

### EXAMPLE 5

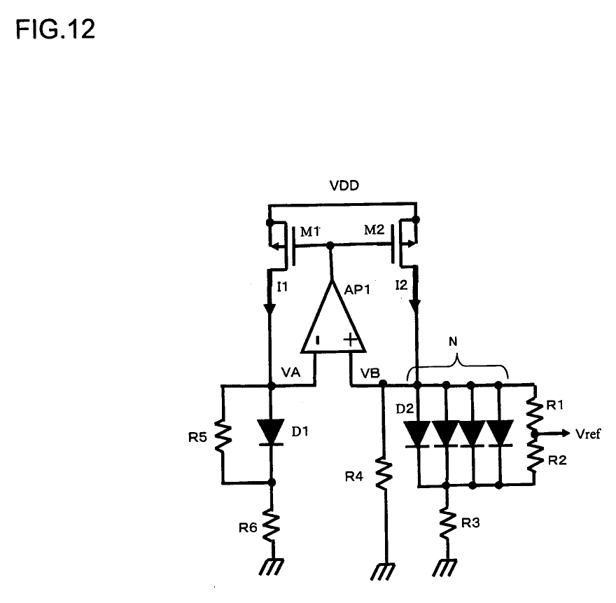

FIG. 12 depicts a circuit diagram showing a specific example of a reference voltage circuit according to claim 6 of the present application. In FIG. 12, a diode D1 is a unit diode, whilst an N-number of diodes D2 are connected in parallel with one another.

A first current-to-voltage converter (I-V1) includes a grounded parallel connection of a diode D1 and a resistor R5 and a resistor R6 connected in series with the parallel connection. A second current-to-voltage converter (I-V2) includes a parallel connection of a plurality of diodes D2 and a series-connected resistors R1, R2, a resistor R3 connected in series with the parallel connection and grounded, and a resistor R4 connected in parallel with the series connection. A mid-point terminal of the resistors R1 and R2 connected in series is a reference voltage output so that it constitutes an output circuit that outputs a reference voltage Vref.

The terminal voltages of the first current-to-voltage converter (I-V1) and the second current-to-voltage converter (I-V2) are connected to an inverting input terminal (−) and a non-inverting input terminal (+) of an OP amp (AP1), respectively.

The first current-to-voltage converter (I-V1) and the second current-to-voltage converter (I-V2) are respectively driven with currents I1 and I2 by the transistors M1 and M2 that constitute a current mirror circuit. The coupled gates of the transistors M1 and M2 of the current mirror circuit are connected to an output terminal of the OP amp (AP1) so that the voltages at respective terminals VA and VB are controlled to be equal to each other.

The operation of the circuit of FIG. 12 is now described. In FIG. 12,

V_{F1}+R₆I₁=V_{F2}+R₃{I₂−(V_{F1}+R₆I₁)/R₄} (40)

ΔV_{F} is given by

ΔV_{F}=V_{F1}−V_{F2}=R₃{I₂−(V_{F1}+R₆I₁)/R₄}−R₆I₁ (41)

The reference voltage Vref is expressed by the sum of ΔV_{F} and the voltage by dividing the voltage V_{F2} across the diode D2, and is given by

$$\begin{matrix}Vref = {R}_{6} {I}_{1} + Δ {V}_{F} + \frac{{R}_{2}}{{R}_{1} + {R}_{2}} {V}_{F 2} \\ = {R}_{6} {I}_{1} + Δ {V}_{F} + \frac{{R}_{2}}{{R}_{1} + {R}_{2}} {V}_{F 2} \\ = α {V}_{F 2} + Δ {V}_{F} + {R}_{6} {I}_{1}\end{matrix} \qquad ( 42 )$$

In actuality, if expressed after the equation (10), ΔV_{F} may he expressed as

$$\begin{matrix}Δ {V}_{F} = {V}_{T} ln \{ \frac{N ( {I}_{1} - \frac{{V}_{F 1}}{{R}_{6}} )}{{I}_{2} - \frac{{V}_{F 2}}{{R}_{1} + {R}_{2}} - \frac{{V}_{F 1} + {R}_{6} {I}_{1}}{{R}_{4}}} \} \\ = {V}_{T} ln \{ \frac{N ( 1 - \frac{{V}_{F 1}}{{R}_{6} {I}_{1}} )}{1 - \frac{{V}_{F 2}}{( {R}_{1} + {R}_{2} ) {I}_{1}} - \frac{{V}_{F 1} + {R}_{6} {I}_{1}}{{R}_{4} {I}_{1}}} \}\end{matrix} \qquad ( 43 )$$

where I1=I2.

The equation (43) differs slightly from the equations (7) or (14) as to addition of a term R₆I₁. However, in both of the circuits of FIGS. 6 and 12, the driving current supplied from the current mirror circuit is the temperature-compensated current or the nearly-temperature-compensated current.

The current in the circuit of FIG. 12 may be a current approximately proportional to temperature (PTAT). Even though the driving current has some negative temperature characteristic, the current of a negative temperature characteristic flows through resistors R4, so that, if the current flowing through the diodes D2 has a positive temperature characteristic, the voltage generated across the resistor R3 has a positive temperature characteristic. The divided voltage by the resistors R1 and R2 has a negative temperature characteristic. Thus, by addition with weights, it is possible to cancel out the temperature characteristics in the reference voltage Vref.

Hence, the circuit of FIG. 12 is fairly akin to the conceptualized circuit diagram shown in FIG. 6, and is a specific example circuit that outputs a reference voltage not higher than 250 mV.

It may be seen that the equation for this reference voltage is the equation (V_{F2}+ΔV_{F}) of the voltage mode reference voltage equivalent to the equations (7) and (14) plus the voltage drop (R₆I₁) by the resistor R6. It may thus be seen that, in order for the reference voltage Vref to be a temperature-compensated voltage, these two elements (αVF2+ΔVf) and (R₆I₁) need to be set such as to provide temperature-compensated voltages, as a principle.

The equation (43) may be expressed by

$$\begin{matrix}Vref = \frac{{R}_{1} {R}_{6}}{{R}_{3} {R}_{4} - {R}_{4} {R}_{6} - {R}_{3} {R}_{6}} {V}_{F 1} + \frac{{R}_{2}}{{R}_{1} + {R}_{2}} {V}_{F 2} + \\ \frac{{R}_{3} {R}_{4} - {R}_{1} {R}_{6}}{{R}_{3} {R}_{4} - {R}_{4} {R}_{6} - {R}_{3} {R}_{6}} Δ {V}_{F} \\ = {α}_{1} {V}_{F 1} + {α}_{2} {V}_{F 2} + β Δ {V}_{F}\end{matrix} \qquad ( 44 )$$

by eliminating the current I1 with the use of the equation (36).

Thus, in order for the reference voltage Vref to be a temperature-compensated voltage, the following equation:

$$\begin{matrix}\frac{\partial Vref}{\partial T} = {α}_{1} \frac{\partial {V}_{F 1}}{\partial T} + {α}_{2} \frac{\partial {V}_{F 2}}{\partial T} + \\ β ln \{ \frac{N ( 1 - \frac{{V}_{F 1}}{{R}_{6} {I}_{1}} )}{1 - \frac{{V}_{F 2}}{( {R}_{1} + {R}_{2} ) {I}_{1}} - \frac{{V}_{F 1} + {R}_{6} {I}_{1}}{{R}_{4} {I}_{1}}} \} \frac{\partial {V}_{I}}{\partial T} + \\ β {V}_{T} \frac{\partial }{\partial T} [ ln \{ \frac{N ( 1 - \frac{{V}_{F 1}}{{R}_{6} {I}_{1}} )}{1 - \frac{{V}_{F 2}}{( {R}_{1} + {R}_{2} ) {I}_{1}} - \frac{{V}_{F 1} + {R}_{6} {I}_{1}}{{R}_{6} {I}_{1}}} \} ] \\ = {α}_{1} \frac{\partial {V}_{F 1}}{\partial T} + {α}_{2} \frac{\partial {V}_{F 2}}{\partial T} + \\ β ln ( \frac{N ( 1 - \frac{{V}_{F 1}}{{R}_{6} {I}_{1}} )}{1 - \frac{{V}_{F 2}}{( {R}_{1} + {R}_{2} ) {I}_{1}} - \frac{{V}_{F 1} + {R}_{6} {I}_{1}}{{R}_{4} {I}_{1}}} ) \frac{k}{q} + \\ β {V}_{T} \frac{\partial }{\partial T} [ ln \{ \frac{N ( 1 - \frac{{V}_{F 1}}{{R}_{6} {I}_{1}} )}{1 - \frac{{V}_{F 2}}{( {R}_{1} {R}_{2} ) {I}_{1}} - \frac{{V}_{F 1} + {R}_{6} {I}_{1}}{{R}_{4} {I}_{1}}} \} ] \\ \approx 0\end{matrix} \qquad ( 45 )$$

has to hold.

It is possible to enlarge the variable range, with temperature, of the value of the denominator in ln of the equation (43) as well as to render the anti-log of ln large or small at lower and higher temperatures, respectively.

That is, by making the temperature characteristic of the product of this log value and V_{T}, that is, ΔV_{BE}, a curved line, it is possible to compensate the temperature non-linearity proper to a diode, more readily than with the Nagano's reference voltage circuit shown in FIG. 3. A reference voltage circuit that outputs a reference voltage not higher than 250 mV may thus be produced.

The diode's forward voltage is varied in an approximate range from 1V to 0.5V for a temperature range from −50° C. to 125° C. Hence, the minimum power supply voltage is 1.2V if V_{DS}≧0.2V, which allows for the operation in the saturation range of the transistors M1 and M2 of the current mirror circuit, is secured.

### EXAMPLE 6

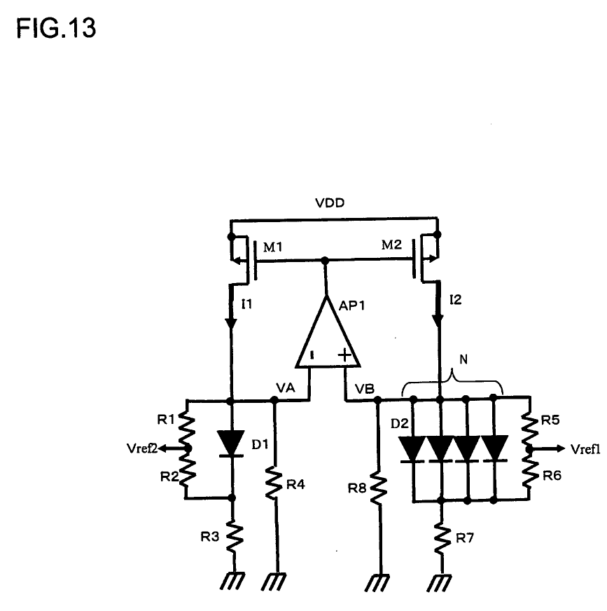

FIG. 13 depicts a circuit diagram showing a specific example of a reference voltage circuit according to claim 7 of the present application. In FIG. 13, a diode D1 is a unit diode, whilst an N-number of diodes D2 are connected in parallel with one another. A first current-to-voltage converter (I-V1) includes a parallel connection of a diode D1 and series-connected resistors R1 and R2, a resistor R3 connected in series with the parallel connection and a resistor R4 connected in parallel with the series connection. A second current-to-voltage converter (I-V2) includes a parallel connection of a plurality of diodes D2 and series-connected resistors R5 and R6, a resistor R7 connected in series with the parallel connection, and a resistor R8 connected in parallel with the series connection. A mid-point terminal of the series-connected resistors R5 and R6 and a mid-point terminal of the resistors R1 and R2 connected in series are reference voltage outputs to constitute output circuits that output reference voltages Vref1 and Vref2.

The terminal voltage of the first current-to-voltage converter (I-V1), made up of the diode D1, series-connected resistors R1, R2 connected in parallel with the diode D1, the resistor R3 connected in series with the resulting parallel connection and the resistor R4 connected in parallel with the series connection, is connected to the inverting input terminal (−) of the OP amp AP1. The terminal voltage of the second current-to-voltage converter (I-V2), made up of the parallel connection of the a plurality of diodes D2 and the series-connected resistors R5 and R6, the resistor R7 connected in series with the parallel connection and the resistor R8 connected in parallel with the series connection, is connected to the non-inverting input terminal (+) of the OP amp AP1.

The first current-to-voltage converter (I-V1) and the second current-to-voltage converter (I-V2) are respectively driven with currents I1 and I2 by the transistors M1 and M2 that constitute a current mirror circuit.

The coupled gates of the transistors M1 and M2 of the current mirror circuit are connected to an output terminal of the OP amp (AP1) so that the voltages at respective terminals VA and VB are controlled to be equal to each other.

The operation of the circuit of FIG. 13 is now described. In FIG. 13,

V_{F1}+R₃(I₁−V_{A}/R₄)=V_{F2}+R₇(I₂−V_{B}/R₈) (46)

and

$$\begin{matrix}{I}_{1} = \frac{{V}_{A}}{{R}_{4}} + \frac{{V}_{A} - {V}_{F 1}}{{R}_{3}} & ( 47 ) \\ {I}_{2} = \frac{{V}_{B}}{{R}_{8}} + \frac{{V}_{B} - {V}_{F 2}}{{R}_{7}} & ( 48 )\end{matrix}$$

With I1=I2 and VA=VB, VA may be found by:

$$\begin{matrix}{V}_{A} = ( {V}_{B} = ) \frac{\frac{{V}_{F 1}}{{R}_{1}} - \frac{{V}_{F 2}}{{R}_{7}}}{\frac{1}{{R}_{3}} + \frac{1}{{R}_{4}} - \frac{1}{{R}_{7}} - \frac{1}{{R}_{8}}} \\ = \frac{1}{1 + \frac{{R}_{3}}{{R}_{4}} - \frac{{R}_{3}}{{R}_{7}} - \frac{{R}_{3}}{{R}_{8}}} {V}_{F 1} - \frac{1}{\frac{{R}_{7}}{{R}_{3}} + \frac{{R}_{7}}{{R}_{4}} - 1 - \frac{{R}_{7}}{{R}_{8}}} {V}_{F 2}\end{matrix} \qquad ( 49 )$$

From the equation (46), ΔV_{F} is expressed as

$$Δ {V}_{F} = {V}_{F 1} - {V}_{F 2} = ( {R}_{7} - {R}_{3} ) {I}_{1} + ( \frac{{R}_{3}}{{R}_{4}} - \frac{{R}_{7}}{{R}_{8}} ) {V}_{A} \qquad ( 50 )$$

while the current I1 is expressed as

$${I}_{1} = ( {I}_{2} = ) \frac{1}{{R}_{7} - {R}_{3}} Δ {V}_{F} - \frac{1}{{R}_{7} - {R}_{3}} ( \frac{{R}_{3}}{{R}_{4}} - \frac{{R}_{7}}{{R}_{8}} ) {V}_{A} \qquad ( 51 )$$

Hence, the reference voltage Vref is represented by the sum of ΔV_{F} and the divided voltage of the diodes D1, D2, and may be found by:

$$\begin{matrix}\begin{matrix}{Vref}_{1} = {R}_{7} ( {I}_{2} - \frac{{V}_{B}}{{R}_{8}} ) + \frac{{R}_{6}}{{R}_{5} + {R}_{6}} {V}_{F 2} \\ = \frac{{R}_{7}}{{R}_{7} - {R}_{3}} {V}_{F} - \{ \frac{{R}_{7}}{{R}_{7} - {R}_{1}} ( \frac{{R}_{3}}{{R}_{4}} - \frac{{R}_{7}}{{R}_{8}} ) + \frac{{R}_{7}}{{R}_{8}} \} {V}_{A} + \\ \frac{{R}_{5}}{{R}_{5} + {R}_{6}} {V}_{F 2} \\ = \frac{{R}_{7}}{{R}_{7} - {R}_{3}} Δ {V}_{F} - \{ \frac{{R}_{7}}{{R}_{7} - {R}_{3}} ( \frac{{R}_{3}}{{R}_{4}} - \frac{{R}_{7}}{{R}_{8}} ) + \frac{{R}_{7}}{{R}_{8}} \} \\ \frac{1}{1 + \frac{{R}_{3}}{{R}_{4}} - \frac{{R}_{3}}{{R}_{7}} - \frac{{R}_{3}}{{R}_{8}}} {V}_{F 1} + \\ [ \{ \frac{{R}_{7}}{{R}_{7} - {R}_{3}} ( \frac{{R}_{3}}{{R}_{4}} - \frac{{R}_{7}}{{R}_{8}} ) + \frac{{R}_{7}}{{R}_{8}} \} \\ \frac{1}{\frac{{R}_{7}}{{R}_{3}} + \frac{{R}_{7}}{{R}_{4}} - 1 - \frac{{R}_{7}}{{R}_{8}}} + \frac{{R}_{5}}{{R}_{5} + {R}_{6}} ] {V}_{F 2} \\ = {α}_{11} {V}_{F 1} + {α}_{12} {V}_{F 2} + {β}_{1} {V}_{F}\end{matrix} & ( 52 ) \\ and & \\ \begin{matrix}{Vref}_{1} = {R}_{7} ( {I}_{2} - \frac{{V}_{8}}{{R}_{8}} ) + \frac{{R}_{6}}{{R}_{5} + {R}_{6}} {V}_{F 2} \\ = \frac{{R}_{7}}{{R}_{7} - {R}_{3}} Δ {V}_{F} - \{ \frac{{R}_{7}}{{R}_{7} - {R}_{3}} ( \frac{{R}_{3}}{{R}_{4}} - \frac{{R}_{7}}{{R}_{8}} ) + \frac{{R}_{7}}{{R}_{8}} \} {V}_{A} + \\ \frac{{R}_{5}}{{R}_{5} + {R}_{6}} {V}_{F 2} \\ = \frac{{R}_{7}}{{R}_{7} - {R}_{3}} Δ {V}_{F} - \{ \frac{{R}_{7}}{{R}_{7} - {R}_{3}} ( \frac{{R}_{3}}{{R}_{4}} - \frac{{R}_{7}}{{R}_{8}} ) + \frac{{R}_{7}}{{R}_{8}} \} \\ \frac{1}{1 + \frac{{R}_{3}}{{R}_{4}} - \frac{{R}_{3}}{{R}_{7}} - \frac{{R}_{3}}{{R}_{8}}} {V}_{F 1} + \\ [ \{ \frac{{R}_{7}}{{R}_{7} - {R}_{3}} ( \frac{{R}_{3}}{{R}_{4}} - \frac{{R}_{7}}{{R}_{8}} ) + \frac{{R}_{7}}{{R}_{8}} \} \\ \frac{1}{\frac{{R}_{7}}{{R}_{3}} + \frac{{R}_{7}}{{R}_{4}} - 1 - \frac{{R}_{7}}{{R}_{8}}} + \frac{{R}_{5}}{{R}_{5} + {R}_{6}} ] {V}_{F 2} \\ = {α}_{11} {V}_{F 1} + {α}_{12} {V}_{F 2} + {β}_{1} Δ {V}_{F}\end{matrix} & ( 53 )\end{matrix}$$

The equations (52) and (53) are approximately equivalent to the equation (7) and also to the equation (14). That is, the circuit of FIG. 13 is equivalent to the conceptualized circuit diagram of FIG. 6, and is an example of an actual circuit that outputs a reference voltage equal to or less than 250 mV.

Strictly speaking, there is an obvious difference between the two circuits. That is, in the circuit of FIG. 6, the driving current supplied from the current mirror circuit is a temperature-compensated current or a nearly-temperature-compensated current. In the circuit of FIG. 13, the driving current supplied from the current mirror circuit is a temperature-compensated current or a nearly-temperature-compensated current.

In the circuit of FIG. 13, the current may be a current approximately proportional to absolute temperature (PTAT).

Even though the driving current has some negative temperature characteristic, the current of a negative temperature characteristic flows through resistors R8 (and R4), so that, if the current flowing through the diodes D2 (and diode D1) has a positive temperature characteristic, the voltage generated across the resistor R7 (and resistor R3) is of a positive temperature characteristic. The divided voltage by the resistors R5 and R6 (and that by the resistors R1 and R2) are of a negative temperature characteristic. Thus, by addition with weights, it is possible to compensate temperature characteristics in the reference voltage Vref1 (and the reference voltage Vref2).

In actuality, if expressed after the equation (10), ΔV_{F} may be expressed as

$$\begin{matrix}Δ {V}_{F} = {V}_{T} ln \{ \frac{N ( {I}_{1} - \frac{{V}_{F 1}}{{R}_{1} + {R}_{2}} - \frac{{V}_{A}}{{R}_{4}} )}{{I}_{2} - \frac{{V}_{F 2}}{{R}_{5} + {R}_{6}} - \frac{{V}_{A}}{{R}_{8}}} \} \\ = {V}_{T} ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \}\end{matrix} \qquad ( 54 )$$

Thus, in order for the reference voltages Vref1 and Vref2 to be temperature-compensated voltages, the following expression:

$$\begin{matrix}\begin{matrix}\frac{\partial {Vref}_{1}}{\partial T} = {α}_{11} \frac{\partial {V}_{F 1}}{\partial T} + {α}_{12} \frac{\partial {V}_{F 2}}{\partial T} + \\ {β}_{1} ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} \frac{\partial {V}_{T}}{\partial T} + \\ {β}_{1} {V}_{T} \frac{\partial }{\partial T} [ ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{i}}} \} ] \\ = {α}_{11} \frac{\partial {V}_{F 1}}{\partial T} + {α}_{12} \frac{\partial {V}_{F 2}}{\partial T} + \\ {β}_{1} ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} \frac{k}{q} + \\ {β}_{1} {V}_{T} \frac{\partial }{\partial T} [ ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} ] \\ \approx 0\end{matrix} & ( 55 ) \\ \begin{matrix}\frac{\partial {Vref}_{2}}{\partial T} = {α}_{21} \frac{\partial {V}_{F 1}}{\partial T} + {α}_{22} \frac{\partial {V}_{F 2}}{\partial T} + \\ {β}_{2} ln ( \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} ) \frac{\partial {V}_{T}}{\partial T} + \\ {β}_{2} {V}_{T} \frac{\partial }{\partial T} \{ ln ( \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} ) \} \\ = {α}_{21} \frac{\partial {V}_{F 1}}{\partial T} + {α}_{22} \frac{\partial {V}_{F 2}}{\partial T} + \\ {β}_{2} ln ( \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} ) \frac{k}{q} + \\ {β}_{2} {V}_{T} \frac{\partial }{\partial T} [ ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} ] \\ \approx 0\end{matrix} & ( 56 )\end{matrix}$$

has to hold.

It is possible to enlarge the variable range, with temperature, of the value of the denominator in ln of the equation (54) as well as to render the anti-log of ln large or small at lower and higher temperatures, respectively. That is, by making the temperature characteristic of the product of this log value and V_{T}, that is, ΔV_{BE}, a curved line, it is possible to compensate the diode's temperature non-linearity more readily than with the Nagano's reference voltage circuit shown in FIG. 3. A reference voltage circuit that outputs a reference voltage not higher than 250 mV may thus be produced.

The diode's forward voltage VF is varied in an approximate range from about 1V to 0.5V for a temperature range from −50° C. to 125° C. Hence, the minimum power supply voltage is 1.2V if V_{DS}≧0.2V, which allows for the operation in the saturation range of the transistors M1 and M2 of the current mirror circuit, is secured.

### EXAMPLE 7

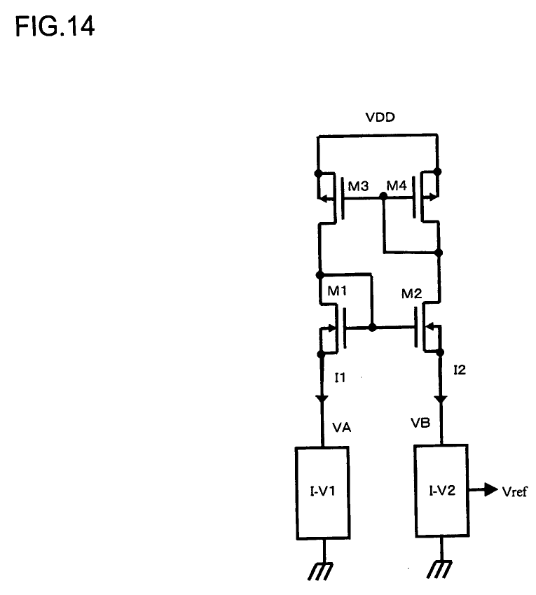

FIG. 14 depicts a diagram, partially shown in blocks, showing an arrangement of a reference voltage circuit according to claims 1 to 6 of the present application in a generalized form. In the Example for claim 1 of the present application, described so far in detail, the OP amp (AP1) is used as control means for controlling preset voltages to be equal to each other. It is however possible to use a current mirror circuit, in place of the OP amp (AP1), as control means for controlling preset voltages to be equal to each other. Specifically, FIG. 7, showing a reference voltage circuit employing a basic OP amp as control means, in a block diagram, may be reformulated as shown in FIG. 14.

A reference voltage Vref is derived as a mid-point terminal of a second current-to-voltage converter (I-V2). A reference voltage Vref2 may be derived from a mid-point terminal of a first current-to-voltage converter (I-V1), depending on the type of the circuit used.

Referring to FIG. 14, a first current mirror circuit includes transistors M1 and M2, while a second current mirror circuit includes transistors M3 and M4. Each of the transistors M1, M4 has a gate and a drain connected in common. The transistors M1 and M3 are cascoded, while the transistors M2 and M4 are also cascoded.

A first current-to-voltage converter (I-V1) and a second current-to-voltage converter (I-V2) are connected to the sources of the transistors M1 and M2, respectively. A mid-point terminal voltage of the second current-to-voltage converter (I-V2) is obtained as a reference voltage Vref.

Alternatively, depending on a circuit used, a reference voltage Vref2 may also be obtained as a mid-point terminal voltage of the first current-to-voltage converter (I-V1).

The operation of the circuit of FIG. 14 is now described. In FIG. 14, a first current mirror circuit includes transistors M1 and M2, while the second current-to-voltage converter (I-V2) includes transistors M3 and M4.

The transistors M1 and M4 have gates and drains connected in common so that the two current mirror circuits share the same current. That is, a current I1 flows through the transistors M1 and M3, while a current I2 floes through the transistors M2 and M4.

The transistors M1 and M2 have sources connected respectively to the first current-to-voltage converter (I-V1) and the second current-to-voltage converter (I-V2), and are operated so that currents I1 and I2 flowing through the transistors will be equal to each other. In this case, terminal voltages VA and VB of the current-to-voltage converters are equal to each other.

The reference voltage Vref is obtained from a mid-point terminal of the second current-to-voltage converter (I-V2). Depending on a circuit used, a reference voltage Vref2 may also be obtained as a mid-point terminal voltage of the first current-to-voltage converter (I-V1).

### EXAMPLE 7-1

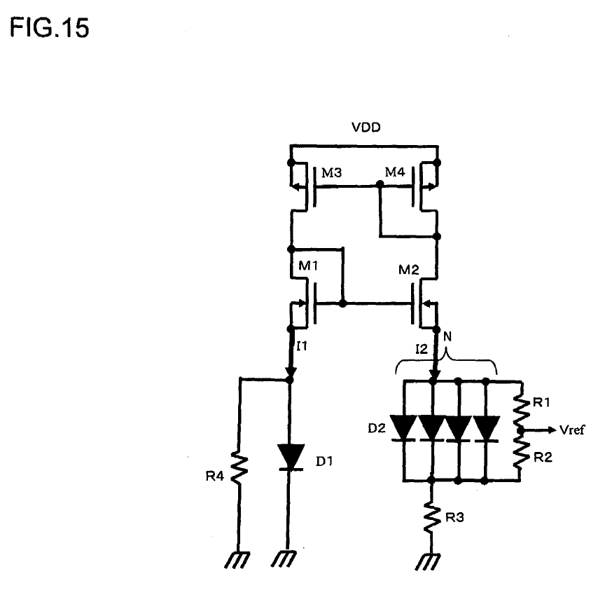

If, in the Example described with reference to FIG. 14, it is supposed that the first current-to-voltage converter (I-V1) and the second current-to-voltage converter (I-V2) are replaced respectively by a first current-to-voltage converter (I-V1) and a second current-to-voltage converter (I-V2) of FIG. 8 that use the original OP amp as control means, there may be obtained a reference voltage circuit that uses a current mirror circuit in substitution for the OP amp AP1. This reference voltage circuit exercises control so that preset voltages will be equal to each other. It is noted that, in FIG. 8, the first current-to-voltage converter (I-V1) includes the parallel connection of a diode Q1 and a resistor R4, while the second current-to-voltage converter (I-V2) includes a parallel connection of a plurality of diodes Q2 and series-connected resistors R1 and R2, and a resistor R3 connected in series with the parallel connection of the diodes Q2 and (R1, R2). FIG. 15 shows a specific implementing circuit. In the circuit of FIG. 15, the OP amp of FIG. 8 has been replaced by the current mirror circuit (M1 to M4) of FIG. 14.

Referring to FIG. 15, the reference voltage circuit includes p-channel MOS transistors M3 and M4 that have sources connected to a power supply VDD and that have gates connected in common. The p-channel transistor M4 has its gate and drain connected together. The reference voltage circuit also includes n-channel MOS transistors M1 and M2. The n-channel MOS transistor M1, having a gate and a drain connected to each other, is connected to the drain of the p-channel MOS transistor M3. The n-channel MOS transistor M2 is connected to the drain of the p-channel MOS transistor M4.

The first current-to-voltage converter (I-V1), including a parallel connection of the diode D1 and the resistor R4, is connected between the source of the n-channel MOS transistor M1 and the ground.

The second current-to-voltage converter (I-V2) is connected between the source of the n-channel MOS transistor M2 and the ground. The second current-to-voltage converter (I-V2) includes the parallel connection of the a plurality of diodes D2 and the series-connected resistors R1, R2, and the resistor R3 connected in series with the resulting parallel connection, as described above. A mid-point terminal of the resistors R1 and R2 connected in series forms an output terminal for the reference voltage Vref.

The operation of the circuit of FIG. 15 is now described. In FIG. 15, a common current I1 flows through the p-channel MOS transistor M3 and the n-channel MOS transistor M1, while a common current I2 flows through the p-channel MOS transistor M4 and the n-channel MOS transistor M2.

The currents I1 and I2 are set so as to be equal to each other. Thus, the first current-to-voltage converter (I-V1), including the parallel connection of the diode D1 and the resistor R4, is driven by the current I1, while the second current-to-voltage converter (I-V2), including the parallel connection of the diodes D2 and the resistors R1 and R2 connected in series, and the resistor R3 connected in series with the parallel connection, is driven by the current I2.

In case the currents I1 and I2 are equal to each other, a terminal voltage VA of the first current-to-voltage converter (I-V1), including the parallel connection of the diode D1 and the resistor R4, becomes equal to a terminal voltage VB of the second current-to-voltage converter (I-V2), including the parallel connection of the diodes D2 and the resistors R1 and R2 connected in series, and the resistor R3 connected in series with the parallel connection.

In this case, a mid-point terminal voltage of the series-connected resistors R1 and R2 of the second current-to-voltage converter (I-V2) is output as a desired reference voltage Vref.

### EXAMPLE 7-2

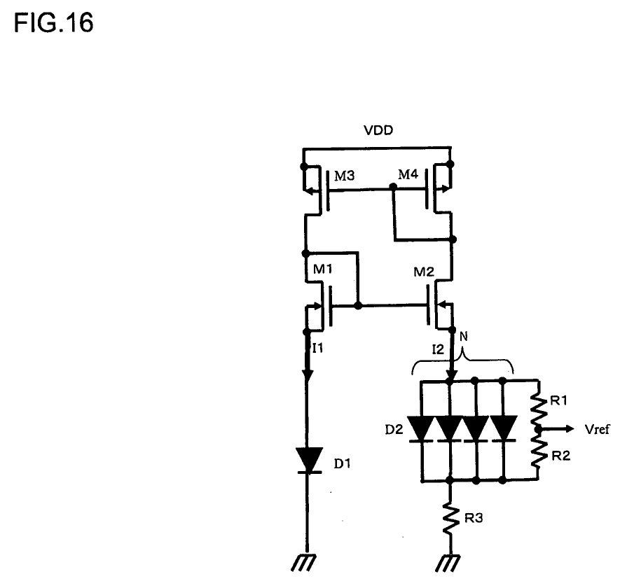

If, in the Example described with reference to FIG. 14, it is supposed that the first current-to-voltage converter (I-V1) and the second current-to-voltage converter (I-V2) are replaced respectively by a first current-to-voltage converter (I-V1) and a second current-to-voltage converter (I-V2) of FIG. 8 that use the original OP amp as control means, there may be obtained a reference voltage circuit that uses a current mirror circuit in substitution for the OP amp (AP1). This reference voltage circuit exercises control so that preset voltages will be equal to each other. It is noted that, in FIG. 8, the first current-to-voltage converter (I-V1) includes a diode Q1, and the second current-to-voltage converter (I-V2) includes a parallel connection of a plurality of diodes Q2 and resistors R1 and R2 connected in series, and a resistor R3 connected in series with the parallel connection. FIG. 16 shows a specific implementing circuit.

In the circuit of FIG. 16, the OP amp of FIG. 9 has been replaced by the current mirror circuit (M1 to M4) of FIG. 14. Referring to FIG. 16, there are provided p-channel MOS transistors M3 and M4 having sources connected to a power supply VDD and having gates connected in common. The p-channel MOS transistor M4 has a gate and a drain connected together. An n-channel MOS transistor M1, having a gate and a drain connected together, is connected to the drain of the p-channel MOS transistor M3. An n-channel MOS transistor M2 is connected to the drain of the p-channel MOS transistor M4.

The first current-to-voltage converter (I-V1), including the diode D1, is connected between the source of the n-channel MOS transistor M1 and the ground.

The second current-to-voltage converter (I-V2), including the parallel connection of the a plurality of diodes D2 and the series-connected resistors R1 and R2, and the resistor R3 connected in series with the parallel connection, is connected between the source of the p-channel MOS transistor M2 and the ground. A mid-point terminal of the series-connected resistors R1 and R2 is used as an output terminal of the reference voltage Vref.

The operation of the circuit of FIG. 16 is now described. A common current I1 flows through the p-channel MOS transistor M3 and the n-channel MOS transistor M1, while a common current I2 flows through the p-channel MOS transistor M4 and the n-channel MOS transistor M2. The currents I1 and I2 are set so as to be equal to each other. Thus, the first current-to-voltage converter (I-V1), including the diode D1, is driven by the current I1, while the second current-to-voltage converter (I-V2), including the parallel connection of a plurality of the diodes D2 and the series-connected resistors R1, R2, and the resistor R3 connected in series with the parallel connection, is driven by the current I2. In case the currents I1 and I2 are equal to each other, a terminal voltage VA of the first current-to-voltage converter (I-V1), including the first current-to-voltage converter (I-V1), including the diode D1, becomes equal to a terminal voltage VB of the second current-to-voltage converter (I-V2), including the parallel connection of the diodes D2 and the series-connected resistors R1, R2 and the resistor R3 connected in series with the parallel connection.

In this case, a mid-point terminal voltage of the series-connected resistors R1 and R2 of the second current-to-voltage converter (I-V2) is output as a desired reference voltage Vref.

### EXAMPLE 7-3

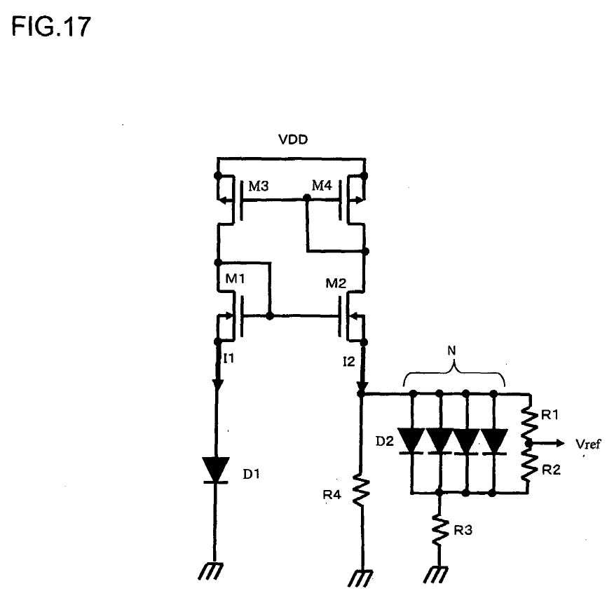

If, in the Example described with reference to FIG. 14, it is supposed that the first current-to-voltage converter (I-V1) and the second current-to-voltage converter (I-V2) are replaced respectively by a first current-to-voltage converter (I-V1) and a second current-to-voltage converter (I-V2) of FIG. 10 that use the original OP amp as control means, there may be obtained a reference voltage circuit that uses a current mirror circuit in substitution for the OP amp (AP1). This reference voltage circuit exercises control so that preset voltages will be equal to each other. It is noted that, in FIG. 10, the first current-to-voltage converter (I-V1) is a diode D1, and the second current-to-voltage converter (I-V2) includes a parallel connection of a plurality of diodes D2 and series-connected resistors R1 and R2, a resistor R3 connected in parallel with the series connection and a resistor R4 connected in parallel with the series connection. FIG. 17 shows a specific implementing circuit.

In the circuit of FIG. 17, the OP amp of FIG. 10 has been replaced by the current mirror circuit (M1 to M4) of FIG. 14. Referring to FIG. 17, there are provided p-channel MOS transistors M3 and M4 having sources connected to a power supply VDD and having gates connected in common. The p-channel MOS transistor M4 has a gate and a drain connected together. An n-channel MOS transistor M1, having a gate and a drain connected together, is connected to the drain of the p-channel MOS transistor M3. An n-channel MOS transistor M2 is connected to the drain of the p-channel MOS transistor M4.

The first current-to-voltage converter (I-V1), including the diode D1, is connected between the source of the n-channel MOS transistor M1 and the ground.

The second current-to-voltage converter (I-V2), including the parallel connection of the diodes D2 and series-connected resistors R1 and R2, the resistor R3 connected in series with the resulting parallel connection and the resistor R4 connected in parallel with the series connection, is connected between the source of the p-channel MOS transistor M2 and the ground. A mid-point terminal of the series-connected resistors R1 and R2 is used as an output terminal of the reference voltage Vref.

The operation of the circuit of FIG. 17 is now described. A common current I1 flows through the p-channel MOS transistor M3 and the n-channel MOS transistor M1, while a common current I2 flows through the p-channel MOS transistor M4 and the n-channel MOS transistor M2. The currents I1 and I2 are set so as to be equal to each other.

Thus, the first current-to-voltage converter (I-V1), including the diode D1, is driven by the current I1, while the second current-to-voltage converter (I-V2), including the parallel connection of the diodes D2 and the series-connected resistors R1 and R2, the resistor R3 connected in series with the parallel connection of the diodes D2 and series resistor (R1, R2), and the resistor R4 connected in parallel with the series connection of the resistor R3 the parallel connection of the diodes D2 and series resistor (R1, R2) and is driven by the current I2.

In case the currents I1 and I2 are equal to each other, a terminal voltage VA of the first current-to-voltage converter (I-V1), including the diode D1, becomes equal to a terminal voltage VB of the second current-to-voltage converter (I-V2), including the parallel connection of the diodes D2 and the series-connected resistors R1, R2, the resistor R3 connected in series with the parallel connection and the resistor R4 connected in parallel with the series connection.

In this case, a mid-point terminal voltage of the series-connected resistors R1, R2 of the second current-to-voltage converter (I-V2) is output as a desired reference voltage Vref.

### EXAMPLE 7-4

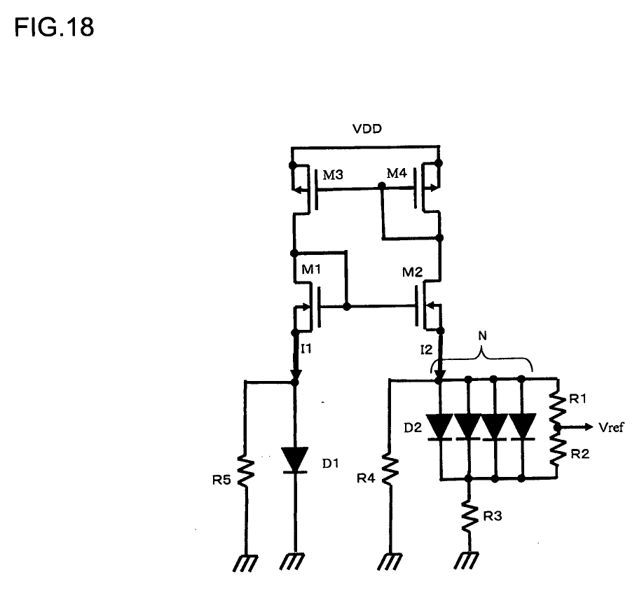

If, in the Example described with reference to FIG. 14, it is supposed that the first current-to-voltage converter (I-V1) and the second current-to-voltage converter (I-V2) are replaced respectively by a first current-to-voltage converter (I-V1) and a second current-to-voltage converter (I-V2) of FIG. 11 that use the original OP amp as control means, there may be obtained a reference voltage circuit that uses a current mirror circuit in substitution for the OP amp (AP1). This reference voltage circuit exercises control so that preset voltages will be equal to each other. It is noted that, in FIG. 11, the first current-to-voltage converter (I-V1) is a parallel connection of a diode D1 and a resistor R5, and the second current-to-voltage converter (I-V2) includes a parallel connection of a plurality of diodes D2 and series-connected resistors R1 and R2, a resistor R3 connected in parallel with the series connection and a resistor R4 connected in parallel with the series connection. FIG. 18 shows a specific implementing circuit.

In the circuit of FIG. 18, the OP amp of FIG. 11 has again been replaced by the current mirror circuit (M1 to M4) of FIG. 14. Referring to FIG. 18, there are provided p-channel MOS transistors M3 and M4 having sources connected to a power supply VDD and having gates connected in common. The p-channel MOS transistor M4 has a gate and a drain connected together. An n-channel MOS transistor M1, having a gate and a drain connected together, is connected to the drain of the p-channel MOS transistor M3. An n-channel MOS transistor M2 is connected to the drain of the p-channel MOS transistor M4.

The first current-to-voltage converter (I-V1), including the parallel connection of the diode D1 and the resistor R5, is connected between the source of the n-channel MOS transistor M1 and the ground.

The second current-to-voltage converter (I-V2), including the parallel connection of the diodes D2 and series-connected resistors R1 and R2, the resistor R3 connected in series with the parallel connection and the resistor R4 connected in parallel with the series connection, is connected between the source of the n-channel MOS transistor M2 and the ground. A mid-point terminal of the series-connected resistors R1 and R2 is used as an output terminal of the reference voltage Vref.

The operation of the circuit or FIG. 18 is now described. A common current I1 flows through the p-channel MOS transistor M3 and the n-channel MOS transistor M1, while a common current I2 flows through the p-channel MOS transistor M4 and the n-channel MOS transistor M2. The currents I1 and I2 are set so as to be equal to each other. Hence, the first current-to-voltage converter (I-V1), including the parallel connection of the diode D1 and the resistor R5, is driven by the current I1, while the second current-to-voltage converter (I-V2), including the parallel connection of the diodes D2 and the series-connected resistors R1 and R2, the resistor R3 connected in series with the parallel connection and the resistor R4 connected in parallel with the series connection, is driven by the current I2.

In case the currents I1 and I2 are equal to each other, a terminal voltage VA of the first current-to-voltage converter (I-V1), including the parallel connection of the diode D1 and the resistor R5, becomes equal to a terminal voltage VB of the second current-to-voltage converter (I-V2), including the parallel connection of the diodes D2 and series-connected resistors R1 and R2, the resistor R3 connected in series with the parallel connection and the resistor R4 connected in parallel with the series connection.

In this case, a mid-point terminal voltage of the series-connected resistors R1 and R2 of the second current-to-voltage converter (I-V2) is output as a desired reference voltage Vref.

### EXAMPLE 7-5

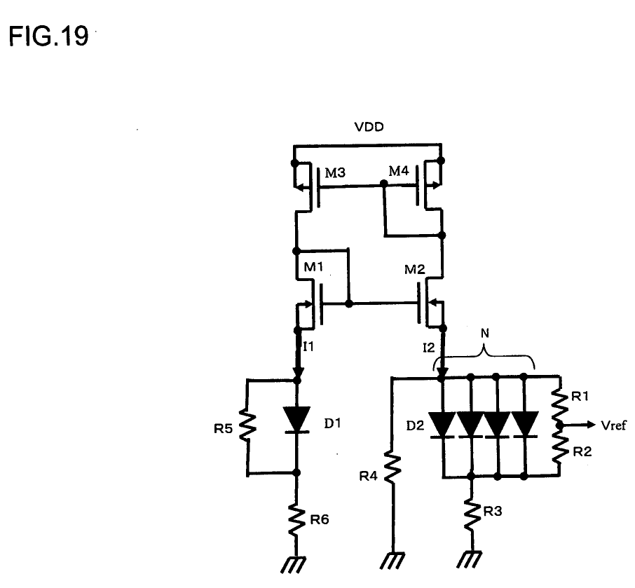

If, in the Example described with reference to FIG. 14, it is supposed that the first current-to-voltage converter (I-V1) and the second current-to-voltage converter (I-V2) are replaced respectively by a first current-to-voltage converter (I-V1) and a second current-to-voltage converter (I-V2) of FIG. 12 that use the original OP amp as control means, there may be obtained a reference voltage circuit that uses a current mirror circuit in substitution for the OP amp (AP1). This reference voltage circuit exercises control so that preset voltages will be equal to each other. It is noted that, in FIG. 12, the first current-to-voltage converter (I-V1) includes a parallel connection of a diode D1 and a resistor R5 and a resistor R6 connected in series with the parallel connection, and the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 19 shows a specific implementing, circuit.

In the circuit of FIG. 19, the OP amp of FIG. 12 has been replaced by the current mirror circuit (M1 to M4) of FIG. 14.

Referring to FIG. 19, there are provided p-channel MOS transistors M3 and M4 having sources connected to a power supply VDD and having gates connected in common. The p-channel MOS transistor M4 has a gate and a drain connected together. An n-channel MOS transistor M1, having a gate and a drain connected together, is connected to the drain of the p-channel MOS transistor M3. An n-channel MOS transistor M2 is connected to the drain of the p-channel MOS transistor M4.

The first current-to-voltage converter (I-V1), including the parallel connection of the diode D1 and the resistor R5 and the resistor R6 connected in series with the parallel connection, is connected between the source of the n-channel MOS transistor M1 and the ground.

The second current-to-voltage converter (I-V2), including the parallel connection of the diodes D2 and series-connected resistors R1 and R2, the resistor R3 connected in series with the parallel connection and the resistor R4 connected in parallel with the series connection, is connected between the source of the n-channel MOS transistor M2 and the ground. A mid-point terminal of the series-connected resistors R1 and R2 is used as an output terminal of the reference voltage Vref.

The operation of the circuit of FIG. 19 is now described. A common current I1 flows through the p-channel MOS transistor M3 and the n-channel MOS transistor M1, while a common current I2 flows through the p-channel MOS transistor M4 and the n-channel MOS transistor M2.

The currents I1 and I2 are set so as to be equal to each other. Hence, the first current-to-voltage converter (I-V1), including the parallel connection of the diode D1 and the resistor R4 and the resistor R6 connected in series with the parallel connection, is driven by the current I1, while the second current-to-voltage converter (I-V2), including the parallel connection of the diodes D2 and series-connected resistors R1 and R2, the resistor R3 connected in series with the parallel connection and the resistor R4 connected in parallel with the series connection, is driven by the current I2.

When the currents I1 and I2 are equal to each other, a terminal voltage VA of the first current-to-voltage converter (I-V1), including the parallel connection of the diode D1 and the resistor R4 and the resistor R6 connected in series with the parallel connection, becomes equal to a terminal voltage VB of the second current-to-voltage converter (I-V2), including the parallel connection of the diodes D2 and series-connected resistors R1 and R2, the resistor R3 connected in series with the parallel connection and the resistor R4 connected in parallel with the series connection.

In this case, a mid-point terminal voltage of the series-connected resistors R1 and R2 of the second current-to-voltage converter (I-V2) is output as a desired reference voltage Vref.

### EXAMPLE 7-6

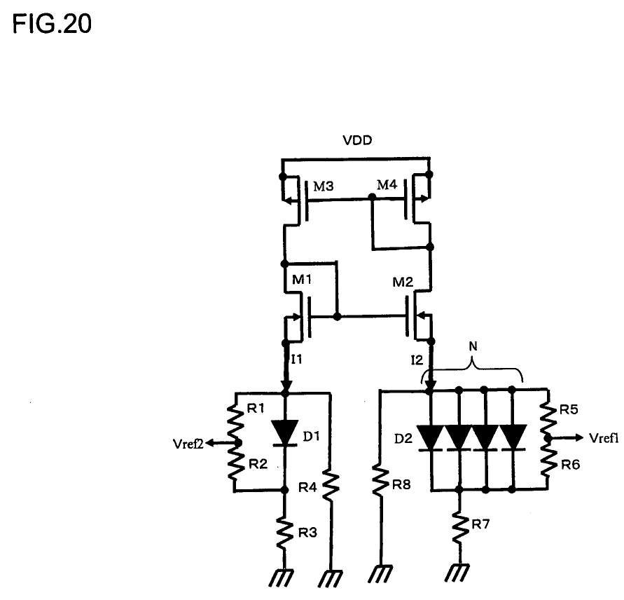

If, in the Example described with reference to FIG. 14, it is supposed that the first current-to-voltage converter (I-V1) and the second current-to-voltage converter (I-V2) are replaced respectively by a first current-to-voltage converter (I-V1) and a second current-to-voltage converter (I-V2) of FIG. 13 that use the original OP amp as control means, there may be obtained a reference voltage circuit that uses a current mirror circuit in substitution for the OP amp (AP1). This reference voltage circuit exercises control so that preset voltages will be equal to each other. It is noted that, in FIG. 13, the first current-to-voltage converter (I-V1) includes a parallel connection of a diode D1 and series-connected resistors R1 and R2 a resistor R3 connected in series with the parallel connection and a resistor R4 connected in series with the parallel connection, and the second current-to-voltage converter (I-V2) includes a parallel connection of a plurality of diodes D2 and series-connected resistors R5 and R6, a resistor R7 connected in series with the parallel connection and a resistor R8 connected in parallel with the series connection. FIG. 20 shows a specific implementing circuit.

In the circuit of FIG. 20, the OP amp of FIG. 13 has been replaced by the current mirror circuit (M1 to M4) of FIG. 14. Referring to FIG. 20, there are provided p-channel MOS transistors M3 and M4 having sources connected to a power supply VDD and having gates connected in common. The p-channel MOS transistor M4 has a gate and a drain connected together. An n-channel MOS transistor M1, having a gate and a drain connected together, is connected to the drain of the p-channel MOS transistor M3. An n-channel MOS transistor M2 is connected to the drain of the p-channel MOS transistor M4.

The first current-to-voltage converter (I-V1), including the parallel connection of the diode D1 and the series-connected resistors R1 and R2, the resistor R3 connected in series with the parallel connection and the resistor R4 connected in parallel with the series connection, is connected between the source of the n-channel MOS transistor M1 and the ground.

The second current-to-voltage converter (I-V2), including the parallel connection of the diodes D2 and the series-connected resistors R5 and R6, the resistor R7 connected in series with the parallel connection and the resistor R8 connected in parallel with the series connection, is connected between the source of the n-channel MOS transistor M2 and the ground.

A mid-point terminal of the series-connected resistors R1 and R2 of the first current-to-voltage converter (I-V1) is used as an output terminal of the reference voltage Vref2, while a mid-point terminal of the series-connected resistors R5 and R6 of the second current-to-voltage converter (I-V2) is used as an output terminal of the reference voltage Vref1.

The operation of the circuit of FIG. 20 is now described. A common current I1 flows through the p-channel MOS transistor M3 and the n-channel MOS transistor M1, while a common current I2 flows through the p-channel MOS transistor M4 and the n-channel MOS transistor M2.

The currents I1 and I2 are set so as to be equal to each other. Hence, the first current-to-voltage converter (I-V1), including the parallel connection of the diode D1 and the series-connected resistors R1 and R2, the resistor R3 connected in series with the parallel connection and the resistor R4 connected in parallel with the series connection, is driven by the current I1. The second current-to-voltage converter (I-V2), including the parallel connection of the diodes D2 and series-connected resistors R5 and R6, the resistor R7 connected in series with the parallel connection and the resistor R8 connected in parallel with the series connection, is driven by the current I2.

In case the currents I1 and I2 are equal to each other, a terminal voltage VA of the first current-to-voltage converter (I-V1), including the parallel connection of the diode D1 and the series-connected resistors R1 and R2, the resistor R3 connected in series with the parallel connection and the resistor R4 connected in parallel with the series connection, becomes equal to a terminal voltage VB of the second current-to-voltage converter (I-V2), including the parallel connection of the diodes D2 and series-connected resistors R5 and R6, the resistor R7 connected in series with the parallel connection and the resistor R8 connected in parallel with the series connection.

In this case, a mid-point terminal voltage of the series-connected resistors R1 and R2 of the first current-to-voltage converter (I-V1) is output as a desired preset reference voltage Vref2, and a mid-point terminal voltage of the series-connected resistors R5 and R6 of the second current-to-voltage converter (I-V2) is output as a desired preset reference voltages Vref1.

### EXAMPLE 8

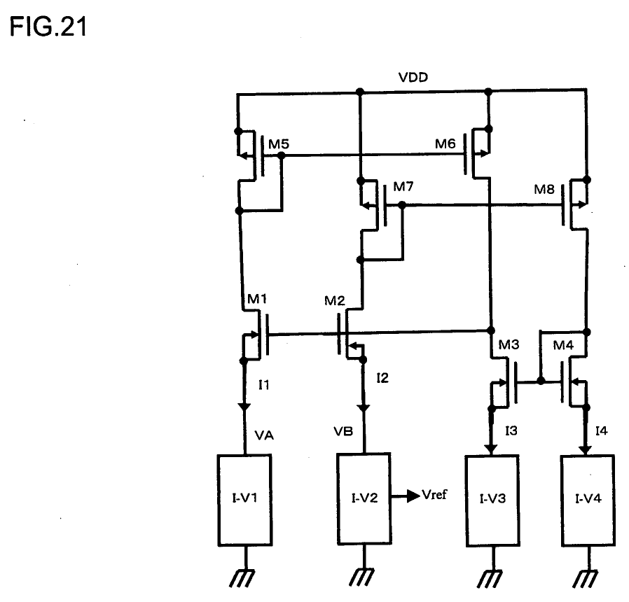

FIG. 21 depicts a diagram, partially shown in blocks, showing arrangements of a reference voltage circuit according to claims 1 to 6 of the present application, in a generalized form. In the Example of claim 1 of the present application, so far described in detail, the OP amp (AP1) is used as control means for controlling preset voltages to be equal to each other.

However, it is also possible to use a current mirror circuit, in place of the OP amp (AP1), to exercise control so that two preset voltages will become equal to each other. Specifically, FIG. 7, which is a circuit block diagram of a reference voltage circuit that uses an original OP amp as control means, may be reformulated as shown in FIG. 21. It should be noted that selection of the first current-to-voltage converter (I-V1), having a smaller number of diodes, as each of the two current-to-voltage converters (I-V3, I-V4), is more desirable for the objective of reducing the chip size, as shown in FIG. 21 However, selection of the second current-to-voltage converter (I-V2), having a larger number of diodes, gives the same favorable effects insofar as the circuit operation is concerned.

A reference voltage Vref may be obtained from a mid-point terminal of the second current-to-voltage converter (I-V2). Alternatively, depending on a circuit used, a reference voltage Vref2 may also be obtained as a mid-point terminal voltage of the first current-to-voltage converter (I-V1).

In FIG. 21, a first current mirror circuit includes n-channel MOS transistors M1 and M2, and a second current mirror circuit includes n-channel MOS transistors M3, M4. A third current mirror circuit includes p-channel MOS transistors M5 and M6, and a fourth current mirror circuit includes p-channel MOS transistors M7 and M8.

The transistors M5 and M7 each have a gate and a drain connected in common. The transistors M1 and M5 are cascoded, while the transistors M5 and M7 are cascoded.

The first current-to-voltage converter (I-V1) and the second current-to-voltage converter (I-V2) are connected to the sources of the transistors M1 and M2, respectively.

A reference voltage Vref may be obtained from a mid-point terminal of the second current-to-voltage converter (I-V2). Alternatively, depending on a circuit used, a reference voltage Vref2 may also be obtained as a mid-point terminal voltage of the first current-to-voltage converter (I-V1).

The transistor M4 has its gate and source coupled together, and is connected to the drain of a transistor M8.

The transistor M3 has a drain connected to the coupled gates of transistors M1 and M2, and is connected to the drain of a transistor M6.

A third current-to-voltage converter (I-V3) and a fourth current-to-voltage converter (I-V4) are respectively connected to sources of the transistors M3 and M4. It is proper to use a circuit equivalent to the first current-to-voltage converter (I-V1) or a circuit equivalent to the second current-to-voltage converter (I-V2) as the third current-to-voltage converter and the fourth current-to-voltage converter.

The operation of the circuit of FIG. 21 is now described. In FIG. 21, a common current flows through transistors M1 and M5 and an equal current I3 is caused to flow via the third current mirror circuit through the transistor M3. Also, a common current I2 flows through transistors M2 and M6 and an equal current I4 is caused to flow via the fourth current mirror circuit into transistor M4. The second current mirror circuit operates as a current subtraction circuit to control the first current mirror circuit depending on the large-small relationship of I2 and I1 to cause the two currents I1 and I2 to be equal to each other (I2=I1).

In this case, a terminal voltage VA of the first current-to-voltage converter (I-V1) becomes equal to a terminal voltage VB of the second current-to-voltage converter (I-V2). A reference voltage Vref may be obtained at this time from a mid-point terminal of the second current-to-voltage converter (I-V2). Alternatively, depending on a circuit used, a reference voltage Vref2 may also be obtained as a mid-point terminal voltage of the first current-to-voltage converter (I-V1)

### EXAMPLE 8-1

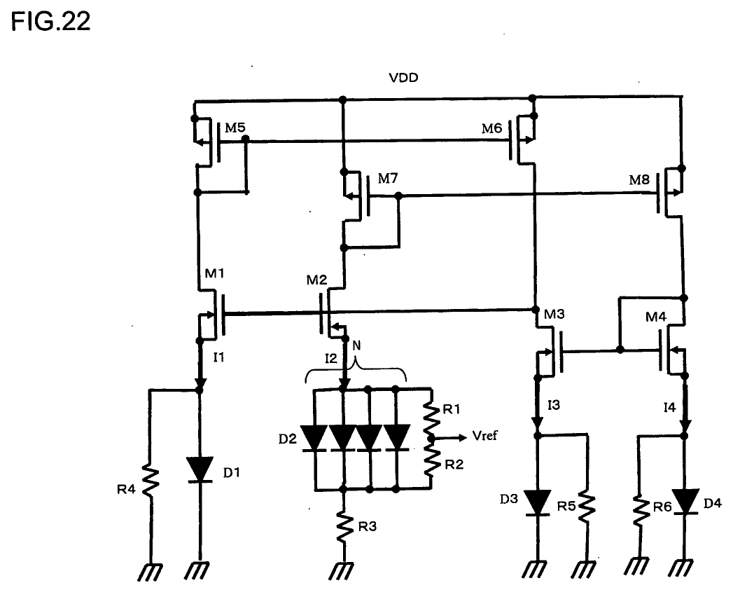

If, in the Example described with reference to FIG. 21, it is supposed that the first current-to-voltage converter (I-V1) and the second current-to-voltage converter (I-V2) are replaced respectively by a first current-to-voltage converter (I-V1) and a second current-to-voltage converter (I-V2) of FIG. 8 that use the original OP amp as control means, there may be obtained a reference voltage circuit that uses a current mirror circuit in substitution for the OP amp (AP1) to exercise control so that preset voltages will be equal to each other. It is noted that, in FIG. 8, the first current-to-voltage converter (I-V1) includes a parallel connection of a diode Q1 and a resistor R4, and the second current-to-voltage converter (I-V2) includes a parallel connection of a plurality of diodes Q2 and series-connected resistors R1 and R2, and a resistor R3 connected in series with the parallel connection. FIG. 22 shows a specific implementing circuit.

In the circuit of FIG. 22, the OP amp of FIG. 8 has been replaced by four current mirror circuits (M1, M2; M3, M4; M5, M6; and M7, M8) of FIG. 21. Referring to FIG. 22, there are provided p-channel MOS transistors M5, M6; M7, M8 that have sources connected to a power supply VDD and that have gates connected in common. The gate and the drain of the p-channel MOS transistor M5 are coupled together, while the gate and the drain of the p-channel MOS transistor M7 are also coupled together. The drain of the n-channel. MOS transistor M3 is connected to the drain of the p-channel MOS transistor M6. The n-channel MOS transistor M4 has its gate and drain coupled together and is connected to the drain of the p-channel MOS transistor M8. The drain of the n-channel MOS transistor M3 is connected to the coupled gates of the n-channel MOS transistors M1 and M2.

The first current-to-voltage converter (I-V1), including the parallel connection of the diode D1 and the resistor R4, is connected between the source of the n-channel MOS transistor M1 and the ground.

The second current-to-voltage converter (I-V2), including the parallel connection of the diodes D2 and series-connected resistors R1, R2 and the resistor R3 connected in series with the parallel connection, is connected between the source of the n-channel MOS transistor M2 and the ground.

A third current-to-voltage converter (I-V3), including a parallel connection of a diode D3 and a resistor R5, is connected between the source of the n-channel MOS transistor M3 and the ground.

A fourth current-to-voltage converter (I-V4), including a parallel connection of a diode D4 and a resistor R6, is connected between the source of the n-channel MOS transistor M4 and the ground.

A mid-point terminal of the series-connected resistors R1 and R2 of the second current-to-voltage converter (I-V2) operates as an output terminal of the reference voltage Vref.

The operation of the circuit of FIG. 22 is now described. In FIG. 22, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit.

A common current I2 also flows through the p-channel MOS transistor M7 and the n-channel MOS transistor M2 to cause an equal current I4 to flow through the n-channel MOS transistor M4 via the p-channel MOS transistor M8 of the fourth current mirror circuit.

The second current mirror circuit operates as a current subtraction circuit and controls the coupled gates of the n-channel MOS transistors M1 and M2 of the first current mirror circuit depending on the large-small relationship of I2 and I1 to cause the two currents I2 and I1 to be equal to each other (I2=I1). Hence, the currents I1 and I2 are set so as to be equal to each other.

In this case, the first current-to-voltage converter (I-V1), including the parallel connection of the diode D1 and the resistor R4, is driven by the current I1. The second current-to-voltage converter (I-V2), including the parallel connection of the diodes D2 and series-connected resistors R1 and R2, and the resistor R3 connected in series with the parallel connection, is driven by the current I2.

If the currents I1 and I2 are equal to each other, a terminal voltage VA of the first current-to-voltage converter (I-V1), including the parallel connection of the diode D1 and the resistor R4, becomes equal to a terminal voltage VB of the second current-to-voltage converter (I-V2), including the parallel connection of the diodes D2 and series-connected resistors R1 and R2, and the resistor R3 connected in series with the parallel connection. In this case, a mid-point terminal of the series-connected resistors R1 and R2 of the second current-to-voltage converter (I-V2) is output as a desired reference voltage Vref.

### EXAMPLE 8-2

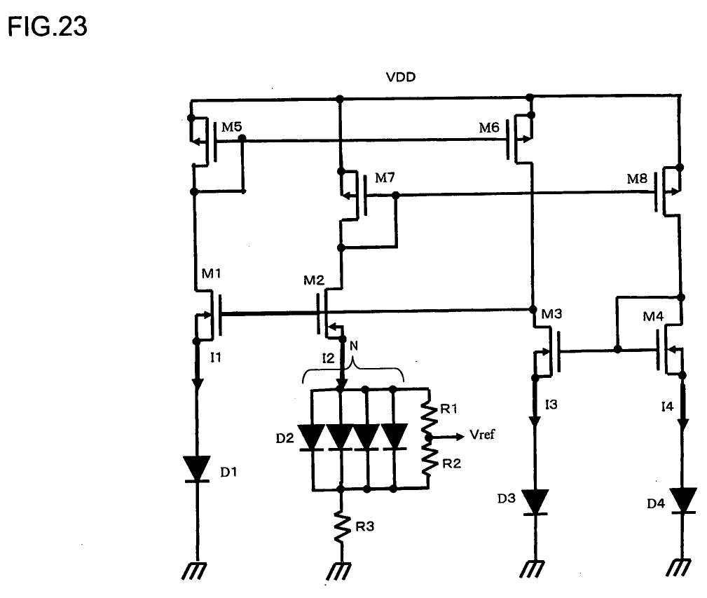

If, in the Example described with reference to FIG. 21, it is supposed that the first current-to-voltage converter (I-V1) and the second current-to-voltage converter (I-V2) are respectively replaced by a first current-to-voltage converter (I-V1) and a second current-to-voltage converter (I-V2) of FIG. 9 that use the original OP amp as control means, there may be obtained a reference voltage circuit that uses a current mirror circuit in substitution for the OP amp (AP1) to exercise control so that preset voltages will be equal to each other. In FIG. 9, the first current-to-voltage converter (I-V1) is including a diode D1, and the second current-to-voltage converter (I-V2) includes a parallel connection of a plurality of diodes D2 and series-connected resistors R1 and R2, and a resistor R3 connected in series with the parallel connection. FIG. 23 shows a specific implementing circuit.

In the circuit of FIG. 23, the OP amp of FIG. 9 has been replaced by four current mirror circuits (M1, M2; M3, M4; M5, M6; and M7, M8) of FIG. 21. Referring to FIG. 23, there are provided p-channel MOS transistors M5, M6; M7, M8 that have sources connected to a power supply VDD and that have gates connected in common. The gate and the drain of the p-channel MOS transistor M5 are coupled together, and the gate and the drain of the p-channel MOS transistor M7 are also coupled together. The drain of the n-channel MOS transistor M3 is connected to the drain of the p-channel MOS transistor M6. The n-channel MOS transistor M4 has its gate and drain coupled together and is connected to the drain of the p-channel MOS transistor M8. The drain of the n-channel MOS transistor M3 is connected to the coupled gates of the n-channel MOS transistors M1 and M2.

The first current-to-voltage converter (I-V1), including the diode D1, is connected between the source of the n-channel MOS transistor M1 and the ground.

The second current-to-voltage converter (I-V2), including the parallel connection of the diodes D2 and the series-connected resistors R1 and R2, and the resistor R3 connected in series with the parallel connection, is connected between the source of the n-channel MOS transistor M2 and the ground.

A third current-to-voltage converter (I-V3), including a diode D3, is connected between the source of the n-channel MOS transistor M3 and the ground.

A fourth current-to-voltage converter (I-V4), including a diode D4, is connected between the source of the n-channel MOS transistor M4 and the ground.

A mid-point terminal of the series-connected resistors R1 and R2 of the second current-to-voltage converter (I-V2) operates as an output terminal of the reference voltage Vref.

The operation of the circuit of FIG. 23 is now described. In FIG. 23, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit.

A common current I2 also flows through the p-channel MOS transistor M7 and the n-channel MOS transistor M2 to cause an equal current I4 to flow through the n-channel MOS transistor M4 via the p-channel MOS transistor M8 of the fourth current mirror circuit.

The second current mirror circuit (M3, M4) operates as a current subtraction circuit and controls the coupled gates of the n-channel MOS transistors M1 and M2 of the first current mirror circuit depending on the large-small relationship of I2 and I1 to cause the two currents I2 and I1 to be equal to each other (I2=I1).

Hence, the currents I1 and I2 are set so as to be equal to each other. In this case, the first current-to-voltage converter (I-V1), including the diode D1, is driven by the current I1. The second current-to-voltage converter (I-V2), including the parallel connection of the diodes D2 and series-connected resistors R1, R2 and the resistor R3 connected in series with the parallel connection, is driven by the current I2. If the currents I1 and I2 are equal to each other, a terminal voltage VA of the first current-to-voltage converter (I-V1) becomes equal to a terminal voltage VB of the second current-to-voltage converter (I-V2).

In this case, a mid-point terminal of the series-connected resistors R1 and R2 of the second current-to-voltage converter (I-V2) is output as a desired reference voltage Vref.

### EXAMPLE 8-3

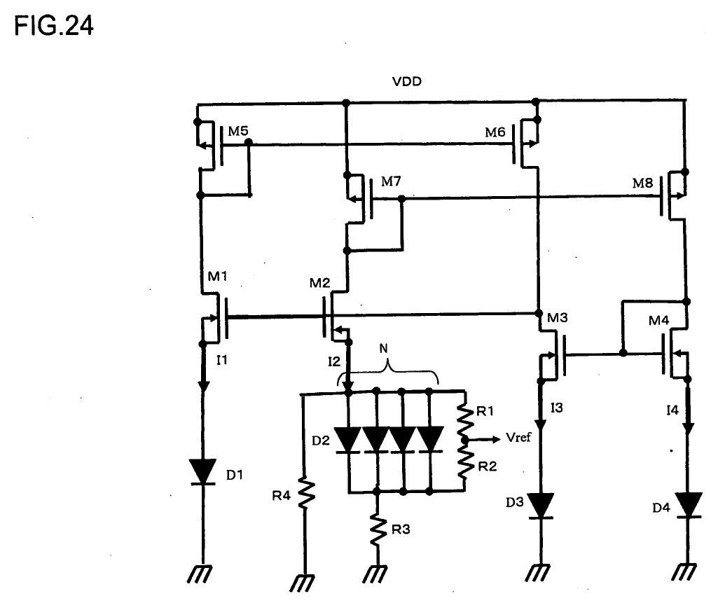

If, in the Example described with reference to FIG. 21, it is supposed that the first current-to-voltage converter (I-V1) and the second current-to-voltage converter (I-V2) are respectively replaced by a first current-to-voltage converter (I-V1) and a second current-to-voltage converter (I-V2) of FIG. 10 that use the original OP amp as control means, there may be obtained a reference voltage circuit that uses a current mirror circuit in substitution for the OP amp (AP1) to exercise control so that preset voltages will be equal to each other. In FIG. 10, the first current-to-voltage converter (I-V1) is including a diode D1, and the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 24 shows a specific implementing circuit.

In the circuit of FIG. 24, the OP amp of FIG. 10 has been replaced by four current mirror circuits (M1, M2; M3, M4; M5, M6; and M7, M8) of FIG. 21. Referring to FIG. 24, there are provided p-channel MOS transistors M5, M6; M7, M8 that have sources connected to a power supply VDD and that have gates connected in common. The gate and the drain of the p-channel MOS transistor M5 are coupled together, while the gate and the drain of the p-channel MOS transistor M7 are also coupled together. The drain of the n-channel MOS transistor M3 is connected to the drain of the p-channel MOS transistor M6. The n-channel MOS transistor M4 has its gate and drain coupled together and is connected to the drain of the p-channel MOS transistor M8. The drain of the n-channel MOS transistor M3 is connected to the coupled gates of the n-channel MOS transistors M1 and M2.

The first current-to-voltage converter (I-V1), including the diode D1, is connected between the source of the n-channel MOS transistor M1 and the ground.

The second current-to-voltage converter (I-V2), including the parallel connection of a plurality of diodes D2 and series-connected resistors R1 and R2, the resistor R3 connected in series with the parallel connection and the resistor R4 connected in parallel with the series connection, is connected between the source of the n-channel MOS transistor M2 and the ground.

A third current-to-voltage converter (I-V3), including a diode D3, is connected between the source of the n-channel MOS transistor M3 and the ground.

A fourth current-to-voltage converter (I-V4), including a diode D4, is connected between the source of the n-channel MOS transistor M4 and the ground.

A mid-point terminal of the series-connected resistors R1 and R2 of the second current-to-voltage converter (I-V2) operates as an output terminal of the reference voltage Vref.

The operation of the circuit of FIG. 24 is now described. In FIG. 24, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit.

A common current I2 flows through the p-channel MOS transistor M7 and the n-channel MOS transistor M2 to cause an equal current I4 to flow through the n-channel MOS transistor M4 via the p-channel MOS transistor M8 of the fourth current mirror circuit.

The second current mirror circuit (M3, M4) operates as a current subtraction circuit and controls the coupled gates of the n-channel MOS transistors M1 and M2 of the first current mirror circuit depending on the large-small relationship of I2 and I1 to cause the two currents I2 and I1 to be equal to each other (I2=I1).

Hence, the currents I1 and I2 are set so as to be equal to each other. In this case, the first current-to-voltage converter (I-V1), including the diode D1, is driven by the current I1. The second current-to-voltage converter (I-V2), including the parallel connection of the diodes D2 and series-connected resistors R1 and R2, the resistor R3 connected in series with the parallel connection and the resistor R4 connected in parallel with the series connection, is driven by the current I2. If the currents I1 and I2 are equal to each other, a terminal voltage VA of the first current-to-voltage converter (I-V1) becomes equal to a terminal voltage VB of the second current-to-voltage converter (I-V2). In this case, a mid-point terminal of the series-connected resistors R1 and R2 of the second current-to-voltage converter (I-V2) is output as a desired reference voltage Vref.

### EXAMPLE 8-4

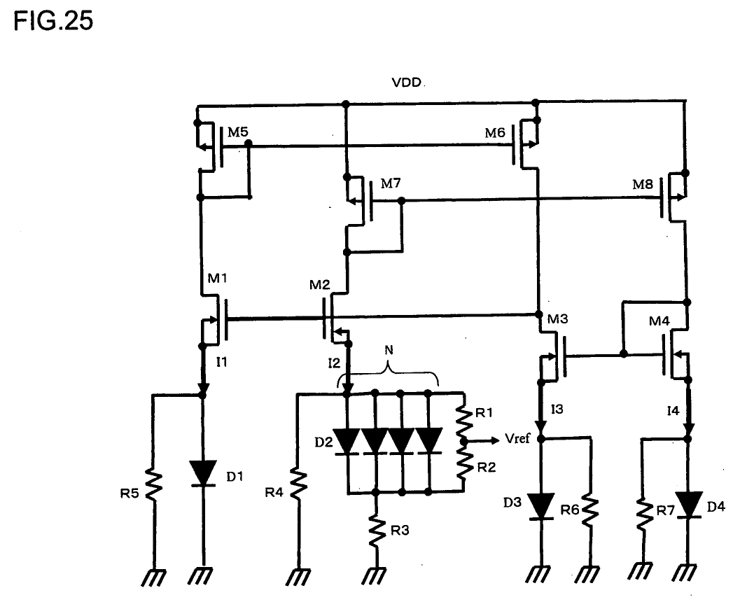

If, in the Example described with reference to FIG. 21, it is supposed that the first current-to-voltage converter (I-V1) and the second current-to-voltage converter (I-V2) are replaced by a first current-to-voltage converter (I-V1) and a second current-to-voltage converter (I-V2) of FIG. 11 that use the original OP amp as control means, respectively, there may be obtained a reference voltage circuit that uses a current mirror circuit in substitution for the OP amp (AP1) to exercise control so that preset voltages will be equal to each other. In FIG. 11, the first current-to-voltage converter (I-V1) includes a parallel connection of a diode D1 and a resistor R5, and the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 25 shows a specific implementing circuit.

In the circuit of FIG. 25, the OP amp of FIG. 11 has been replaced by four current mirror circuits (M1, M2; M3, M4; M5, M6; and M7, M8) of FIG. 21.

Referring to FIG. 25, there are provided p-channel MOS transistors M5, M6; M7, M8 that have sources connected to a power supply VDD and that have gates connected in common. The gate and the drain of the p-channel MOS transistor M5 are coupled together, while the gate and the drain of the p-channel MOS transistor M7 are also coupled together. The drain of the n-channel MOS transistor M3 is connected to the drain of the p-channel MOS transistor M6. The n-channel MOS transistor M4 has its gate and drain coupled together and is connected to the drain of the p-channel MOS transistor M8. The drain of the n-channel MOS transistor M3 is connected to the coupled gates of the n-channel MOS transistors M1 and M2.

The first current-to-voltage converter (I-V1), including the parallel connection of the diode D1 and the resistor R5, is connected between the source of the n-channel MOS transistor M1 and the ground.

The second current-to-voltage converter (I-V2), including the parallel connection of the diodes D2 and the series-connected resistors R1 and R2, the resistor R3 connected in series with the parallel connection and the resistor R4 connected in parallel with the series connection, is connected between the source of the n-channel MOS transistor M2 and the ground.

A third current-to-voltage converter (I-V3), including a parallel connection of a diode D3 and a resistor R6, is connected between the source of the n-channel MOS transistor M3 and the ground.

A fourth current-to-voltage converter (I-V4), including a parallel connection of a diode D4 and a resistor R7, is connected between the source of the n-channel MOS transistor M4 and the ground.

A mid-point terminal of the series-connected resistors R1 and R2 connected in series of the second current-to-voltage converter (I-V2) operates as an output terminal of the reference voltage Vref.

The operation of the circuit of FIG. 25 is now described. In FIG. 25, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit.

A common current I2 also flows through the p-channel MOS transistor M7 and the n-channel MOS transistor M2 to cause an equal current I4 to flow through the n-channel MOS transistor M4 via the p-channel MOS transistor M8 of the fourth current mirror circuit.

The second current mirror circuit (M3, M4) operates as a current subtraction circuit and controls the coupled gates of the n-channel MOS transistors M1 and M2 of the first current mirror circuit depending on the large-small relationship of I2 and I1 to cause the two currents I2 and I1 to be equal to each other (I2=I1).

Hence, the currents I1 and I2 are set so as to be equal to each other. In this case, the first current-to-voltage converter (I-V1), including the parallel connection of the diode D1 and the resistor R5, is driven by the current I1.

The second current-to-voltage converter (I-V2), including the parallel connection of the diodes D2 and series-connected resistors R1 and R2, the resistor R3 connected in series with the parallel connection and the resistor R4 connected in parallel with the series connection, is driven by the current I2.

If the currents I1 and I2 are equal to each other, a terminal voltage VA of the first current-to-voltage converter (I-V1) becomes equal to a terminal voltage VB of the second current-to-voltage converter (I-V2).

In this case, a mid-point terminal of the series-connected resistors R1 and R2 of the second current-to-voltage converter (I-V2) is output as a desired reference voltage Vref.

### EXAMPLE 8-5

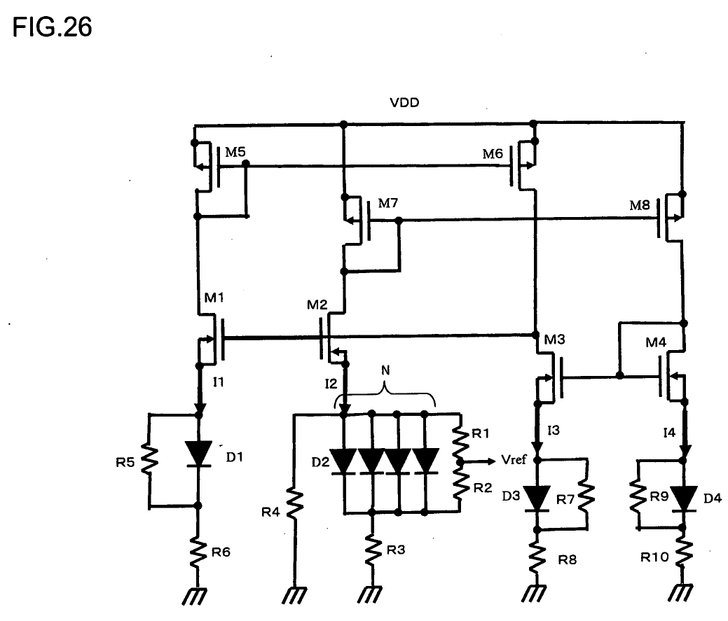

If, in the Example described with reference to FIG. 21, it is supposed that the first current-to-voltage converter (I-V1) and the S second current-to-voltage converter (I-V2) are replaced by a first current-to-voltage converter (I-V1) and a second current-to-voltage converter (I-V2) of FIG. 12 that use the original OP amp as control means, respectively, there may be obtained a reference voltage circuit that uses a current mirror circuit in substitution for the OP amp (AP1) to exercise control so that preset voltages will be equal to each other. In FIG. 12, the first current-to-voltage converter (I-V1) includes a parallel connection of a diode D1 and a resistor R5 and a resistor R6 connected in series with the parallel connection. The second current-to-voltage converter (I-V2) includes a parallel connection of a plurality of diodes D2 and series-connected resistors (R1, R2), a resistor R3 connected in series with the parallel connection of the diodes D2 and (R1, R2), and a resistor R4 connected in parallel with the series connection of R3 and the parallel connection of the diodes D2 and (R1, R2). FIG. 26 shows a specific implementing circuit.

In the circuit of FIG. 26, the OP amp of FIG. 11 has been replaced by four current mirror circuits (M1, M2; M3, M4; M5, M6; and M7, M8) of FIG. 21. Referring to FIG. 26, there are provided p-channel MOS transistors M5, M6; M7, M8 that have sources connected to a power supply VDD and that have gates connected in common. The gate and the drain of the p-channel MOS transistor M5 are coupled together, while the gate and the drain of the p-channel MOS transistor M7 are also coupled together. The drain of the n-channel MOS transistor M3 is connected to the drain of the p-channel MOS transistor M6. The n-channel MOS transistor M4 has its gate and drain coupled together and is connected to the drain of the p-channel MOS transistor M8. The drain of the n-channel MOS transistor M3 is connected to the coupled gates of the n-channel MOS transistors M1 and M2.

The first current-to-voltage converter (I-V1), including the parallel connection of the diode D1 and the resistor R5 and the resistor R6 connected in series with the parallel connection, is connected between the source of the n-channel MOS transistor M1 and the ground.

The second current-to-voltage converter (I-V2), including the parallel connection of the diodes D2 and the series-connected resistors (R1, R2), the resistor R3 connected in series with the parallel connection of the diodes D2 and (R1, R2) and the resistor R4 connected in parallel with the series connection of R3 and the parallel connection of the diodes D2 and (R1, R2), is connected between the source of the n-channel MOS transistor M2 and the ground.

A third current-to-voltage converter (I-V3), including a parallel connection of a plurality of diodes D3 and a resistor R7 and another resistor R8 connected in series with the parallel connection of D3 and R7, is connected between the source of the n-channel MOS transistor M3 and the ground.

A fourth current-to-voltage converter (I-V4), including a parallel connection of a diode D4 and a resistor R9 and another resistor R10 connected in series with the parallel connection of D4 and R9, is connected between the source of the n-channel MOS transistor M4 and the ground.

A mid-point terminal of the series-connected resistors R1 and R2 of the second current-to-voltage converter (I-V2) operates as an output terminal of the reference voltage Vref.

The operation of the circuit of FIG. 26 is now described. In FIG. 26, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit. A common current I2 flows through the p-channel MOS transistor M7 and the n-channel MOS transistor M2 to cause an equal current I4 to flow through the n-channel MOS transistor M4 via the p-channel MOS transistor M8 of the fourth current mirror circuit.

The second current mirror circuit (M3, M4) operates as a current subtraction circuit and controls the coupled gates of the n-channel MOS transistors M1 and M2 of the first current mirror circuit depending on the large-small relationship of I2 and I1 to cause the two currents I2 and I1 to be equal to each other (I2=I1).

Hence, the currents I1 and I2 are set so as to be equal to each other. In this case, the first current-to-voltage converter (I-V1), including the parallel connection of the diode D1 and the resistor R5 and the resistor R6 connected in series with the parallel connection, is driven by the current I1. The second current-to-voltage converter (I-V2), including the parallel connection of the diodes D2 and series-connected resistors (R1, R2), the resistor R3 connected in series with the parallel connection of the diodes D2 and (R1,R2) and the resistor R4 connected in parallel with the series connection of R3 and the parallel connection of the diodes D2 and (R1,R2), is driven by the current I2.

If the currents I1 and I2 are equal to each other, a terminal voltage VA of the first current-to-voltage converter (I-V1) becomes equal to a terminal voltage VB of the second current-to-voltage converter (I-V2). In this case, a mid-point terminal of the series-connected resistors R1 and R2 of the second current-to-voltage converter (I-V2) is output as a desired reference voltage Vref.

### EXAMPLE 8-6

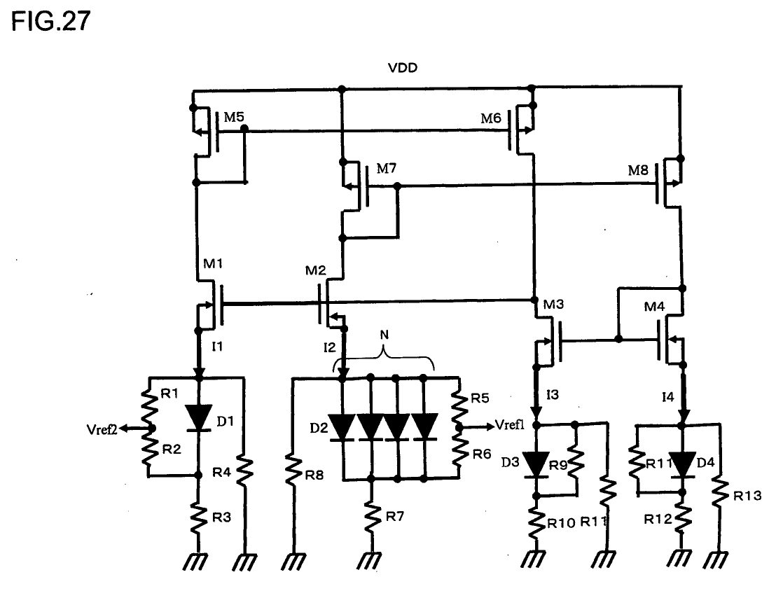

If, in the Example described with reference to FIG. 21, it is supposed that the first current-to-voltage converter (I-V1) and the second current-to-voltage converter (I-V2) are replaced by a first current-to-voltage converter (I-V1) and a second current-to-voltage converter (I-V2) of FIG. 13 that use the original OP amp as control means, respectively, there may be obtained a reference voltage circuit that uses a current mirror circuit in substitution for the OP amp (AP1) to exercise control so that preset voltages will be equal to each other. It is noted that, in FIG. 13, the first current-to-voltage converter (I-V1) includes a parallel connection of a diode D1 and series-connected resistors (R1, R2), a resistor R3 connected in series with the parallel connection of the diode D1 and (R1, R2) and a resistor R4 connected in parallel with the series connection of R3 and the parallel connection of the diode D1 and (R1, R2). The second current-to-voltage converter (I-V2) includes a parallel connection of a plurality of diodes D2 and series-connected resistors (R5, R6), a resistor R7 connected in series with the parallel connection of the diodes D2 and (R5, R6) and a resistor R8 connected in parallel with the series connection of R7 and the parallel connection of the diodes D2 and (R5, R6). FIG. 27 shows a specific implementing circuit.

In the circuit of FIG. 27, the OP amp of FIG. 13 has been replaced by four current mirror circuits (M1, M2; M3, M4; M5, M6; M7, M8) of FIG. 21. Referring to FIG. 27, there are provided p-channel MOS transistors M5, M6; M7, M8 that have sources connected to a power supply VDD and that have gates connected in common. The gate and the drain of the p-channel MOS transistor M5 are coupled together, while the gate and the drain of the p-channel MOS transistor M7 are also coupled together. The drain of the n-channel MOS transistor M3 is connected to the drain of the p-channel MOS transistor M6. The n-channel MOS transistor M4 has its gate and drain coupled together and is connected to the drain of the p-channel MOS transistor M8. The drain of the n-channel MOS transistor M3 is connected to the coupled gates of the n-channel MOS transistors M1 and M2.

The first current-to-voltage converter (I-V1), including the parallel connection of the diode D1 and the series-connected resistors (R1, R2), the resistor R3 connected in series with the parallel connection of D1 and (R1, R2) and the resistor R4 connected in parallel with the series connection of R3 and the parallel connection of D1 and (R1, R2), is connected between the source of the n-channel MOS transistor M1 and the ground.

The second current-to-voltage converter (I-V2), including the parallel connection of the a plurality of diodes D2 and the series-connected resistors (R1, R2), the resistor R7 connected in series with the parallel connection of the diodes D2 and (R1, R2) and the resistor R8 connected in parallel with the series connection of R7 and the parallel connection of the diodes D2 and (R1, R2), is connected between the source of the n-channel MOS transistor M2 and the ground.

A third current-to-voltage converter (I-V3), including a parallel connection of a diode D3 and a resistor R9, a resistor R10 connected in series with the parallel connection of D3 and R9, and a resistor R11 connected in parallel with the series connection of R10 and the parallel connection of D3 and R9, is connected between the source of the n-channel MOS transistor M3 and the ground.

A fourth current-to-voltage converter (I-V4), including a parallel connection of a diode D4 and the resistor R11, a resistor R12 connected in series with the parallel connection of D4 and R11 and a resistor R13 connected in parallel with the series connection of R13 and the parallel connection of D4 and R11, is connected between the source of the n-channel MOS transistor M4 and the ground.

A mid-point terminal of the series-connected resistors R1 and R2 of the first current-to-voltage converter (I-V1) and a mid-point terminal of the series-connected resistors R5 and R6 of the second current-to-voltage converter (I-V2) operate as output terminals of the reference voltage Vref.

The operation of the circuit of FIG. 27 is now described. In FIG. 27, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit. A common current I2 flows through the p-channel MOS transistor M7 and the n-channel MOS transistor M2 to cause an equal current I4 to flow through the n-channel MOS transistor M4 via the p-channel MOS transistor M8 of the fourth current mirror circuit. The second current mirror circuit operates as a current subtraction circuit (M3, M4) and controls the coupled gates of the n-channel MOS transistors M1 and M2 of the first current mirror circuit depending on the large-small relationship of I2 and I1 to cause the two currents I2 and I1 to be equal to each other (I2=I1).

Hence, the currents I1 and I2 are set so as to be equal to each other. In this case, the first current-to-voltage converter (I-V1), including the parallel connection of the diode D1 and the series-connected resistors R1 and R2, the resistor R3 connected in series with the parallel connection and the resistor R4 connected in parallel with the series connection, is driven by the current I1. The second current-to-voltage converter (I-V2), including the parallel connection of the diodes D2 and the series-connected resistors (R1, R2), the resistor R7 connected in series with the parallel connection of the diodes D2 and (R1,R2), and the resistor R8 connected in parallel with the series connection of R7 and the parallel connection of the diodes D2 and (R1,R2), is driven by the current I2.

If the currents I1 and I2 are equal to each other, a terminal voltage VA of the first current-to-voltage converter (I-V1) becomes equal to a terminal voltage VB of the second current-to-voltage converter (I-V2). In this case, the mid-point terminal of the series-connected resistors R1 and R2 of the first current-to-voltage converter (I-V1) outputs a desired reference voltage Vref2, and the mid-point terminal of the series-connected resistors R5 and R6 of the second current-to-voltage converter (I-V2) outputs a desired reference voltage Vref1.

### EXAMPLE 9

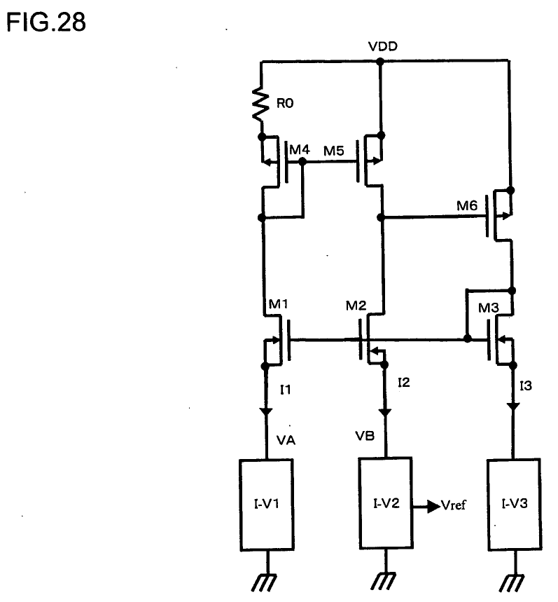

FIG. 28 depicts a diagram, partially shown in blocks, showing an arrangement of a reference voltage circuit according to claims 1 to 6 of the present application in a generalized form. In the Example for claim 1 of the present application (FIG. 7), described so far in detail, the OP amp (AP1) is used as control means for controlling preset voltages to be equal to each other. It is however possible to use a current mirror circuit, in place of the OP amp (AP1), as control means for controlling preset voltages to be equal to each other. Specifically, FIG. 7, showing a reference voltage circuit employing a basic OP amp as control means, in a block diagram, may be reformulated as shown in FIG. 28.

It should be noted that selection of the first current-to-voltage converter (I-V1), having a smaller number of diodes, as the current-to-voltage converter (I-V3), is more desirable for the objective of reducing the chip size, as shown in FIG. 28. However, selection of the second current-to-voltage converter (I-V2), having a larger number of diodes, gives the same favorable effects insofar as the circuit operation is concerned.

A reference voltage Vref is obtained from a mid-point terminal of the second current-to-voltage converter (I-V2).

A reference voltage Vref2 may be derived from a mid-point terminal of the first current-to-voltage converter (I-V1), depending on the type of the circuit used. In FIG. 28, the n-channel MOS transistor M3 has a gate and a drain connected in common, and n-channel MOS transistors M1 and M2 constitute a first current mirror circuit.

The p-channel MOS transistor M4 has a gate and a drain connected in common, while having a source connected via a source resistor R0 to a power supply. The p-channel MOS transistor M4 constitutes a second current mirror circuit along with the p-channel MOS transistor M5.

The second current mirror circuit (M4, M5) is a Widlar current mirror circuit and is a non-linear current mirror circuit.

The p-channel MOS transistor M6 has a gate connected to the drain of the p-channel MOS transistor M5.

The transistors M1 and M4 are cascoded, while the transistors M2 and M5 are also cascoded and the transistors M3 and M6 are also cascoded.

The first current-to-voltage converter (I-V1), the second current-to-voltage converter (I-V2) and the third current-to-voltage converter (I-V3) are connected to sources of the transistors M1, M2 and M3, respectively.

A mid-point terminal voltage of the first current-to-voltage converter (I-V1) is output as the reference voltage Vref. Alternatively, a mid-point terminal of the first current-to-voltage converter (I-V1) may be output as the reference voltage Vref2, depending on the sort of the circuit used.

The operation of the circuit of FIG. 28 is now described. In FIG. 28, a common current I1 flows through the transistors M1 and M4. A common current I2 flows through the transistors M2 and M5, while a common current I3 flows through the transistor M3 and M6.

Since the second current mirror circuit (M4, M5) is a Widlar current mirror circuit, the current I2 flowing through transistor M5 increases rapidly with slight increase in the current I1 flowing through transistor M4.

The current I3 flowing through transistor M6 then decreases rapidly, so that the currents I1 and I2, which are in a mirror relationship with respect to the current I3 flowing through transistor M3, also decrease rapidly simultaneously. The steady circuit state is reached when the current I1 flowing through transistor M4, the current I2 flowing through transistor M5 and the current I3 flowing through transistor M6 are in equilibrium with one another.

Under this control, a terminal voltage VA of the first current-to-voltage converter (I-V1) becomes equal to a terminal voltage VB of the second current-to-voltage converter (I-V2) when the two currents I1 and I2 become equal to each other.

At this time, the reference voltage Vref is obtained at the mid-point terminal of the second current-to-voltage converter (I-V2).

Alternatively, a mid-point terminal of the first current-to-voltage converter (I-V1) may be output as the reference voltage Vref2, depending on the sort of the circuit used.

### EXAMPLE 9-1

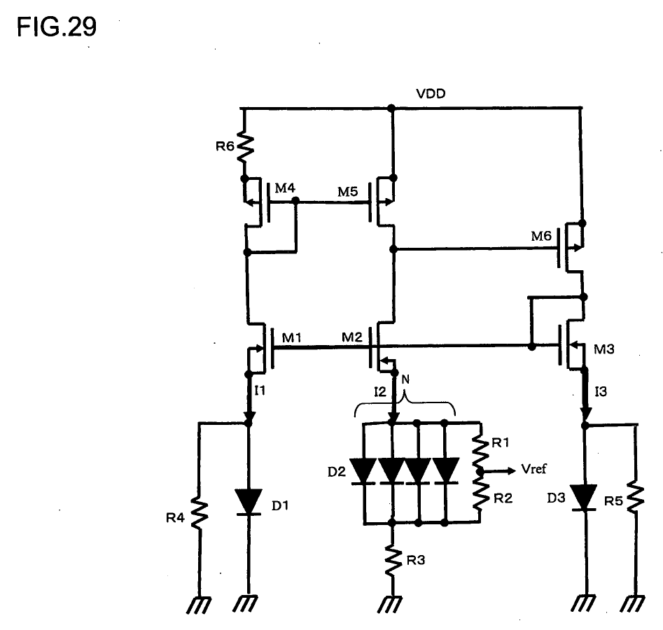

If, in the Example described with reference to FIG. 28, it is supposed that the first current-to-voltage converter (I-V1) and the second current-to-voltage converter (I-V2) are replaced by a first current-to-voltage converter (I-V1) and a second current-to-voltage converter (I-V2) of FIG. 8 that use the original OP amp as control means, respectively, a reference voltage circuit may be obtained which uses a current mirror circuit in substitution for the OP amp (AP1) to exercise control so that preset voltages will be equal to each other. It is noted that, in FIG. 8, the first current-to-voltage converter (I-V1) includes a parallel connection of a diode D1 and a resistor R4, and the second current-to-voltage converter (I-V2) includes a parallel connection of a plurality of diodes D2 and series-connected resistors R1 and R2 and a resistor R3 connected in series with the parallel connection. FIG. 29 shows a specific implementing circuit.

The circuit of FIG. 29 uses two current mirror circuits (M1, M2, M3; M4, M5, (M6)) of FIG. 28 in substitution for the OP amp of FIG. 8. Referring to FIG. 29, an n-channel MOS transistor M3, having a gate and a drain coupled together, forms a first current mirror circuit with n-channel MOS transistors M1 and M2. A p-channel MOS transistor M4, having a gate and a drain coupled together, has a source connected via resistor R6 to a power supply VDD. This p-channel MOS transistor M4 and the p-channel MOS transistor M5 have gates coupled together to constitute a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The n-channel MOS transistor M1 has a drain connected to a drain of the p-channel MOS transistor M4 whose gate and drain are coupled together.

The first current-to-voltage converter (I-V1), including the parallel connection of the diode D1 and the resistor R4, is connected between a source of the n-channel MOS transistor M1 and the ground.

The second current-to-voltage converter (I-V2), including the parallel connection of the diodes D2 and the series-connected resistors R1, R2 and the resistor R3 connected in series with the parallel connection, is connected between the source of the n-channel MOS transistor M2 and the ground.

A third current-to-voltage converter (I-V3), including a parallel connection of a diode D3 and a resistor R5, is connected between the source of the n-channel MOS transistor M3 and the ground.

A mid-point terminal of the series-connected resistors R1 and R2 of the second current-to-voltage converter (I-V2) operates as an output terminal for the reference voltage Vref.

The operation of the circuit of FIG. 29 is now described. In FIG. 29, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

Since the second current mirror circuit (M4, M5) is a Widlar current mirror circuit, the current I2 flowing through transistor M5 increases rapidly with slight increase in the current I1 flowing through transistor M4. The current I3 flowing through transistor M6 then decreases rapidly, so that the currents I1 and I2, which are in a mirror relationship with respect to the current I3 flowing through transistor M3, also decrease rapidly simultaneously. The steady circuit state is reached when the current I1 flowing through transistor M4, the current I2 flowing through transistor M5 and the current I3 flowing through transistor M6 are in equilibrium with one another.

Under this control, a terminal voltage VA of the first current-to-voltage converter (I-V1) becomes equal to a terminal voltage VB of the second current-to-voltage converter (I-V2) when the two currents I1 and I2 become equal to each other. The first current-to-voltage converter (I-V1) includes the parallel connection of the diode D1 and the resistor R4, while the second current-to-voltage converter (I-V2) includes the parallel connection of the a plurality of diodes D2 and the series-connected resistors R1 and R2, and the resistor R3 connected in series with the parallel connection, as described above.

In this case, a mid-point terminal voltage of the series-connected resistors R1 and R2 of the second current-to-voltage converter (I-V2) is output as the desired reference voltage Vref.

### EXAMPLE 9-2

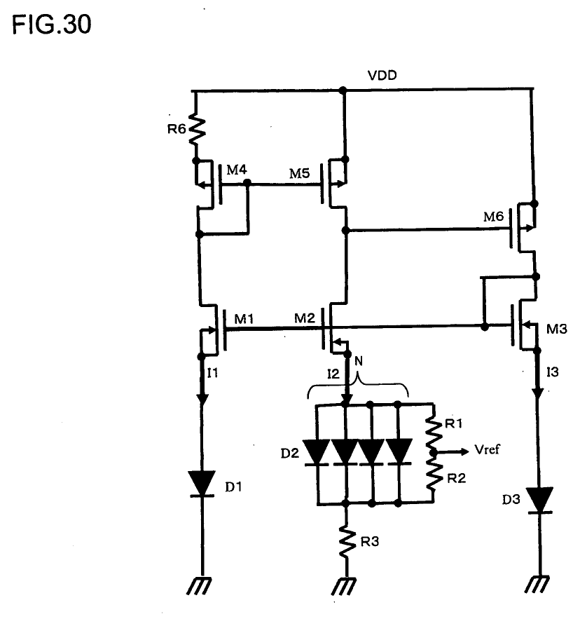

If, in the Example described with reference to FIG. 28, it is supposed that the first current-to-voltage converter (I-V1) and the second current-to-voltage converter (I-V2) are respectively replaced by a first current-to-voltage converter (I-V1) and a second current-to-voltage converter (I-V2) of FIG. 9 that use the original OP amp as control means, a reference voltage circuit may be obtained which uses a current mirror circuit in substitution for the OP amp in order to exercise control so that preset voltages will be equal to each other. It is noted that, in FIG. 9, the first current-to-voltage converter (I-V1) includes a diode D1, and the second current-to-voltage converter (I-V2) includes a parallel connection of a plurality of diodes D2 and series-connected resistors (R1, R2), and a resistor R3 connected in series with the parallel connection of diodes D2 and (R1,R2). FIG. 30 shows a specific implementing circuit.

The circuit of FIG. 30 uses two current mirror circuits (M1, M2, M3; M4, M5, (M6)) of FIG. 28 in substitution for the OP amp of FIG. 9. Referring to FIG. 30, an n-channel MOS transistor M3, having a gate and a drain coupled together, forms a first current mirror circuit with n-channel MOS transistors M1 and M2. A p-channel MOS transistor M4, having a gate and a drain coupled together, has a source connected via resistor R6 to a power supply VDD. This p-channel MOS transistor M4 and the p-channel MOS transistor M5 have gates coupled together to constitute a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The n-channel MOS transistor M1 has a drain connected to a drain of the p-channel MOS transistor M4 whose gate and the drain are coupled together.

The first current-to-voltage converter (I-V1), including the diode D1, is connected between a source of the n-channel MOS transistor M1 and the ground. The second current-to-voltage converter (I-V2), including the parallel connection of the diodes D2 and the series-connected resistors R1, R2 and the resistor R3 connected in series with the parallel connection, is connected between the source of the n-channel MOS transistor M2 and the ground. A third current-to-voltage converter (I-V3), including a diode D3, is connected between the source of the n-channel MOS transistor M3 and the ground.

A mid-point terminal of the series-connected resistors R1 and R2 of the second current-to-voltage converter (I-V2) operates as an output terminal for the reference voltage Vref.

The operation of the circuit of FIG. 30 is now described. In FIG. 30, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

Since the second current mirror circuit (M4, M5) is a Widlar current mirror circuit, the current I2 flowing through transistor M5 increases rapidly with slight increase in the current I1 flowing through transistor M4. The current I3 flowing through transistor M6 then decreases rapidly, so that the currents I1 and I2, which are in a mirror relationship with respect to the current I3 flowing through transistor M3, also decrease rapidly simultaneously. The steady-state of the circuit is reached when the current I1 flowing through transistor M4, the current I2 flowing through transistor M5 and the current I3 flowing through transistor M6 are in equilibrium with one another.

Under this control, a terminal voltage VA of the first current-to-voltage converter (I-V1) becomes equal to a terminal voltage VB of the second current-to-voltage converter (I-V2) when the two currents I1 and I2 become equal to each other. The first current-to-voltage converter (I-V1) includes the diode D1, while the second current-to-voltage converter (I-V2) includes the parallel connection of the a plurality of diodes D2 and the series-connected resistors R1, R2 and the resistor R3 connected in series with the parallel connection, as described above.

In this case, a mid-point terminal voltage of the series-connected resistors R1 and R2 of the second current-to-voltage converter (I-V2) is output as the desired reference voltage Vref.

### EXAMPLE 9-3

If, in the Example described with reference to FIG. 28, it is supposed that the first current-to-voltage converter (I-V1) and the second current-to-voltage converter (I-V2) are replaced by a first current-to-voltage converter (I-V1) and a second current-to-voltage converter (I-V2) of FIG. 10 that use the original OP amp as control means, respectively, there may be obtained a reference voltage circuit that uses a current mirror circuit in substitution for the OP amp in order to exercise control so that preset voltages will be equal to each other. In FIG. 10, the first current-to-voltage converter (I-V1) includes a diode D1, and the second current-to-voltage converter (I-V2) includes a parallel connection of a plurality of diodes D2 and series-connected resistors (R1, R2), and a resistor R3 connected in series with the parallel connection of the diodes D2 and (R1,R2), and a resistor R4 connected in parallel with the series connection of R3 and the parallel connection of the diodes D2 and (R1,R2).

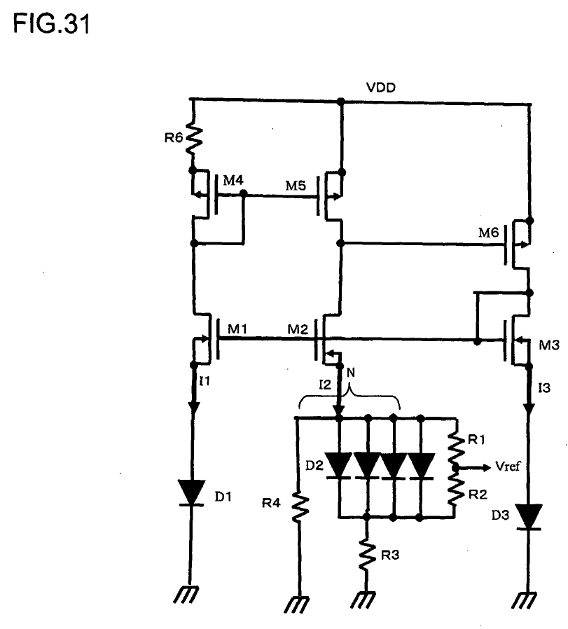

FIG. 31 shows a specific implementing circuit. The circuit of FIG. 31 uses two current mirror circuits (M1, M2, M3; M4, M5, (M6)) of FIG. 28 in substitution for the OP amp of FIG. 10. Referring to FIG. 31, an n-channel MOS transistor M3, having a gate and a drain coupled together, forms a first current mirror circuit with an n-channel MOS transistors M1 and M2. A p-channel MOS transistor M4, having a gate and a drain coupled together, has a source connected via resistor R6 to a power supply VDD. This p-channel MOS transistors M4 and M5 have gates coupled together to constitute a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The n-channel MOS transistor M1 has a drain connected to a drain of the p-channel MOS transistor M4 whose gate and drain are coupled together.

The first current-to-voltage converter (I-V1), including the diode D1, is connected between a source of the n-channel MOS transistor M1 and the ground.

The second current-to-voltage converter (I-V2), including the parallel connection of the diodes D2 and the series-connected resistors R1 and R2, the resistor R3 connected in series with the parallel connection of the diodes D2 and (R1, R2), and the resistor R4 connected in parallel with the series connection of R3 and the parallel connection of the diodes D2 and (R1, R2), is connected between the source of the n-channel MOS transistor M2 and the ground.

A third current-to-voltage converter (I-V3), including a diode D3, is connected between the source of the n-channel MOS transistor M3 and the ground. A mid-point terminal of the series-connected resistors R1 and R2 of the second current-to-voltage converter (I-V2) operates as an output terminal for the reference voltage Vref.

The operation of the circuit of FIG. 31 is now described. In FIG. 31, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

Since the second current mirror circuit (M4, M5) is a Widlar current mirror circuit, the current I2 flowing through transistor M5 increases rapidly with slight increase in the current I1 flowing through transistor M4.

The current I3 flowing through transistor M6 then decreases rapidly, so that the currents I1 and I2, which are in a mirror relationship with respect to the current I3 flowing through transistor M3, also decrease rapidly simultaneously. The steady-state of the circuit is reached when the current I1 flowing through transistor M4, the current I2 flowing through transistor M5 and the current I3 flowing through transistor M6 are in equilibrium with one another.

Under this control, a terminal voltage VA of the first current-to-voltage converter (I-V1) becomes equal to a terminal voltage VB of the second current-to-voltage converter (I-V2) when the two currents I1 and I2 become equal to each other. The first current-to-voltage converter (I-V1) includes the diode D1, while the second current-to-voltage converter (I-V2) includes the parallel connection of the a plurality of diodes D2 and the series-connected resistors R1 and R2, the resistor R3 connected in series with the parallel connection and the resistor R4 connected in parallel with the series connection, as described above.

In this case, a mid-point terminal voltage of the series-connected resistors R1 and R2 of the second current-to-voltage converter (I-V2) is output as the desired reference voltage Vref.

### EXAMPLE 9-4

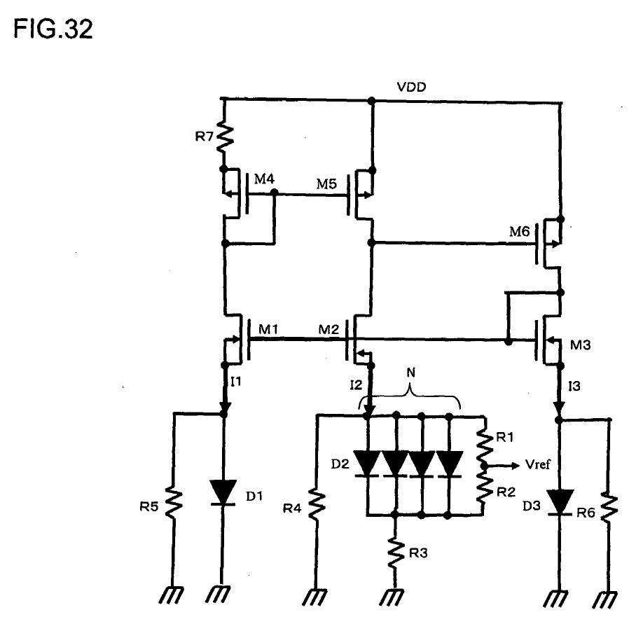

If, in the Example described with reference to FIG. 28, it is supposed that the first current-to-voltage converter (I-V1) and the second current-to-voltage converter (I-V2) are replaced by a first current-to-voltage converter (I-V1) and a second current-to-voltage converter (I-V2) of FIG. 11 that use the original OP amp as control means, respectively, there may be obtained a reference voltage circuit that uses a current mirror circuit in substitution for the OP amp in order to exercise control so that preset voltages will be equal to each other. It is noted that, in FIG. 11, the first current-to-voltage converter (I-V1) includes a parallel connection of a diode D1 and a resistor R5, and the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 32 shows a specific implementing circuit.

The circuit of FIG. 32 uses two current mirror circuits (M1, M2, M3; M4, M5, (M6)) of FIG. 28 in substitution for the OP amp of FIG. 11. Referring to FIG. 32, an n-channel MOS transistor M3, having a gate and a drain coupled together, forms a first current mirror circuit with n-channel MOS transistors M1 and M2. A p-channel MOS transistor M4, having a gate and a drain coupled together, has a source connected via resistor R7 to a power supply VDD. This p-channel MOS transistors M4 and M5 have gates coupled together to constitute a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The n-channel MOS transistor M1 has a drain connected to a drain of the p-channel MOS transistor M4 whose gate and drain are coupled together.

The first current-to-voltage converter (I-V1), including the parallel connection of the diode D1 and the resistor R5, is connected between the source of the n-channel MOS transistor M1 and the ground. The second current-to-voltage converter (I-V2), including the parallel connection of the diodes D2 and the series-connected resistors R1 and R2, the resistor R3 connected in series with the parallel connection of the diodes D2 and (R1, R2), and the resistor R4 connected in parallel with the series connection of R3 and the parallel connection of the diodes D2 and (R1, R2), is connected between the source of the n-channel MOS transistor M2 and the ground.

A third current-to-voltage converter (I-V3), including a parallel connection of a diode D3 and a resistor R6, is connected between the source of the n-channel MOS transistor M3 and the ground.

A mid-point terminal of the series-connected resistors R1 and R2 of the second current-to-voltage converter (I-V2) operates as an output terminal for the reference voltage Vref.

The operation of the circuit of FIG. 32 is now described. In FIG. 32, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

Since the second current mirror circuit (M4, M5) is a Widlar current mirror circuit, the current I2 flowing through transistor M5 increases rapidly with slight increase in the current I1 flowing through transistor M4.

The current I3 flowing through transistor M6 then decreases rapidly, so that the currents I1 and I2, which are in a mirror relationship with respect to the current I3 flowing through transistor M3, also decrease rapidly simultaneously. The steady circuit state is reached when the current I1 flowing through transistor M4, the current I2 flowing through transistor M5 and the current I3 flowing through transistor M6 are in equilibrium with one another.

Under this control, a terminal voltage VA of the first current-to-voltage converter (I-V1) becomes equal to a terminal voltage VB of the second current-to-voltage converter (I-V2) when the two currents I1 and I2 become equal to each other. The first current-to-voltage converter (I-V1) includes the parallel connection of the diode D1 and the resistor R5, while the second current-to-voltage converter (I-V2) includes the parallel connection of a plurality of diodes D2 and the series-connected resistors R1 and R2, the resistor R3 connected in series with the parallel connection of the diodes D2 and (R1,R2), and the resistor R4 connected in parallel with the series connection of R3 and the parallel connection of the diodes D2 and (R1,R2), as described above.

In this case, a mid-point terminal voltage of the series-connected resistors R1 and R2 of the second current-to-voltage converter (I-V2) is output as the desired reference voltage Vref.

### EXAMPLE 9-5

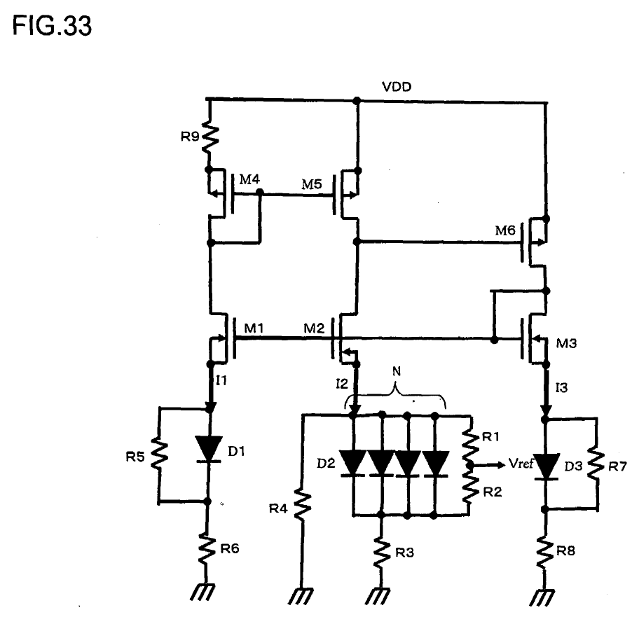

If, in the Example described with reference to FIG. 28, it is supposed that the first current-to-voltage converter (I-V1) and the second current-to-voltage converter (I-V2) are replaced by a first current-to-voltage converter (I-V1) and a second current-to-voltage converter (I-V2) of FIG. 12 that use the original OP amp as control means, respectively, there may be obtained a reference voltage circuit that uses a current mirror circuit in substitution for the OP amp in order to exercise control so that preset voltages will be equal to each other. It is noted that, in FIG. 12, the first current-to-voltage converter (I-V1) includes a parallel connection of a diode D1 and a resistor R5 and a resistor R6 connected in series with the parallel connection, and the second current-to-voltage converter (I-V2) includes a parallel connection of a plurality of diodes D2 and series-connected resistors R1 and R2, a resistor R3 connected in series with the parallel connection of D2 and (R1,R2), and a resistor R4 connected in parallel with the series connection of R3 and the parallel connection of D2 and (R1,R2). FIG. 33 shows a specific implementing circuit.

The circuit of FIG. 33 uses two current mirror circuits (M1, M2, M3; M4, M5, (M6)) of FIG. 28 in substitution for the OP amp of FIG. 12. Referring to FIG. 33, an n-channel MOS transistor M3, having a gate and a drain coupled together, forms a first current mirror circuit with n-channel MOS transistors M1 and M2.

A p-channel MOS transistor M4, having a gate and a drain coupled together, has a source connected via a source resistor R9 to a power supply VDD. This p-channel MOS transistors M4 and the p-channel MOS transistor M5 have gates coupled together to constitute a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The n-channel MOS transistor M1 has a drain connected to a drain of the p-channel MOS transistor M4 whose gate and drain are coupled together.

The first current-to-voltage converter (I-V1), including the parallel connection of the diode D1 and the resistor R5 and the resistor R6 connected in series with the parallel connection, is connected between a source of the n-channel MOS transistor M1 and the ground.

The second current-to-voltage converter (I-V2), including the parallel connection of diodes D2 and the series-connected resistors R1 and R2, the resistor R3 connected in series with the parallel connection of the diodes D2 and (R1, R2) and the resistor R4 connected in parallel with the series connection of R3 and the parallel connection of the diodes D2 and (R1, R2), is connected between the source of the n-channel MOS transistor M2 and the ground.

A third current-to-voltage converter (I-V3), including a parallel connection of a diode D3 and a resistor R7, is connected between the source of the n-channel MOS transistor M3 and the ground.

A mid-point terminal of the series-connected resistors R1 and R2 of the second current-to-voltage converter (I-V2) operates as an output terminal for the reference voltage Vref.

The operation of the circuit of FIG. 33 is now described. In FIG. 33, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

Since the second current mirror circuit (M4, M5) is a Widlar current mirror circuit, the current I2 flowing through transistor M5 increases rapidly with slight increase in the current I1 flowing through transistor M4.

The current I3 flowing through transistor M6 then decreases rapidly, so that the currents I1 and I2, which are in a mirror relationship with respect to the current I3 flowing through transistor M3, also decrease rapidly simultaneously. The steady-state of the circuit is reached when the current I1 flowing through transistor M4, the current I2 flowing through transistor M5 and the current I3 flowing through transistor M6 are in equilibrium with one another.

Under this control, a terminal voltage VA of the first current-to-voltage converter (I-V1) becomes equal to a terminal voltage VB of the second current-to-voltage converter (I-V2) when the two currents I1 and I2 become equal to each other. The first current-to-voltage converter (I-V1) includes the parallel connection of the diode D1 and the resistor R5 and the resistor R6 connected in series with the parallel connection, while the second current-to-voltage converter (I-V2) includes the parallel connection of the a plurality of diodes D2 and the series-connected resistors R1 and R2, the resistor R3 connected in series with the parallel connection of diodes D2 and (R1,R2), and the resistor R4 connected in parallel with the series connection of R3 and the parallel connection of diodes D2 and (R1,R2), as described above. In this case, a mid-point terminal voltage of the series-connected resistors R1 and R2 of the second current-to-voltage converter (I-V2) is output as the desired reference voltage Vref.

### EXAMPLE 9-6

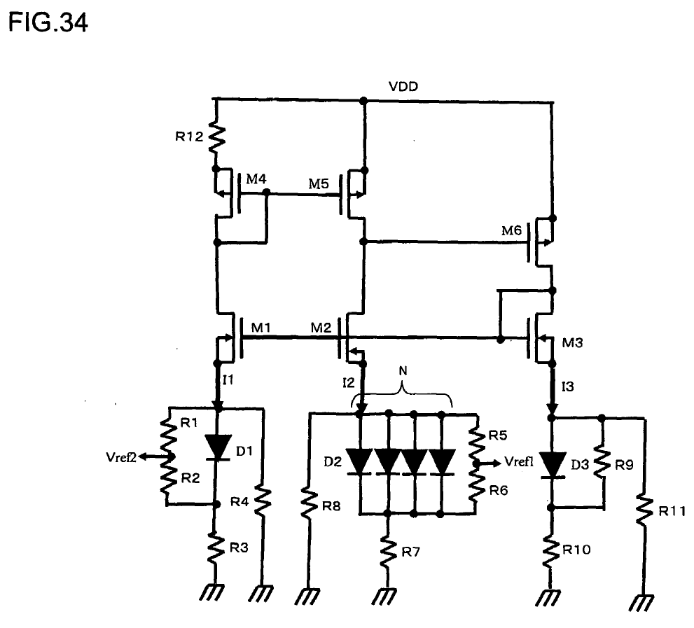

If, in the Example described with reference to FIG. 28, it is supposed that the first current-to-voltage converter (I-V1) and the second current-to-voltage converter (I-V2) are replaced by a first current-to-voltage converter (I-V1) and a second current-to-voltage converter (I-V2) of FIG. 13 that use the original OP amp as control means, respectively, there may be obtained a reference voltage circuit that uses a current mirror circuit in substitution for the OP amp in order to exercise control so that preset voltages will be equal to each other. It is noted that, in FIG. 13, the first current-to-voltage converter (I-V1) includes a parallel connection of the diode D1 and series-connected resistors R1 and R2, a resistor R3 connected in series with the parallel connection of D1 and (R1,R2), and a resistor R4 connected in parallel with the series connection of R3 and the parallel connection of D1 and (R1,R2). The second current-to-voltage converter (I-V2) includes a parallel connection of a plurality of diodes D2 and series-connected resistors R5 and R6, a resistor R7 connected in series with the parallel connection of D2 and (R5, R6), and a resistor R8 connected in parallel with the series connection of R3 and the parallel connection of D2 and (R5, R6). FIG. 34 shows a specific implementing circuit.

The circuit of FIG. 34 uses two current mirror circuits (M1, M2, M3; M4, M5, (M6)) of FIG. 28 in substitution for the OP amp of FIG. 13. Referring to FIG. 34, an n-channel MOS transistor M3, having a gate and a drain coupled together, forms a first current mirror circuit with n-channel MOS transistors M1 and M2. The p-channel MOS transistor M4, having a gate and a drain coupled together, has a source connected via a source resistor R12 to a power supply VDD. This p-channel MOS transistors M4 and the p-channel MOS transistor M5 have gates coupled together to constitute a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The n-channel MOS transistor M1 has a drain connected to a drain of the p-channel MOS transistor M4 whose gate and drain are coupled together.

The first current-to-voltage converter (I-V1), including the parallel connection of the diode D1 and the series-connected resistors R1 and R2, the resistor R3 connected in series with the parallel connection of D1 and (R1, R2) and the resistor R4 connected in parallel with the series connection of R3 and the parallel connection of D1 and (R1, R2), is connected between a source of the n-channel MOS transistor M1 and the ground.

The second current-to-voltage converter (I-V2), including the parallel connection of the diodes D2 and the series-connected resistors R5 and R6, the resistor R7 connected in series with the parallel connection of R2 and (R5, R6), and the resistor R8 connected in parallel with the series connection of R7 and the parallel connection of D2 and (R5, R6), is connected between the source of the n-channel MOS transistor M2 and the ground.

A third current-to-voltage converter (I-V3) is connected between the source of the n-channel MOS transistor M3 and the ground. The third current-to-voltage converter includes a parallel connection of a diode D3 and a resistor R9, a resistor R10 connected in series with the parallel connection of D3 and (R9, R10), and a resistor R11 connected in parallel with the series connection of R10 and the parallel connection of D3 and (R9, R10).

A mid-point terminal of the series-connected resistors R1 and R2 of the first current-to-voltage converter (I-V1) operates as an output terminal for the reference voltage Vref2, while a mid-point terminal of the series-connected resistors R5 and R6 of the second current-to-voltage converter (I-V2) operates as an output terminal for the reference voltage Vref1.

The operation of the circuit of FIG. 34 is now described. In FIG. 34, a common current 1i flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

Since the second current mirror circuit is a Widlar current mirror circuit, the current I2 flowing through transistor M5 increases rapidly with slight increase in the current I1 flowing through transistor M4. The current I3 flowing through transistor M6 then decreases rapidly, so that the currents I1 and I2, which are in a mirror relationship with respect to the current I3 flowing through transistor M3, also decrease rapidly simultaneously. The steady-state of the circuit is reached when the current I1 flowing through transistor M4, the current I2 flowing through transistor M5 and the current I3 flowing through transistor M6 are in equilibrium with one another.

Under this control, a terminal voltage VA of the first current-to-voltage converter (I-V1) becomes equal to a terminal voltage VB of the second current-to-voltage converter (I-V2) when the two currents I1 and I2 become equal to each other. The first current-to-voltage converter (I-V1) includes the parallel connection of the diode D1 and the series-connected resistors R1 and R2, the resistor R3 connected in series with the parallel connection of D1 and (R1, R2), and the resistor R4 connected in parallel with the series connection of R3 and the parallel connection of D1 and (R1, R2), as described above. The second current-to-voltage converter (I-V2) includes the parallel connection of the a plurality of diodes D2 and the series-connected resistors R5 and R6, the resistor R7 connected in series with the parallel connection of D2 and (R5, R6), and the resistor R8 connected in parallel with the series connection of R7 and the parallel connection of D2 and (R5, R6), also as described above.

In this case, a mid-point terminal voltage of the series-connected resistors R1 and R2 of the first current-to-voltage converter (I-V1) is output as the desired reference voltage Vref2, while a mid-point terminal voltage of the series-connected resistors R5 and R6 of the second current-to-voltage converter (I-V2) is output as the desired reference voltage Vref1.

### EXAMPLE 10

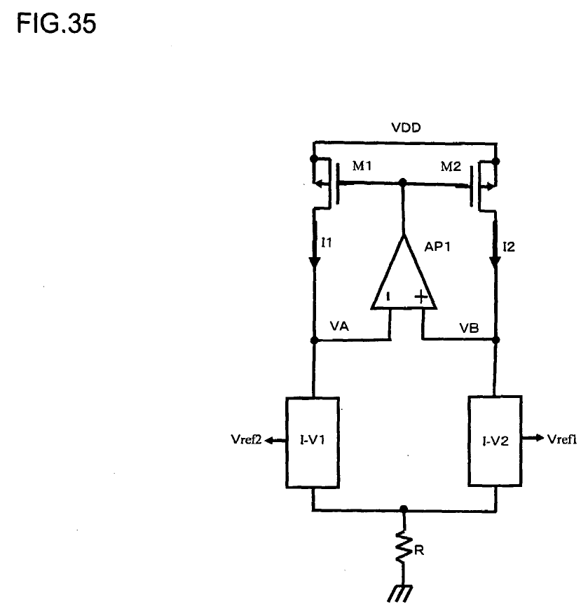

FIG. 35 depicts a diagram, partially shown in blocks, showing an arrangement of a reference voltage circuit according to claim 8 of the present application in a generalized form. As described so far in detail, the reference voltage circuit of the sort described yields an output voltage which is 250 mV at most. It may be surmised that there persists a need for a reference voltage higher by 300 mV and equal to, for example, 500 mV. The following is a technique of a circuit that may be arranged for a reference voltage circuit adapted for such application.

Referring to FIG. 35, one terminals of a first current-to-voltage converter (I-V1) and a second current-to-voltage converter (I-V2) are coupled together and grounded via a common resistor R. The other terminals are connected to drains of transistors M1 and M2 that constitute a current mirror circuit, while being connected to an inverting input terminal and a non-inverting input terminal of an OP amp (AP1).

An output terminal of the OP amp (AP1) is connected to coupled gates of the transistors M1 and M2 that constitute a current mirror circuit.

A mid-point terminal voltage of the first current-to-voltage converter (I-V1) is output as the reference voltage Vref2, while a mid-point terminal voltage of the second current-to-voltage converter (I-V2) is output as the reference voltage Vref1. There are cases where the reference voltage Vref2 may not be output, depending on the sort of the circuit.

The operation of the circuit of FIG. 35 is now described. With the reference voltage circuits, described so far in detail, in particular the reference voltage circuit of FIG. 7, the currents I1 and I2, driving the first current-to-voltage converter (I-V1) and the second current-to-voltage converter (I-V2), respectively, are assumed to be equal to each other. If a temperature-compensated reference voltage may be obtained, the temperature characteristics of the driving currents I1 and I2 have been set to either (1) a positive temperature characteristic or (2) a compensated temperature characteristic.

Thus, if one terminals of the first current-to-voltage converter (I-V1) and the second current-to-voltage converter (I-V2) are coupled together and grounded via resistor R5, as shown in FIG. 35, the voltage drop at the resistor R is summed to the reference voltage.
(1) If the temperature characteristic of the driving currents is positive, the voltage having the positive temperature characteristic increases in an amount corresponding to the voltage drop at the resistor R. Thus, if the divided forward voltage of the diode(s), having a negative temperature characteristic, is correspondingly increased, a larger temperature-compensated reference voltage Vref may be obtained. Or,
(2) if the temperature characteristic of the driving currents has been compensated, a reference voltage larger by the voltage drop at the resistor R may be obtained.

### EXAMPLE 10-1

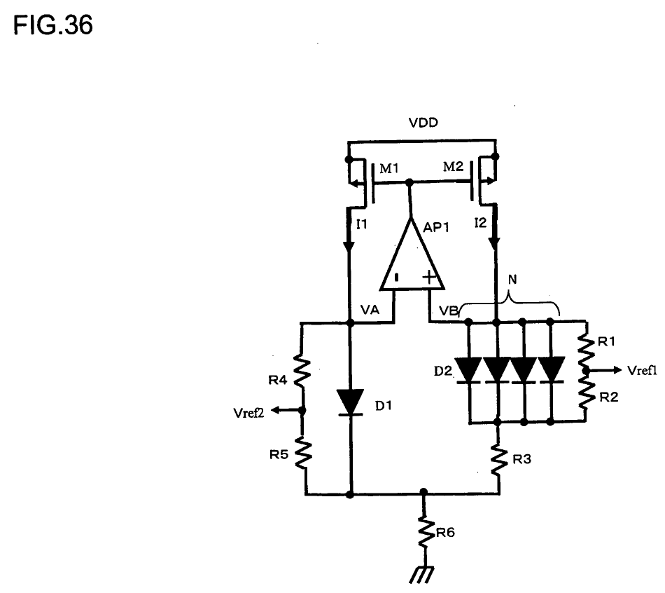

FIG. 36 depicts a circuit showing a specific example of a reference voltage circuit according to claim 9 of the present application. If, in the example described with reference to FIG. 35, the first current-to-voltage converter (I-V 1) and the second current-to-voltage converter (I-V2) of FIG. 35 are respectively replaced by a first current-to-voltage converter (I-V1), including a parallel connection of a diode D1 and series-connected resistors R4 and R5, and a second current-to-voltage converter (I-V2), including a plurality of diodes D2 and series-connected resistors R1 and R2 and a resistor R3 connected in series with the parallel connection of the diodes. D2 and (R1, R2), and the two current-to-voltage converters are grounded via a common resistor R6, there may be obtained a reference voltage circuit that uses an OP amp as control means. FIG. 36 shows a specific implementing circuit.

Referring to FIG. 36, one terminals of the first current-to-voltage converter (I-V1) and the second current-to-voltage converter (I-V2) are coupled together and grounded via the common resistor R6. The first current-to-voltage converter includes the parallel connection of the diode D1 and the series-connected resistors R4 and R5, and the second current-to-voltage converter includes the parallel connection of the diodes D2 and series-connected registers R1 and R2, and the resistor R3 connected in series with the parallel connection of D2 and (R1, R2), as described above. The other terminals arc connected to drains of transistors M1 and M2 that constitute a current mirror circuit, while being connected to an inverting input terminal and a non-inverting input terminal of an OP amp (AP1). An output terminal of the OP amp (AP1) is connected to coupled gates of the transistors M1 and M2 that constitute a current mirror circuit.

A mid-point terminal voltage of the series-connected resistors R4, and R5 of the first current-to-voltage converter (I-V1) is output as the reference voltage Vref2, while a mid-point terminal voltage of the series-connected resistors R1 and R2 of the second current-to-voltage converter (I-V2) is output as the reference voltage Vref1.

The operation of the circuit of FIG. 36 is now described. It is assumed that, in FIG. 36, the current I1 that drives the first current-to-voltage converter, including the parallel connection of the diode D1 and the series-connected resistors R4 and R5, and the current I2 that drives the second current-to-voltage converter, including the parallel connection of the a plurality of diodes D2 and the series-connected resistors R1 and R2, and the resistor R3 connected in series with the parallel connection of the diodes D2 and (R1, R2), are equal to each other.

Referring to FIG. 36, if one terminals of the first current-to-voltage converter (I-V1), including the parallel connection of the diode D1 and the series-connected resistors R4 and R5, and the second current-to-voltage converter, including the parallel connection of the a plurality of diodes D2 and the series-connected resistors R1 and R2, and the resistor R3 connected in series with the parallel connection of the diodes D2 and (R1, R2), are coupled together and grounded via resistor R6, the voltage drop at the resistor R6 is summed to the reference voltage.

In FIG. 36, VA is controlled to be equal to VB, so that

V_{F1}=V_{F2}+R₃I₂ (57)

If we put

ΔV_{F}=V_{F1}−V_{F2}=R₃I₂ (58)

the reference voltages Vref1, Vref2 may be found as

$$\begin{matrix}\begin{matrix}{Vref}_{1} = {R}_{6} ( {I}_{1} + {I}_{2} ) + {R}_{3} {I}_{2} + \frac{{R}_{2}}{{R}_{1} + {R}_{2}} {V}_{F 2} \\ = ( 1 + \frac{2 {R}_{6}}{{R}_{3}} ) Δ {V}_{F} + \frac{{R}_{2}}{{R}_{1} + {R}_{2}} {V}_{F 2} \\ = {α}_{1} {V}_{F 2} + ( 1 + β ) Δ {V}_{F}\end{matrix} & ( 59 ) \\ and & \\ \begin{matrix}{Vref}_{2} = {R}_{6} ( {I}_{1} + {I}_{2} ) + \frac{{R}_{5}}{{R}_{4} + {R}_{5}} {V}_{F 1} \\ = \frac{2 {R}_{6}}{{R}_{3}} Δ {V}_{F} + \frac{{R}_{5}}{{R}_{4} + {R}_{5}} {V}_{F 1} \\ = {α}_{2} {V}_{F 1} + βΔ {V}_{F}\end{matrix} & ( 60 )\end{matrix}$$

However, in actuality, the equation (58) may be expressed, after the equation (10), as

$$\begin{matrix}Δ {V}_{F} = {V}_{T} ln \{ \frac{N ( {I}_{1} - \frac{{V}_{F 1}}{{R}_{4} + {R}_{5}} )}{{I}_{2} - \frac{{V}_{F 2}}{{R}_{1} + {R}_{2}}} \} \\ = {V}_{T} ln [ \frac{N \{ 1 - \frac{{V}_{F 1}}{( {R}_{4} + {R}_{5} ) {I}_{1}} \}}{1 - \frac{{V}_{F 2}}{( {R}_{4} + {R}_{5} ) {I}_{1}}} ]\end{matrix} \qquad ( 61 )$$

Hence, in order for the reference voltages Vref1 and Vref2 to be temperature-compensated voltages, the following expressions:

$$\begin{matrix}\begin{matrix}\frac{\partial {Vref}_{1}}{\partial T} = {α}_{1} \frac{\partial {V}_{F 2}}{\partial T} + ( 1 + β ) ln [ \frac{N \{ 1 - \frac{{V}_{F 1}}{( {R}_{4} + {R}_{5} ) {I}_{1}} \}}{1 - \frac{{V}_{F 2}}{( {R}_{4} + {R}_{5} ) {I}_{1}}} ] \frac{\partial {V}_{T}}{\partial T} + \\ ( 1 + β ) {V}_{T} \frac{\partial }{\partial T} ln [ \frac{N \{ 1 - \frac{{V}_{F 1}}{( {R}_{4} + {R}_{5} ) {I}_{1}} \}}{1 - \frac{{V}_{F 2}}{( {R}_{4} + {R}_{5} ) {I}_{1}}} ] \\ = {α}_{1} \frac{\partial {V}_{F 2}}{\partial T} + ( 1 + β ) ln [ \frac{N \{ 1 - \frac{{V}_{F 1}}{( {R}_{4} + {R}_{5} ) {I}_{1}} \}}{1 - \frac{{V}_{F 2}}{( {R}_{4} + {R}_{5} ) {I}_{1}}} ] \frac{k}{q} + \\ ( 1 + β ) {V}_{1} \frac{\partial }{\partial T} ln [ \frac{N \{ 1 - \frac{{V}_{F 1}}{( {R}_{4} + {R}_{5} ) {I}_{1}} \}}{1 - \frac{{V}_{F 2}}{( {R}_{4} + {R}_{5} ) {I}_{1}}} ] \\ \approx 0\end{matrix} & ( 62 ) \\ and & \\ \begin{matrix}\frac{\partial {Vref}_{2}}{\partial T} = {α}_{2} \frac{\partial {V}_{F 1}}{\partial T} + βln [ \frac{N \{ 1 - \frac{{V}_{F 1}}{( {R}_{4} + {R}_{5} ) {I}_{1}} \}}{1 - \frac{{V}_{F 2}}{( {R}_{4} + {R}_{5} ) {I}_{1}}} ] \frac{\partial {V}_{T}}{\partial T} + \\ β {V}_{T} \frac{\partial }{\partial T} ln [ \frac{N \{ 1 - \frac{{V}_{F 1}}{( {R}_{4} + {R}_{5} ) {I}_{1}} \}}{1 - \frac{{V}_{F 2}}{( {R}_{4} + {R}_{5} ) {I}_{1}}} ] \\ = {α}_{2} \frac{\partial {V}_{F 1}}{\partial T} + βln [ \frac{N \{ 1 - \frac{{V}_{F 1}}{( {R}_{4} + {R}_{5} ) {I}_{1}} \}}{1 - \frac{{V}_{F 2}}{( {R}_{4} + {R}_{5} ) {I}_{1}}} ] \frac{k}{q} + \\ β {V}_{T} \frac{\partial }{\partial T} ln [ N \{ 1 - \frac{{V}_{F 1}}{( {R}_{4} + {R}_{5} ) {I}_{1}} \} ] \\ \approx 0\end{matrix} & ( 63 )\end{matrix}$$

need to hold, respectively.

Here, if we set

$$\frac{{V}_{F 1}}{{R}_{4} + {R}_{5}} \approx \frac{{V}_{F 2}}{{R}_{1} + {R}_{2}} \qquad ( 64 )$$

we have

Vref₁≈α₁V_{F2}+(1+β)V_{T}ln(N) (65)

and

Vref₁≈α₂V_{F1}+βV_{T}ln(N) (66)

so that the following expressions:

$$\begin{matrix}\begin{matrix}\frac{\partial {Vref}_{1}}{\partial T} \approx {α}_{1} \frac{\partial {V}_{F 2}}{\partial T} + ( 1 + β ) ln ( N ) \frac{\partial {V}_{T}}{\partial T} \\ = {α}_{1} \frac{\partial {V}_{F 2}}{\partial T} + ( 1 + β ) ln ( N ) \frac{k}{q} \\ \approx 0\end{matrix} & ( 67 ) \\ and & \\ \begin{matrix}\frac{\partial {Vref}_{2}}{\partial T} \approx {α}_{1} \frac{\partial {V}_{F 1}}{\partial T} + βln ( N ) \frac{\partial {V}_{T}}{\partial T} \\ = {α}_{1} \frac{\partial {V}_{F 1}}{\partial T} + βln ( N ) \frac{k}{q} \\ \approx 0\end{matrix} & ( 68 )\end{matrix}$$

Hold, respectively.

If, on the other hand, we set:

$$\frac{{V}_{F 1}}{{R}_{4} + {R}_{5}} < \frac{{V}_{F 2}}{{R}_{1} + {R}_{2}} \qquad ( 69 )$$

it is possible to enlarge the variable range, with temperature, of the value of the denominator in ln of the equation (56) as well as to render the anti-log of ln large or small at lower and higher temperatures, respectively.

That is, by making the temperature characteristic of the product of this log value and V_{T}, that is, ΔV_{BE}, a curved line, it is possible to compensate the temperature non-linearity proper to a diode more readily than with the Nagano's reference voltage circuit shown in FIG. 3.

Thus, to obtain the temperature-compensated reference voltages Vref1 and Vref2, the temperature characteristics of the driving currents I1 and I2 are set so as to be of a positive temperature characteristic. Hence, the voltage V_{PTAT} of the positive temperature characteristic is increased in an amount corresponding to the voltage drop by this resistor R6. Thus, by increasing the divided voltage V_{CTAT} of the diode's forward voltage having a negative temperature characteristic in a corresponding amount, it is possible to obtain a larger temperature-compensated reference voltage.

That is, the reference voltages Vref1, Vref2 may respectively be expressed as:

Vref1=α₁V_{F2}+(1+β)ΔV_{F}=V_{CTAT1}+V_{PTAT1} (70)

and

Vref2=α₂V_{F1}+βΔV_{F}=V_{CTAT2}+V_{PTAT2} (71)

### EXAMPLE 10-2

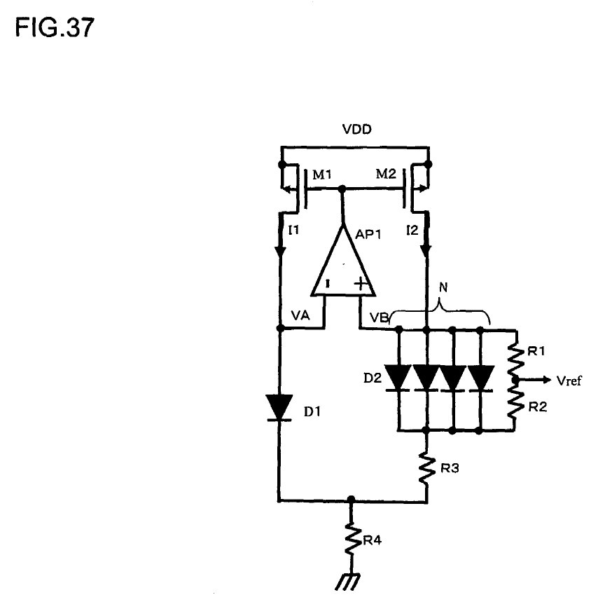

FIG. 37 depicts a circuit showing a specific example of a reference voltage circuit according to claim 9 of the present application. If, in the example described with reference to FIG. 35, the first current-to-voltage converter (I-V1) and the second current-to-voltage converter (I-V2) of FIG. 35 are respectively replaced by a first current-to-voltage converter (I-V1), including a diode D1, and a second current-to-voltage converter (I-V2), including a plurality of diodes D2 and series-connected resistors R1 and R2 and a resistor R3 connected in series with the parallel connection of diode D2 and (R1, R2), and the two current-to-voltage converters are grounded via a common resistor R4, there may be obtained a reference voltage circuit that uses an OP amp as control means. FIG. 37 shows a specific implementing circuit.

Referring to FIG. 37, one terminals of the first current-to-voltage converter (I-V1) and the second current-to-voltage converter (I-V2) are coupled together and grounded via common resistor R4. The first current-to-voltage converter includes the parallel connection of the diode D1 and the series-connected resistors R4, R5, and the second current-to-voltage converter includes the parallel connection of the a plurality of diodes D2 and the series-connected resistors R1 and R2, and the resistor R3 connected in series with the parallel connection of D2 and (R1, R2), as described above. The other terminals are connected to drains of transistors M1 and M2 that constitute a current mirror circuit, while being connected to an inverting input terminal and a non-inverting input terminal of an OP amp (AP1). An output terminal of the OP amp (AP1) is connected to coupled gates of the transistors M1 and M2 that constitute a current mirror circuit.

A mid-point terminal voltage of the series-connected resistors R1 and R2 of the second current-to-voltage converter (I-V2) is output as the reference voltage Vref1.

The operation of the circuit of FIG. 37 is now described. It is assumed that, in FIG. 37, the current I1 that drives the first current-to-voltage converter, including the diode D1, and the current I2 that drives the second current-to-voltage converter, including the parallel connection of diodes D2 and the series-connected resistors R1 and R2 and the resistor R3 connected in series with the parallel connection of the diodes D2 and (R1, R2), are equal to each other. Referring to FIG. 37, if one terminals of the first current-to-voltage converter (I-V1), including the diode D1, and the second current-to-voltage converter (I-V2), including the parallel connection of the a plurality of diodes D2 and the series-connected resistors R1 and R2 and the resistor R3 connected in series with the parallel connection of the diodes D2 and (R1, R2), are coupled together and grounded via resistor R4, the voltage drop at the resistor R4 is summed to the reference voltage.

In FIG. 36, VA is controlled to be equal to VB, so that

V_{F1}=V_{F2}+R₃I₂ (72)

If we put

ΔV_{F}=V_{F1}−V_{F2}=R₃I₂ (73)

the reference voltage Vref may be found by

$$\begin{matrix}Vref = {R}_{4} ( {I}_{1} + {I}_{2} ) + {R}_{3} {I}_{2} + \frac{{R}_{2}}{{R}_{1} + {R}_{2}} {V}_{F 2} \\ = ( 1 + \frac{2 {R}_{4}}{{R}_{3}} ) Δ {V}_{F} + \frac{{R}_{2}}{{R}_{1} + {R}_{2}} {V}_{F 2} \\ = {α}_{1} {V}_{F 2} + ( 1 + β ) Δ {V}_{F}\end{matrix} \qquad ( 74 )$$

However, in actuality, the equation (58) may be expressed, after the equation (10), as

$$\begin{matrix}Δ {V}_{F} = {V}_{T} ln \{ - \frac{{NI}_{1}}{{I}_{2} - \frac{{V}_{F 2}}{{R}_{1} + {R}_{2}}} \} \\ = {V}_{T} ln \{ \frac{N}{1 - \frac{{V}_{F 2}}{( {R}_{4} + {R}_{5} ) {I}_{1}}} \}\end{matrix} \qquad ( 75 )$$

Thus, in order for the reference voltage Vref to be a temperature-compensated voltage, the following expression:

$$\begin{matrix}\frac{\partial Vref}{\partial T} = {α}_{1} \frac{\partial {V}_{F 2}}{\partial T} + ( 1 + β ) ln \{ \frac{N}{1 - \frac{{V}_{F 2}}{( {R}_{4} + {R}_{5} ) {I}_{1}}} \} \frac{\partial {V}_{1}}{\partial T} + \\ ( 1 + β ) {V}_{T} \frac{\partial }{\partial T} ln \{ \frac{N}{1 - \frac{{V}_{F 2}}{( {R}_{4} + {R}_{5} ) {I}_{1}}} \} \\ = {α}_{1} \frac{\partial {V}_{F 2}}{\partial T} + ( 1 + β ) ln \{ \frac{N}{1 - \frac{{V}_{F 2}}{( {R}_{4} + {R}_{5} ) {I}_{1}}} \} \frac{k}{q} + \\ ( 1 + β ) {V}_{T} \frac{\partial }{\partial T} ln \{ \frac{N}{1 - \frac{{V}_{F 2}}{( {R}_{4} + {R}_{5} ) {I}_{1}}} \} \\ \approx 0\end{matrix} \qquad ( 76 )$$

has to be valid.

It is possible to enlarge the variable range, with temperature, of the value of the denominator in ln of the equation (75) as well as to render the anti-log of ln large or small at lower and higher temperatures, respectively. That is, by making the temperature characteristic of the product of this log value and V_{T}, that is, ΔV_{BE}, a curved line, it is possible to compensate the temperature non-linearity proper to a diode more readily than with the Nagano's reference voltage circuit shown in FIG. 3.

Thus, to obtain the temperature-compensated reference voltage Vref, the temperature characteristics of the driving currents I1 and I2 are set so as to be positive.

Hence, the voltage V_{PTAT} of the positive temperature characteristic is increased in an amount corresponding to the voltage drop by this resistor R6. Thus, by increasing the divided voltage V_{CTAT} of the diode's forward voltage, having a negative temperature characteristic, in a corresponding amount, it is possible to obtain a larger temperature-compensated reference voltage.

Thus, the reference voltage Vref is expressed as:

Vref=αV_{F2}+(1+β)ΔV_{F}=V_{CTAT}+V_{PTAT} (77)

### EXAMPLE 10-3

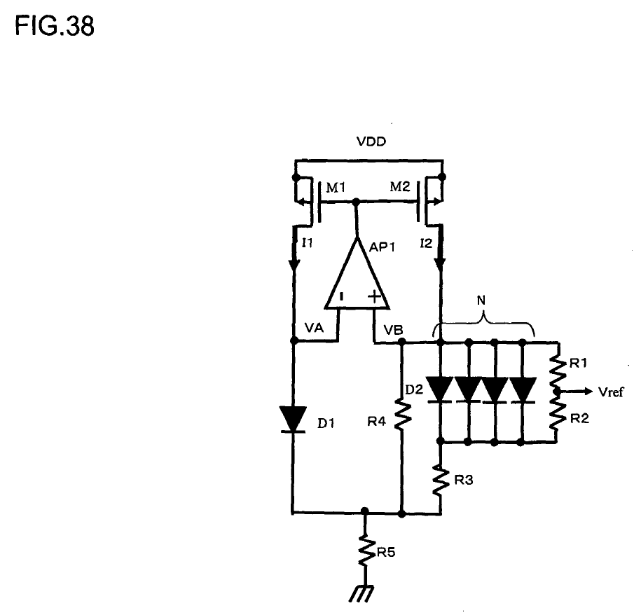

FIG. 38 depicts a circuit showing a specific example of a reference voltage circuit according to claim 9 of the present application. If, in the example described with reference to FIG. 35, the first current-to-voltage converter (I-V1) and the second current-to-voltage converter (I-V2) are respectively replaced by a first current-to-voltage converter, (I-V1), including a diode D1, and a second current-to-voltage converter (I-V2), including a parallel connection of a plurality of diodes D2 and series-connected resistors R1 and R2, a resistor R3 connected in series with the parallel connection of diodes D2 and (R1, R2) and a resistor R4 connected in parallel with the series connection of R3 and the parallel connection of diodes D2 and (R1,R2), and the first and second current-to-voltage converter are coupled together and grounded via a common resistor R5, there may be obtained a reference voltage circuit that uses an OP amp as control means. FIG. 38 shows a specific implementing circuit.

Referring to FIG. 38, one terminals of the first current-to-voltage converter (I-V1) and the second current-to-voltage converter (I-V2) are coupled together and grounded via the common resistor R5. The first current-to-voltage converter includes the diode D1, and the second current-to-voltage converter includes the parallel connection of the a plurality of diodes D2 and the series-connected resistors R1 and R2, the resistor R3 connected in series with the parallel connection of the diodes D2 and (R1, R2) and the resistor R4 connected in parallel with the series connection of R3 and the parallel connection of the diodes D2 and (R1,R2). The other terminals are connected to drains of transistors M1 and M2 that constitute a current mirror circuit, while being connected to an inverting input terminal and a non-inverting input terminal of an OP amp (AP1). An output terminal of the OP amp (AP1) is connected to coupled gates of the transistors M1 and M2 that constitute a current mirror circuit. A mid-point terminal voltage of the series-connected resistors R1 and R2 of the second current-to-voltage converter (I-V2) is output as the reference voltage Vref.

The operation of the circuit of FIG. 36 is now described. It is assumed that, in FIG. 38, the current I1 that drives the first current-to-voltage converter, including the diode D1, and the current I2 that drives the second current-to-voltage converter, including the parallel connection of the a plurality of diodes D2 and the series-connected resistors R1 and R2, the resistor R3 connected in series with the parallel connection of D2 and (R1, R2) and the resistor R4 connected in parallel with the series connection of R3 and the parallel connection of D2 and (R1,R2), are equal to each other.

Referring to FIG. 38, if one terminals of the first current-to-voltage converter (I-V1), including the diode D1, and the second current-to-voltage converter, including the parallel connection of the a plurality of diodes D2 and series-connected resistors R1 and R2, the resistor R3 connected in series with the parallel connection of D2 and (R1, R2) and the resistor R4 connected in parallel with the series connection of R3 and the parallel connection of D2 and (R1,R2), are coupled together and grounded via resistor R6, the voltage drop at the resistor R6 is summed to the reference voltage.

In FIG. 36, VA is controlled to be equal to VB, so that

V_{F1}=V_{F2}+R₃(I₂−V_{F1}/R₄) (78)

If we put

ΔV_{F}=V_{F1}−V_{F2}=R₃(I₂−V_{F1}/R₄) (79)

the reference voltage Vref may be found as

$$\begin{matrix}Vref = {R}_{5} ( {I}_{1} + {I}_{2} ) + {R}_{1} ( {I}_{2} - \frac{{V}_{F 1}}{{R}_{4}} ) + \frac{{R}_{2}}{{R}_{1} + {R}_{2}} {V}_{F 2} \\ = \frac{2 {R}_{s}}{{R}_{4}} ( {V}_{F 1} + \frac{{R}_{4}}{{R}_{3}} Δ {V}_{F} ) + Δ {V}_{F} + \frac{{R}_{2}}{{R}_{1} + {R}_{2}} {V}_{F 2} \\ = α {V}_{F 2} + Δ {V}_{F} + γ ( {V}_{F 1} + K Δ {V}_{F} )\end{matrix} \qquad ( 80 )$$

However, in actuality, the equation (79) may be expressed, like the equation (10), as

$$\begin{matrix}Δ {V}_{F} = {V}_{T} ln \{ \frac{{NI}_{1}}{{I}_{2} - \frac{{V}_{F 2}}{{R}_{1} + {R}_{2}}} \} \\ = {V}_{T} ln \{ \frac{N}{1 - \frac{{V}_{F 2}}{( {R}_{4} + {R}_{5} ) {I}_{1}}} \}\end{matrix} \qquad ( 81 )$$

It may be seen that the equation (73) represents an expression of a voltage mode reference voltage equivalent to the equations (7) and (14):

(αV_{F2}+ΔV_{F})

plus the current mode reference voltage:

{γ(V_{F1}+KΔV_{F})}

that is derived from the Bamba's reference voltage circuit.

Thus, it will be appreciated that, in order for the reference voltage Vref to be a temperature-compensated voltage, it is sufficient, as a principle, to set both of these two elements, namely

(αV_{F2}+ΔV_{F})

and

{γ(V_{F1}+KΔV_{F})}

so that these are temperature-compensated voltages. Such coefficients that enable the above setting do exist.

Thus,

$$\begin{matrix}\frac{\partial Vref}{\partial T} = α \frac{\partial {V}_{F 2}}{\partial T} + ln \{ \frac{N}{1 - \frac{{V}_{F 2}}{( {R}_{4} + {R}_{5} ) {I}_{1}}} \} \frac{\partial {V}_{T}}{\partial T} + \\ {V}_{T} \frac{\partial }{\partial T} ln \{ \frac{N}{1 - \frac{{V}_{F 2}}{( {R}_{4} + {R}_{5} ) {I}_{1}}} \} + \\ γ [ \frac{\partial {V}_{F 1}}{\partial T} + K ln \{ \frac{N}{1 - \frac{{V}_{F 2}}{( {R}_{4} + {R}_{5} ) {I}_{1}}} \} \frac{\partial {V}_{T}}{\partial T} + \\ {KV}_{T} \frac{\partial }{\partial T} ln \{ \frac{N}{1 - \frac{{V}_{F 2}}{( {R}_{4} + {R}_{5} ) {I}_{1}}} \} ] \\ = α \frac{\partial {V}_{F 2}}{\partial T} + ln \{ \frac{N}{1 - \frac{{V}_{F 2}}{( {R}_{4} - {R}_{5} ) {I}_{1}}} \} \frac{k}{q} + \\ {V}_{T} \frac{\partial }{\partial T} ln \{ \frac{N}{1 - \frac{{V}_{F 2}}{( {R}_{4} + {R}_{5} ) {I}_{1}}} \} + \\ γ [ \frac{\partial {V}_{F 1}}{\partial T} + K ln \{ \frac{N}{1 - \frac{{V}_{F 2}}{( {R}_{4} + {R}_{5} ) {I}_{1}}} \} \frac{k}{q} + \\ {KV}_{T} \frac{\partial }{\partial T} ln \{ \frac{N}{1 - \frac{{V}_{F 2}}{( {R}_{4} + {R}_{5} ) {I}_{1}}} \} ] \\ \approx 0\end{matrix} \qquad ( 82 )$$

has to hold.

It is possible to enlarge the variable range, with temperature, of the value of the denominator in ln of the equation (81) as well as to render the anti-log of ln large or small at lower and higher temperatures, respectively. That is, by making the temperature characteristic of the product of this log value and V_{T}, that is, ΔV_{F}, a curved line, it is possible to compensate the temperature non-linearity proper to a diode more readily than with the Nagano's reference voltage circuit shown in FIG. 3.

Thus, to obtain the temperature-compensated reference voltage Vref, the temperature characteristics of the driving currents I1 and I2 are set so that these temperature characteristics cancel each other. Thus, a temperature-compensated voltage is obtained by adding the divided voltage V_{CTAT2} of the diode's forward voltage having a negative temperature characteristic to V_{PTAT} having a positive temperature characteristic. This temperature-compensated voltage is summed to a temperature-compensated voltage {γ(V_{CTAT1}+KV_{PTAT})} corresponding to voltage drop at this resistor R6 to yield a larger reference voltage.

That is, the reference voltage Vref is expressed as:

Vref=αV_{F2}+ΔV_{F}+γ(V_{F1}+KΔV_{F})=V_{CTAT2}+V_{PTAT}+γ(V_{CTAT1}+KV_{PTAT}) (83)

### EXAMPLE 10-4

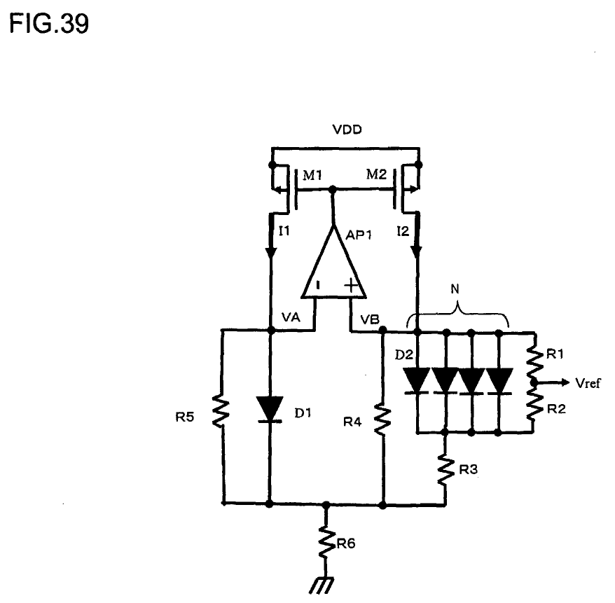

FIG. 39 depicts a circuit showing a specific example of a reference voltage circuit according to claim 9 of the present application. If, in the example described with reference to FIG. 35, the first current-to-voltage converter (I-V1) and the second current-to-voltage converter (I-V2) are respectively replaced by a first current-to-voltage converter (I-V1), including a parallel connection of a diode D1 and a resistor R5, and a second current-to-voltage converter (I-V2), including a plurality of diodes D2 and series-connected resistors R1 and R2, a resistor R3 connected in series with the parallel connection of D2 and (R1, R2) and a resistor R4 connected in parallel with the series connection of R3 and the parallel connection of D2 and (R1,R2) and the two current-to-voltage converters are grounded via a common resistor R6, a reference voltage circuit that uses an OP amp as control means may be obtained. FIG. 39 shows a specific implementing circuit.

Referring to FIG. 39, one terminals of the first current-to-voltage converter (I-V1) and the second current-to-voltage converter (I-V2) are coupled together and grounded via a common resistor R6. The first current-to-voltage converter includes the parallel connection of the diode D1 and the resistor R5, and the second current-to-voltage converter includes the parallel connection of the diodes D2 and the series-connected resistors R1 and R2, the resistor R3 connected in series with the parallel connection of D2 and (R1, R2) and the resistor R4 connected in parallel with the series connection of R3 and the parallel connection of D2 and (R1,R2), as described above. The other terminals are connected to drains of transistors M1 and M2 that constitute a current mirror circuit, while being connected to an inverting input terminal and a non-inverting input terminal of an OP amp (AP1). An output terminal of the OP amp (AP1) is connected to coupled gates of the transistors M1 and M2 that constitute a current mirror circuit.

A mid-point terminal voltage of the series-connected resistors R1 and R2 of the second current-to-voltage converter (I-V2) is output as the reference voltage Vref.

The operation of the circuit of FIG. 39 is now described. Let it be assumed that, in FIG. 39, the current I1 that drives the first current-to-voltage converter, and that includes the parallel connection of the diode D1 and the resistor R5, and the current I2 that drives the second current-to-voltage converter, and that includes the parallel connection of the plurality of diodes D2 and the series-connected resistors R1 and R2, the resistor R3 connected in series with the parallel connection and the resistor R4 connected in parallel with the series connection, are equal to each other.

Referring to FIG. 39, if one terminals of the first current-to-voltage converter (I-V1), including the parallel connection of the diode D1 and the resistor R5, and the second current-to-voltage converter, including the parallel connection of the a plurality of diodes D2 and the series-connected resistors R1 and R2, the resistor R3 connected in series with the parallel connection of D2 and (R1, R2) and the resistor R4 connected in parallel with the series connection of R3 and the parallel connection of D2 and (R1,R2), are coupled together and grounded via resistor R6, the voltage drop at the resistor R is summed to the reference voltage.

In FIG. 36, VA is controlled to be equal to VB, so that

V_{F1}=V_{F2}+R₃(I₂−V_{F1}/R₄) (84)

If we put

ΔV_{F1}=V_{F1}−V_{F2}=R₃(I₂−V_{F1}/R₄) (85)

the reference voltage Vref may be found by

$$\begin{matrix}Vref = {R}_{6} ( {I}_{1} + {I}_{2} ) + {R}_{3} ( {I}_{2} - \frac{{V}_{F 1}}{{R}_{4}} ) + \frac{{R}_{2}}{{R}_{1} + {R}_{2}} {V}_{F 2} \\ = \frac{2 {R}_{6}}{{R}_{4}} ( {V}_{F 1} + \frac{{R}_{4}}{{R}_{3}} Δ {V}_{F} ) + Δ {V}_{F} + \frac{{R}_{2}}{{R}_{1} + {R}_{2}} {V}_{F 2} \\ = α {V}_{F 2} + Δ {V}_{F} + γ ( {V}_{F 1} + K Δ {V}_{F} )\end{matrix} \qquad ( 86 )$$

However, in actuality, the equation (79) may be expressed, like the equation (10), by

$$Δ {V}_{F} = {V}_{T} ln \{ \frac{N ( {I}_{1} - \frac{{V}_{F 1}}{{R}_{5}} )}{{I}_{2} - \frac{{V}_{F 2}}{{R}_{1} + {R}_{2}}} \} = {V}_{I} ln \{ \frac{N ( 1 - \frac{{V}_{F 1}}{{R}_{5} {I}_{1}} )}{1 - \frac{{V}_{F 2}}{( {R}_{4} + {R}_{5} ) {I}_{1}}} \} \qquad ( 87 )$$

It may be seen that the equation (86) is the sum of the expression of the voltage mode reference voltage equivalent to the equations (7) and (14), that is,

(αV_{F2}+ΔV_{F})

and the expression of the current mode reference voltage, obtained from the Bamba's reference voltage circuit, that is,

{γ(V_{F1}+KΔV_{F})}

Thus, as a principle, if the reference voltage Vref is to be a temperature-compensated voltage, it is sufficient that the above two elements, namely (αV_{F2}+ΔV_{F}) and {γ(V_{F1}+KΔV_{F})}, are set so that both of these are temperature-compensated voltages. It is noted that the coefficients α, γ and K that enable the above setting do exist.

Hence,

$$\begin{matrix}\frac{\partial Vref}{\partial T} = α \frac{\partial {V}_{F 2}}{\partial T} + ln \{ \frac{N ( 1 - \frac{{V}_{F 2}}{{R}_{5} {I}_{1}} )}{1 - \frac{{V}_{F 2}}{( {R}_{4} + {R}_{5} ) {I}_{1}}} \} \frac{\partial {V}_{T}}{\partial T} + \\ {V}_{T} \frac{\partial }{\partial T} + {V}_{T} \frac{\partial }{\partial T} ln \{ \frac{N ( 1 - \frac{{V}_{F 1}}{{R}_{5} {I}_{1}} )}{1 - \frac{{V}_{F 2}}{( {R}_{4} + {R}_{5} ) {I}_{1}}} \} + \\ γ [ \frac{\partial {V}_{F 1}}{\partial T} + K ln \{ \frac{N ( 1 - \frac{{V}_{F 1}}{{R}_{5} {I}_{1}} )}{1 - \frac{{V}_{F 2}}{( {R}_{4} + {R}_{5} ) {I}_{1}}} \} \frac{\partial {V}_{T}}{\partial T} + \\ {KV}_{T} \frac{\partial }{\partial T} ln \{ \frac{N ( 1 - \frac{{V}_{F 1}}{{R}_{5} {I}_{1}} )}{1 - \frac{{V}_{F 2}}{( {R}_{4} + {R}_{5} ) {I}_{1}}} \} ] \\ = α \frac{\partial {V}_{F 2}}{\partial T} + ln \{ \frac{N ( 1 - \frac{{V}_{F 1}}{{R}_{5} {I}_{1}} )}{1 - \frac{{V}_{F 2}}{( {R}_{4} + {R}_{5} ) {I}_{1}}} \} \frac{k}{q} + \\ {V}_{T} \frac{\partial }{\partial T} ln \{ \frac{N \{ 1 - \frac{{V}_{F 1}}{{R}_{5} {I}_{1}} \}}{1 - \frac{{V}_{F 2}}{( {R}_{4} + {R}_{5} ) {I}_{1}}} \} + \\ γ [ \frac{\partial {V}_{F 1}}{\partial T} + K ln \{ \frac{N ( 1 - \frac{{V}_{F 1}}{{R}_{5} {I}_{1}} )}{1 - \frac{{V}_{F 2}}{( {R}_{4} + {R}_{4} ) {I}_{1}}} \} \frac{k}{q} + \\ {KV}_{T} \frac{\partial }{\partial T} ln \{ \frac{N \{ 1 - \frac{{V}_{F 1}}{{R}_{5} {I}_{1}} \}}{1 - \frac{{V}_{F 2}}{( {R}_{4} + {R}_{5} ) {I}_{1}}} \} ] \\ \approx 0\end{matrix} \qquad ( 88 )$$

has to hold.

It is possible to enlarge the variable range, with temperature, of the value of the denominator in ln of the equation (87) as well as to render the anti-log of ln large or small at lower and higher temperatures, respectively. That is, by making the temperature characteristic of the product of this log value and V_{T}, that is, ΔV_{F}, a curved line, it is possible to compensate the temperature non-linearity proper to a diode more readily than with the Nagano's reference voltage circuit shown in FIG. 3.

Thus, to obtain the temperature-compensated reference voltage Vref, the temperature characteristics of the driving currents I1 and I2 are set so as to cancel out temperature characteristics.

Hence, by summing a divided voltage V_{CTAT2} of the forward voltage of the diode, having a negative temperature characteristic, to V_{PTAT} having a positive temperature characteristic, a temperature-compensated voltage is obtained, which is then summed to a temperature-compensated voltage corresponding to a voltage drop by the resistor R6. It is thus possible to obtain a larger temperature-compensated reference voltage.

Thus, the reference voltage Vref is expressed as:

Vref=αV_{F2}+ΔV_{F}+γ(V_{F1}+KΔV_{F})=V_{CTAT2}+V_{PTAT}+γ(V_{CTAT1}+KV_{PTAT}) (89)

### EXAMPLE 10-5

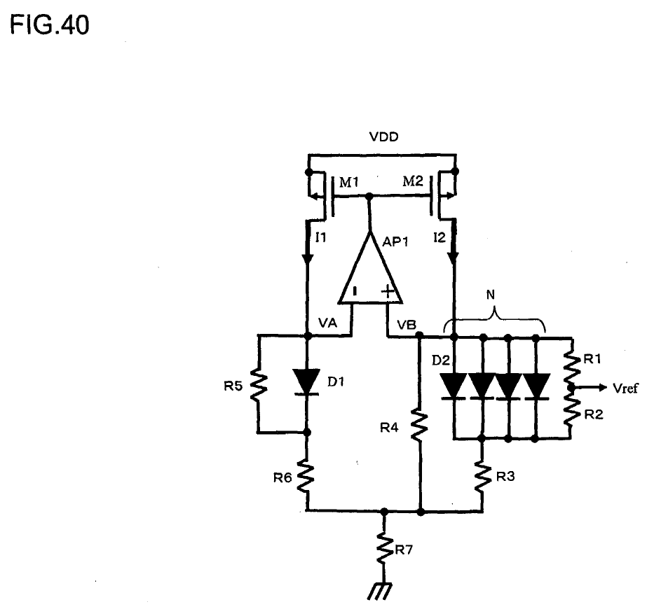

FIG. 40 depicts a circuit showing a specific example of a reference voltage circuit according to claim 9 of the present application. If, in the example described with reference to FIG. 35, the first current-to-voltage converter (I-V1) and the second current-to-voltage converter (I-V2) are respectively replaced by a first current-to-voltage converter (I-V1), including a parallel connection of a diode D1 and a resistor R5 and a resistor R6 connected in series with the parallel connection, and a second current-to-voltage converter (I-V2), including a plurality of diodes D2 and series-connected resistors R1 and R2, a resistor R3 connected in series with the parallel connection of D2 and (R1, R2) and a resistor R4 connected in parallel with the series connection of R3 and the parallel connection of D2 and (R1,R2), and the two current-to-voltage converters are grounded via a common resistor R7; a reference voltage circuit that uses an OP amp as control means may be obtained. FIG. 40 shows a specific implementing circuit.

Referring to FIG. 40, one terminals of the first current-to-voltage converter (I-V1) and the second current-to-voltage converter (I-V2) are coupled together and grounded via a common resistor R7. The first current-to-voltage converter includes the parallel connection of the diode D1 and the resistor R5 and the resistor R6 connected in series with the parallel connection of D1 and D5. The second current-to-voltage converter (I-V2) includes the a plurality of diodes D2 and the series-connected resistors R1 and R2, the resistor R3 connected in series with the parallel connection of D2 and (R1, R2), and the resistor R4 connected in parallel with the series connection of R3 and the parallel connection of D2 and (R1, R2), as described above. The other terminals are connected to drains of transistors M1 and M2 that constitute a current mirror circuit, and are connected to an inverting input terminal and a non-inverting input terminal of an OP amp (AP1). An output terminal of the OP amp (AP1) is connected to coupled gates of the transistors M1 and M2 that constitute a current mirror circuit.

A mid-point terminal voltage of the series-connected resistors R1 and R2 of the second current-to-voltage converter (I-V2) is output as the reference voltage Vref.

The operation of the circuit of FIG. 40 is now described. Let it be assumed that, in FIG. 40, the current I1 that drives the first current-to-voltage converter, including the parallel connection of the diode D1 and the resistor R5 and the resistor R6 connected in series with the parallel connection, and the current I2 that drives the second current-to-voltage converter, including the parallel connection of the diodes D2 and series-connected resistors R1 and R2, resistor R3 connected in series with the parallel connection and the resistor R4 connected in parallel with the series connection, are equal to each other.

Referring to FIG. 40, if one terminals of the first current-to-voltage converter (I-V1), including the parallel connection of the diode D1 and the resistor R5 and the resistor R6 connected in series with the parallel connection, and the second current-to-voltage converter, including the parallel connection of the diodes D2 and the series-connected resistors R1 and R2, the resistor R3 connected in series with the parallel connection of D2 and (R1, R2) and the resistor R4 connected in parallel with the series connection of R3 and the parallel connection of D2 and (R1, R2), are coupled together and grounded via resistor R7, the voltage drop at the resistor R7 is summed to the reference voltage.

In FIG. 40, VA is controlled to be equal to VB, so that

V_{F1}+R₆I₁=V_{F2}+R₃{I₂−(V_{F1}+R₆I₁)/R_{4}} (90)

If we put

ΔV_{F}=V_{F1}−V_{F2}=R₃{I₂−(V_{F1}+R₆I₁)/R₄}−R₆I₁ (91)

the reference voltage Vref may be found as

$$\begin{matrix}Vref = {R}_{7} ( {I}_{1} + {I}_{2} ) + {R}_{6} {I}_{1} + Δ {V}_{F} + \frac{{R}_{2}}{{R}_{1} + {R}_{2}} {V}_{F 2} \\ = ( 2 {R}_{7} + {R}_{6} ) {I}_{1} + Δ {V}_{F} + \frac{{R}_{2}}{{R}_{1} + {R}_{2}} {V}_{F 2} \\ = α {V}_{F 2} + Δ {V}_{F} + ( 2 {R}_{7} + {R}_{6} ) {I}_{1}\end{matrix} \qquad ( 92 )$$

However, in actuality, if expressed after the equation, the equation (91) may be written as

$$Δ {V}_{F} = {V}_{T} ln \{ \frac{N ( {I}_{1} - \frac{{V}_{F 1}}{{R}_{S}} )}{{I}_{2} - \frac{{V}_{F 2}}{{R}_{1} + {R}_{2}} - \frac{{V}_{F 1} + {R}_{6} {I}_{1}}{{R}_{4}}} \} \\ = {V}_{T} ln \{ \frac{N ( 1 - \frac{{V}_{F 1}}{{R}_{5} {I}_{1}} )}{1 - \frac{{V}_{F 2}}{( {R}_{4} + {R}_{5} ) {I}_{1}} - \frac{{V}_{F 1} + {R}_{6} {I}_{1}}{{R}_{4} {I}_{1}}} \} \qquad ( 93 )$$

It may be seen that the equation (74) corresponds to the expression

(αV_{F2}+ΔV_{F})

of the voltage mode reference voltage, equivalent to the equations (7) and (14), plus the voltage drop {(2R₇+R₆)I₁} by the resistor. It may thus be understood that, as a principle, if the reference voltage Vref is to be a temperature-compensated voltage, it is sufficient to set both of these two elements, namely

(αV_{F2}+ΔV_{F})

and {(2R₇+R₆)I₁}, so as to be temperature-compensated voltages.

Alternatively, by eliminating the current I1, with the use of the equation (91), the equation (92) may be written as

$$\begin{matrix}Vref = \frac{2 {R}_{3} {R}_{7} + {R}_{3} {R}_{6}}{{R}_{3} {R}_{4} - {R}_{4} {R}_{6} - {R}_{3} {R}_{6}} {V}_{F 1} + \frac{{R}_{2}}{{R}_{1} + {R}_{2}} {V}_{F 2} + \\ \frac{2 {R}_{3} {R}_{7} + {R}_{3} {R}_{4} - {R}_{4} {R}_{6}}{{R}_{3} {R}_{4} - {R}_{4} {R}_{6} - {R}_{3} {R}_{6}} Δ {V}_{T} \\ = {α}_{1} {V}_{F 1} + {α}_{2} {V}_{F 2} + β Δ {V}_{F}\end{matrix} \qquad ( 94 )$$

Thus, if the reference voltage Vref is to be a temperature-compensated voltage,

$$\begin{matrix}\frac{\partial Vref}{\partial T} = {α}_{1} \frac{\partial {V}_{F 1}}{\partial T} + {α}_{2} \frac{\partial {V}_{F 2}}{\partial T} + \\ β ln \{ \frac{N \{ 1 - \frac{{V}_{F 1}}{{R}_{5} {I}_{1}} \}}{1 - \frac{{V}_{F 2}}{( {R}_{4} + {R}_{5} ) {I}_{1}} - \frac{{V}_{F 1} + {R}_{6} {I}_{1}}{{R}_{4} {I}_{1}}} \} \frac{\partial {V}_{T}}{\partial T} + \\ β {V}_{T} \frac{\partial }{\partial T} ln \{ \frac{N \{ 1 - \frac{{V}_{F 1}}{{R}_{5} {I}_{1}} \}}{1 - \frac{{V}_{F 2}}{( {R}_{4} + {R}_{4} ) {I}_{1}} - \frac{{V}_{F 1} + {R}_{6} {I}_{1}}{{R}_{4} {I}_{1}}} \} \\ = {α}_{1} \frac{\partial {V}_{F 1}}{\partial T} + {α}_{2} \frac{\partial {V}_{F 2}}{\partial T} + \\ β ln \{ \frac{N \{ 1 - \frac{{V}_{F 1}}{{R}_{5} {I}_{1}} \}}{1 - \frac{{V}_{F 2}}{( {R}_{4} + {R}_{5} ) {I}_{1}} - \frac{{V}_{F 1} + {R}_{6} {I}_{1}}{{R}_{4} {I}_{1}}} \} \frac{k}{q} + \\ β {V}_{T} \frac{\partial }{\partial T} ln \{ \frac{N \{ 1 - \frac{{V}_{F 1}}{{R}_{5} {I}_{1}} \}}{1 - \frac{{V}_{F 2}}{( {R}_{4} + {R}_{5} )} - \frac{{V}_{F 1} + {R}_{6} {I}_{1}}{{R}_{4} {I}_{1}}} \} \\ \approx 0\end{matrix} \qquad ( 95 )$$

has to hold.

It is possible to enlarge the variable range, with temperature, of the value of the denominator in ln of the equation (93) as well as to render the anti-log of ln large or small at lower and higher temperatures, respectively. That is, by making the temperature characteristic of the product of this log value and V_{T}, that is, ΔV_{F}, a curved line, it is possible to compensate the temperature non-linearity proper to a diode more readily than with the Nagano's reference voltage circuit shown in FIG. 3.

Thus, to obtain the temperature-compensated reference voltage Vref, the temperature characteristics of the driving currents I1 and I2 are set so as to be canceled out.

Hence, by summing a divided voltage V_{CTAT} of the diode's forward voltage, having a negative temperature coefficient, to V_{PTAT} having a positive temperature coefficient, a temperature-compensated voltage is obtained, which is then summed to a temperature-compensated voltage V_{ADD} corresponding to a voltage drop by the resistor R6. It is thus possible to obtain a larger temperature-compensated reference voltage.

Thus, the reference voltage Vref is expressed as:

Vref=αV_{F2}+ΔV_{F}+V_{ADD}=V_{CTAT}+V_{PTAT}+V_{ADD} (96)

### EXAMPLE 10-6

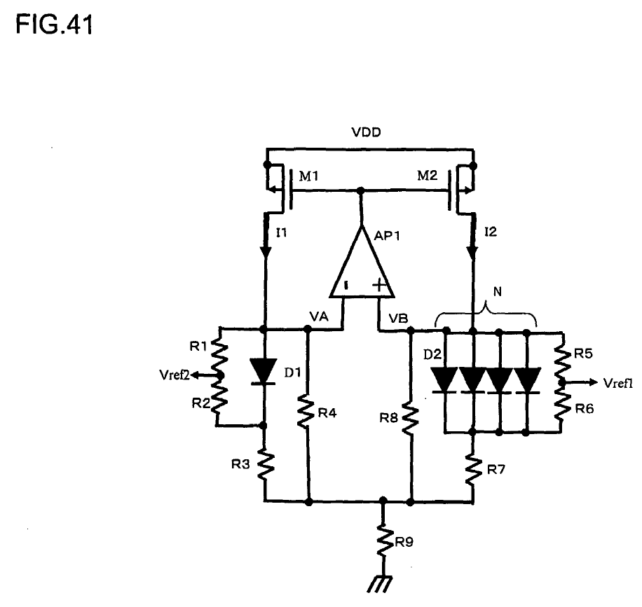

FIG. 41 depicts a circuit showing a specific example of a reference voltage circuit according to claim 9 of the present application. If, in the example described with reference to FIG. 35, the first current-to-voltage converter (I-V1) and the second current-to-voltage converter (I-V2) are respectively replaced by a first current-to-voltage converter (I-V1), including a parallel connection of a diode D1 and series-connected resistors R1 and R2, a resistor R3 connected in series with the parallel connection of D1 and (R1,R2), and a resistor R4 connected in parallel with the series connection of R3 and the parallel connection of D1 and (R1,R2), and a second current-to-voltage converter (I-V2), including a plurality of diodes D2 and series-connected resistors R5 and R6, a resistor R7 connected in series with the parallel connection of D2 and (R5, R6) and a resistor R8 connected in parallel with the series connection of R7 and the parallel connection of D2 and (R5, R6), and the two current-to-voltage converters are grounded via a common resistor R9, a reference voltage circuit that uses an OP amp as control means may be obtained. FIG. 41 shows a specific implementing circuit.

Referring to FIG. 41, one terminals of the first current-to-voltage converter (I-V1) and the second current-to-voltage converter (I-V2) are coupled together and grounded via common resistor R9. The first current-to-voltage converter includes the parallel connection of the diode D1 and the series-connected resistors R1 and R2, the resistor R3 connected in series with the parallel connection of D1 and (R1,R2) and the resistor R4 connected in parallel with the series connection of R3 and the parallel connection of D1 and (R1,R2), and the second current-to-voltage converter (I-V2) includes the diodes D2 and the series-connected resistors R5 and R6, the resistor R7 connected in series with the parallel connection of D2 and (R5, R6) and the resistor R8 connected in parallel with the series connection of R7 and (the parallel connection of D2 and (R5, R6), as described above. The other terminals are connected to drains of transistors M1 and M2 that constitute a current mirror circuit, while being connected to an inverting input terminal and a non-inverting input terminal of an OP amp (AP1). An output terminal of the OP amp (AP1) is connected to coupled gates of the transistors M1 and M2 that constitute a current mirror circuit.

A mid-point terminal voltage of the series-connected resistors R1 and R2 of the second current-to-voltage converter (I-V2) is output as the reference voltage Vref.

The operation of the circuit of FIG. 41 is now described. Let it be assumed that, in FIG. 41, the current I1 that drives the first current-to-voltage converter, including the parallel connection of the diode D1 and the series-connected resistors R1 and R2, the resistor R3 connected in series with the parallel connection of D1 and (R1,R2), and the resistor R4 connected in parallel with the series connection of R3 and the parallel connection of D1 and (R1,R2), and the current I2 that drives the second current-to-voltage converter, including the diodes D2 and the series-connected resistors R5 and R6, the resistor R7 connected in series with the parallel connection of D2 and (R5, R6), and the resistor R8 connected in parallel with the series connection of R7 and the parallel connection of D2 and (R5, R6), are equal to each other.

Referring to FIG. 41, if one terminals of the first current-to-voltage converter (I-V1), including the parallel connection of the diode D1 and the series-connected resistors R1 and R2, the resistor R3 connected in series with the parallel connection of D1 and (R1,R2), and the resistor R4 connected in parallel with the series connection of R3 and the parallel connection of D1 and (R1,R2), and the second current-to-voltage converter, including a plurality of diodes D2 and the series-connected resistors R5 and R6, resistor R7 connected in series with the parallel connection of D2 and (R5,R6), and the resistor R8 connected in parallel with the series connection of R7 and the parallel connection of D2 and (R5,R6), are coupled together and grounded via resistor R9, the voltage drop at the resistor R is summed to the reference voltage.

In FIG. 36, VA is controlled to be equal to VB, so that

$$\begin{matrix}{V}_{F 1} + {R}_{6} {I}_{1} = {V}_{F 2} + {R}_{3} \{ {I}_{2} - ( {V}_{F 1} + {R}_{6} {I}_{1} ) / {R}_{4} & ( 97 ) \\ {I}_{1} = \frac{{V}_{A}}{{R}_{4}} + \frac{{V}_{A} - {V}_{F 1}}{{R}_{3}} \\ and & ( 98 ) \\ {I}_{2} = \frac{{V}_{B}}{{R}_{4}} + \frac{{V}_{B} - {V}_{F 2}}{{R}_{7}} & ( 99 )\end{matrix}$$

With I1=I2 and VA=VB, VA may be found by

$$\begin{matrix}{V}_{A} = ( {V}_{B} = ) \frac{\frac{{V}_{F 1}}{{R}_{3}} - \frac{{V}_{F 2}}{{R}_{7}}}{\frac{1}{{R}_{3}} + \frac{1}{{R}_{4}} - \frac{1}{{R}_{7}} - \frac{1}{{R}_{6}}} \\ = \frac{1}{1 + \frac{{R}_{3}}{{R}_{4}} - \frac{{R}_{3}}{{R}_{7}} - \frac{{R}_{3}}{{R}_{6}}} {V}_{F 1} - \frac{1}{\frac{{R}_{7}}{{R}_{3}} + \frac{{R}_{7}}{{R}_{4}} - 1 - \frac{{R}_{7}}{{R}_{6}}} {V}_{F 2}\end{matrix} \qquad ( 100 )$$

From the equation (97), ΔV_{F} may be expressed as

$$Δ {V}_{F} = {V}_{F 1} - {V}_{F 2} = ( {R}_{7} - {R}_{3} ) {I}_{1} + ( \frac{{R}_{3}}{{R}_{4}} - \frac{{R}^{7}}{{R}_{8}} ) {V}_{A} \qquad ( 101 )$$

and the current i1 may be expressed as

$${I}_{1} = ( {I}_{2} = ) \frac{1}{{R}_{7} - {R}_{3}} Δ {V}_{F} - \frac{1}{{R}_{7} - {R}_{3}} ( \frac{{R}_{3}}{{R}_{4}} - \frac{{R}_{7}}{{R}_{8}} ) {V}_{A} \qquad ( 102 )$$

Thus, the reference voltages Vref1, Vref2 may be expressed by the sum of ΔV_{F} and the divided voltages of the diodes D1, D2, and may be found by:

$$\begin{matrix}\begin{matrix}{Vref}_{1} = {R}_{9} ( {I}_{1} + {I}_{2} ) + {R}_{7} ( {I}_{2} - \frac{{V}_{6}}{{R}_{8}} ) + \frac{{R}_{6}}{{R}_{5} + {R}_{6}} {V}_{F 2} \\ = \frac{2 {R}_{9} + {R}_{7}}{{R}_{7} {R}_{3}} Δ {V}_{F} - \{ \frac{2 {R}_{9} + {R}_{7}}{{R}_{7} - {R}_{3}} ( \frac{{R}_{3}}{{R}_{4}} - \frac{{R}_{7}}{{R}_{8}} ) + \frac{{R}_{7}}{{R}_{8}} \} \\ {V}_{A} + \frac{{R}_{6}}{{R}_{5} + {R}_{6}} {V}_{F 2} \\ = \frac{2 {R}_{9} + {R}_{7}}{{R}_{7} {R}_{3}} {V}_{F} + \{ \frac{2 {R}_{9} + {R}_{7}}{{R}_{7} - {R}_{3}} ( \frac{{R}_{3}}{{R}_{4}} - \frac{{R}_{7}}{{R}_{8}} ) + \frac{{R}_{7}}{{R}_{8}} \} \\ \frac{1}{1 + \frac{{R}_{3}}{{R}_{4}} - \frac{{R}_{3}}{{R}_{7}} + \frac{{R}_{3}}{{R}_{8}}} {V}_{F 1} + \\ [ \{ \frac{2 {R}_{9} + {R}_{7}}{{R}_{7} - {R}_{3}} ( \frac{{R}_{3}}{{R}_{4}} - \frac{{R}_{7}}{{R}_{8}} ) + \frac{{R}_{7}}{{R}_{3}} \} \\ \frac{1}{\frac{{R}_{7}}{{R}_{3}} + \frac{{R}_{7}}{{R}_{4}} - 1 - \frac{{R}_{7}}{{R}_{8}}} + \frac{{R}_{6}}{{R}_{5} + {R}_{6}} ] {V}_{F 2} \\ = {α}_{11} {V}_{F 1} + {α}_{12} {V}_{F 2} + {β}_{1} Δ {V}_{F}\end{matrix} \\ and & ( 103 ) \\ \begin{matrix}{Vref}_{2} = {R}_{9} ( {I}_{1} + {I}_{2} ) + {R}_{3} ( {I}_{1} - \frac{{V}_{A}}{{R}_{4}} ) + \frac{{R}_{2}}{{R}_{1} + {R}_{2}} {V}_{F 1} \\ = \frac{2 {R}_{9} + {R}_{3}}{{R}_{7} - {R}_{3}} Δ {V}_{F} - \{ \frac{2 {R}_{9} + {R}_{3}}{{R}_{7} - {R}_{3}} ( \frac{{R}_{3}}{{R}_{4}} - \frac{{R}_{7}}{{R}_{8}} ) + \frac{{R}_{3}}{{R}_{4}} \} \\ {V}_{A} + \frac{{R}_{2}}{{R}_{1} + {R}_{2}} {V}_{F 1} \\ = \frac{2 {R}_{9} + {R}_{3}}{{R}_{7} - {R}_{3}} Δ {V}_{F} - [ \{ \frac{2 {R}_{9} + {R}_{3}}{{R}_{7} - {R}_{3}} ( \frac{{R}_{3}}{{R}_{4}} - \frac{{R}_{7}}{{R}_{8}} ) + \frac{{R}_{3}}{{R}_{4}} \} \\ \frac{1}{1 + \frac{{R}_{3}}{{R}_{4}} - \frac{{R}_{3}}{{R}_{7}} - \frac{{R}_{3}}{{R}_{8}}} + \frac{{R}_{2}}{{R}_{1} + {R}_{2}} ] {V}_{F 1} + \\ \{ \frac{2 {R}_{9} + {R}_{3}}{{R}_{7} - {R}_{3}} ( \frac{{R}_{3}}{{R}_{4}} - \frac{{R}_{7}}{{R}_{8}} ) + \frac{{R}_{3}}{{R}_{4}} \} \frac{1}{\frac{{R}_{7}}{{R}_{3}} + \frac{{R}_{7}}{{R}_{4}} - 1 - \frac{{R}_{7}}{{R}_{8}}} {V}_{F 2} \\ = {α}_{21} {V}_{F 1} + {α}_{22} {V}_{F 2} + {β}_{2} Δ {V}_{F}\end{matrix} & ( 104 )\end{matrix}$$

It is noted that the equations (103), (104) are approximately equivalent to the equations (7) and (14).

That is, with the circuit of FIG. 41, the driving current supplied from the current mirror circuit is again the temperature-compensated current or the nearly temperature-compensated current.

With the circuit of FIG. 41, the driving current supplied from the current mirror circuit may be a current approximately proportional to temperature or the current proportional to absolute temperature (PTAT). Also, if the driving current has a slightly negative temperature characteristic, the current having a negative temperature characteristic flows through the resistor R8 and also through the resistor R4. Thus, if the current flowing through the diode D2 (and diode D1) has a positive temperature characteristic, the temperature characteristic of the voltage generated across the resistor R7 (and resistor R3) is positive, and the temperature characteristic of the divided voltage of the resistors R5 and R6 (and the divided voltage of the resistors R1 and R2) is negative. Thus, temperature compensation may be attained by summation with weights.

Hence, the temperature characteristics of the reference voltages Vref1 and Vref2, added by the voltage drop at the resistor R9, may be compensated in case the temperature characteristic of the voltage drop by the resistor R9 has substantially been compensated.

In actuality, ΔV_{F} may be expressed, like the equation (10), by

$$\begin{matrix}Δ {V}_{F} = {V}_{T} ln \{ \frac{N ( {I}_{1} - \frac{{V}_{F 1}}{{R}_{1} + {R}_{2}} - \frac{{V}_{A}}{{R}_{4}} )}{{I}_{2} - \frac{{V}_{F 2}}{{R}_{5} + {R}_{6}} - \frac{{V}_{A}}{{R}_{8}}} \} \\ = {V}_{T} ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \}\end{matrix} \qquad ( 105 )$$

Hence, in order for the reference voltages Vref1, Vref2 to be temperature-compensated voltages,

$$\begin{matrix}\begin{matrix}\frac{\partial {Vref}_{1}}{\partial T} = {α}_{11} \frac{\partial {V}_{F 1}}{\partial T} + {α}_{12} \frac{\partial {V}_{F 2}}{\partial T} + \\ {β}_{1} ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} \frac{\partial {V}_{T}}{\partial T} + \\ {β}_{1} {V}_{T} \frac{\partial }{\partial T} ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} \\ = {α}_{11} \frac{\partial {V}_{F 1}}{\partial T} + {α}_{12} \frac{\partial {V}_{F 2}}{\partial T} + \\ {β}_{1} ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} \frac{k}{q} + \\ {β}_{1} {V}_{T} \frac{\partial }{\partial T} ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} \\ \approx 0\end{matrix} \\ and & ( 106 ) \\ \begin{matrix}\frac{\partial {Vref}_{2}}{\partial T} = {α}_{21} \frac{\partial {V}_{F 1}}{\partial T} + {α}_{22} \frac{\partial {V}_{F 2}}{\partial T} + \\ {β}_{2} ln \{ \frac{N ( 1 - \frac{{V}_{F 1}}{( {R}_{1} + {R}_{2} ) {I}_{2}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} \frac{\partial {V}_{T}}{\partial T} + \\ {β}_{2} {V}_{T} \frac{\partial }{\partial T} ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} \frac{\partial {V}_{F 2}}{\partial T} + \\ {β}_{2} ln \{ \frac{N ( 1 - \frac{{V}_{F 1}}{( {R}_{1} + {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} \frac{k}{q} + \\ {β}_{2} {V}_{T} \frac{\partial }{\partial T} ln \{ \frac{N ( 1 - \frac{{V}_{F 1}}{( {R}_{1} {R}_{2} ) {I}_{1}} - \frac{{V}_{A}}{{R}_{4} {I}_{1}} )}{1 - \frac{{V}_{F 2}}{( {R}_{5} + {R}_{6} ) {I}_{1}} - \frac{{V}_{A}}{{R}_{8} {I}_{1}}} \} \\ \approx 0\end{matrix} & ( 107 )\end{matrix}$$

need to hold.

It is possible to enlarge the variable range, with temperature, of the value of the denominator in ln of the equation (105) as well as to render the anti-log of ln large or small at lower and higher temperatures, respectively. That is, by making the temperature characteristic of the product of this log value and V_{T}, that is, ΔV_{F}, a curved line, it is possible to compensate the temperature non-linearity proper to a diode more readily than with the Nagano's reference voltage circuit shown in FIG. 3.

Thus, to obtain the temperature-compensated reference voltages Vref1 and Vref2, the temperature characteristics of the driving currents I1 and I2 are set so as to cancel each other.

Hence, by summing divided voltages V_{CTAT1} and V_{CTAT2} of the forward voltages of the diodes, having a negative temperature coefficient, to V_{PTAT1} and V_{PTAT}, having a positive temperature coefficient, two temperature-compensated voltages may be obtained. These two temperature-compensated voltages may then be added by a temperature-compensated voltage VADD corresponding to a voltage drop by the resistor R6. It is thus possible to obtain a larger temperature-compensated reference voltage.

That is, the reference voltage Vref1 may be expressed by

Vref₁=α₁V_{F2}+β₁ΔV_{F}+V_{ADD}=V_{CTAT1}+V_{PTAT1}+V_{ADD} (108)

and the reference voltage Vref2 may be expressed by

Vref₂=α₂V_{F1}+β₂ΔV_{F}+V_{ADD}=V_{CTAT2}+V_{PTAT2}+V_{ADD} (109)

### EXAMPLE 11

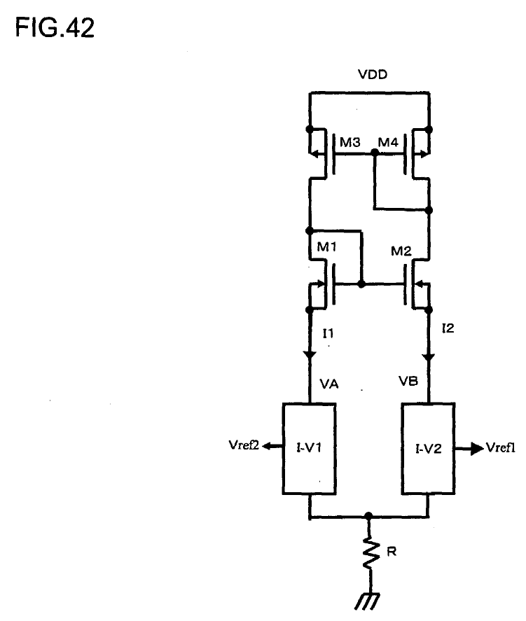

FIG. 42 depicts a diagram, partially shown in blocks, showing an arrangement of a reference voltage circuit according to claim 8 of the present application in a generalized form. In the Example for claim 8 of the present application (FIG. 35), described so far in detail, the OP amp (AP1) is used as control means for controlling preset voltages to be equal to each other. It is however possible to use a current mirror circuit, in place of the OP amp (AP1), as control means for controlling preset voltages to be equal to each other. Specifically, FIG. 35, showing a reference voltage circuit employing a basic OP amp as control means, in a block diagram, may be reformulated as shown in FIG. 42.

A reference voltage Vref1 is derived at a mid-point terminal of a second current-to-voltage converter (I-V2). Alternatively, depending on the particular circuit used, a reference voltage Vref2 may be derived from a mid-point terminal of a first current-to-voltage converter (I-V1).

In FIG. 42, the first current mirror circuit includes transistors M1 and M2, and the second current mirror circuit includes transistors M3 and M4. The transistors M1 and M4 have gates and drains connected in common, while the transistors M1 and M3 also have gates and drains connected in common. The transistors M1 and M3 are cascoded, while the transistors M2 and M4 are also cascoded.

The first current-to-voltage converter (I-V1) and the second current-to-voltage converter (I-V2) are connected to the sources of the transistors M1 and M2, respectively, and are grounded via common resistor R.

A reference voltage Vref1 is derived from a mid-point terminal of the second current-to-voltage converter (I-V2). Alternatively, depending on the particular circuit used, a reference voltage Vref2 may be derived from a mid-point terminal of the first current-to-voltage converter (I-V1).

In FIG. 42, the first current-to-voltage converter (I-V1) and the second current-to-voltage converter (I-V2) are grounded via a common resistor R. These circuits may also be grounded by respective different resistors.

The operation of the circuit of FIG. 42 is now described. Referring to FIG. 42, the first current mirror circuit includes the transistors M1 and M2, while the second current mirror circuit includes the transistors M3 and M4. The transistors M1 and M4 have gates and drains connected in common, and the two current mirror circuits share the same currents. That is, a current I1 flows through the transistors M1 and M3, while a current I2 flows through the transistors M2 and M4.

The first current-to-voltage converter (I-V1) and the second current-to-voltage converter (I-V2) are connected to sources of the transistors M1 and M2, and are grounded by a common resistor R. The two currents I1 and I2 are made equal to each other by the two current mirror circuits. When the currents I1 and I2 are equal to each other, the terminal voltages VA and VB become equal to each other.

A reference voltage Vref1 is derived from a mid-point terminal of the second current-to-voltage converter (I-V2). Depending on the particular circuit used, there are cases where a reference voltage Vref2 is derived from a mid-point terminal of the first current-to-voltage converter (I-V1).

### EXAMPLE 11-1

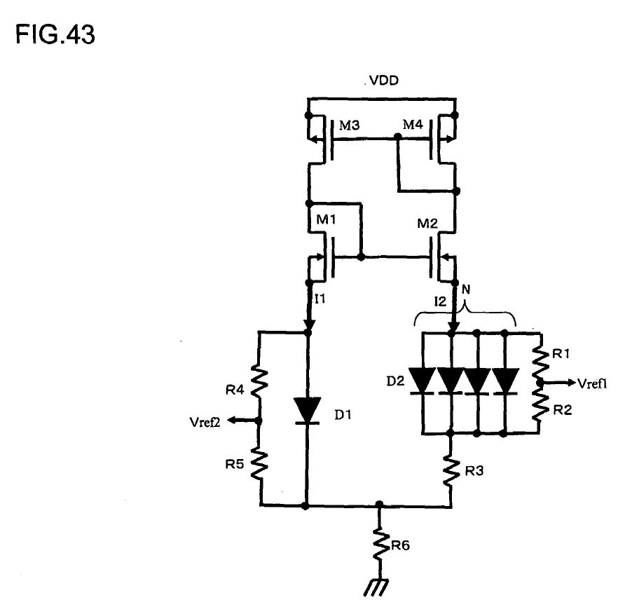

If, in the Example described with reference to FIG. 42, the first current-to-voltage converter (I-V1) and the second current-to-voltage converter (I-V2) are replaced by a first current-to-voltage converter (I-V1) and a second current-to-voltage converter (I-V2) of FIG. 36 that use the original OP amp as control means, respectively, there may be obtained a reference voltage circuit that uses a current mirror circuit in place of the OP amp to exercise control so that preset voltages will be equal to each other. The first current-to-voltage converter (I-V1) is now made up of a parallel connection of a diode D1 and series-connected resistors R4 and R5, while the second current-to-voltage converter (I-V2) includes a parallel connection of a plurality of diodes D2 and series-connected resistors R1 and R2, and a resistor R3 connected in series with the parallel connection of D2 and (R1, R2). FIG. 43 shows a specific implementing circuit.

The circuit of FIG. 43 uses current mirror circuits (M1, M2, M3 and M4) in substitution for the OP amp of FIG. 36. Referring to FIG. 43, p-channel MOS transistors M3 and M4 have sources connected to a power supply VDD and have gates connected in common. The p-channel MOS transistor M4 has a gate and a drain coupled together. To the drain of the p-channel MOS transistor M3 is connected the n-channel MOS transistor M1 that has a gate and a drain coupled together. To the drain of the p-channel MOS transistor M4 is connected the n-channel MOS transistor M2 that has a gate and a drain coupled together.

The first current-to-voltage converter (I-V1), including the parallel connection of the diode D1 and the resistors R4 and R5, is connected to the source of the n-channel MOS transistor M1. The second current-to-voltage converter (I-V2), including the parallel connection of the diodes D2 and the resistors R1 and R2 connected in series, and the resistor R3 connected in series with the parallel connection of D2 and (R1,R2), is connected to the source of the n-channel MOS transistor M2. The first and second current-to-voltage converters are grounded by a common resistor R6.

A mid-point terminal of the series-connected resistors R4 and R5 of the first current-to-voltage converter (I-V1) operates as an output terminal of the reference voltage Vref2, while a mid-point terminal of the series-connected resistors R1 and R2 of the second current-to-voltage converter (I-V2) operates as an output terminal of the reference voltage Vref1.

The operation of the circuit of FIG. 43 is now described. In FIG. 43, a common current I1 flows through the p-channel MOS transistor M3 and through the n-channel MOS transistor M1, while a common current I2 flows through the p-channel MOS transistor M4 and through the n-channel MOS transistor M2. The currents I1 and I2 are set so as to be equal to each other.

Thus, the first current-to-voltage converter (I-V1), including the parallel connection of the diode D1 and the series-connected resistors R4 and R5, is driven by the current I1, while the second current-to-voltage converter (I-V2), including the parallel connection of the diodes D2 and the series-connected resistors R1 and R2, and the resistor R3 connected in series with the parallel connection of D2 and (R1,R2), is driven by the current I2. The currents I1 and I2 flow to the ground via the common resistor R6.

When the currents I1 and I2 are equal to each other, a terminal voltage VA of the first current-to-voltage converter (I-V1), including the parallel connection of the diode D1 and the series-connected resistors R4 and R5, becomes equal to a terminal voltage VB of the second current-to-voltage converter (I-V2), including the parallel connection of the diodes D2 and the series-connected resistors R1 and R2 connected in series, and the resistor R3 connected in series with the parallel connection.

In this case, the mid-point terminal voltage of the series-connected resistors R4 and R5 of the first current-to-voltage converter (I-V1) is output as a desired reference voltage Vref2, while the mid-point terminal voltage of the series-connected resistors R1 and R2 of the second current-to-voltage converter (I-V2) is output as a desired reference voltage Vref1.

### EXAMPLE 11-2

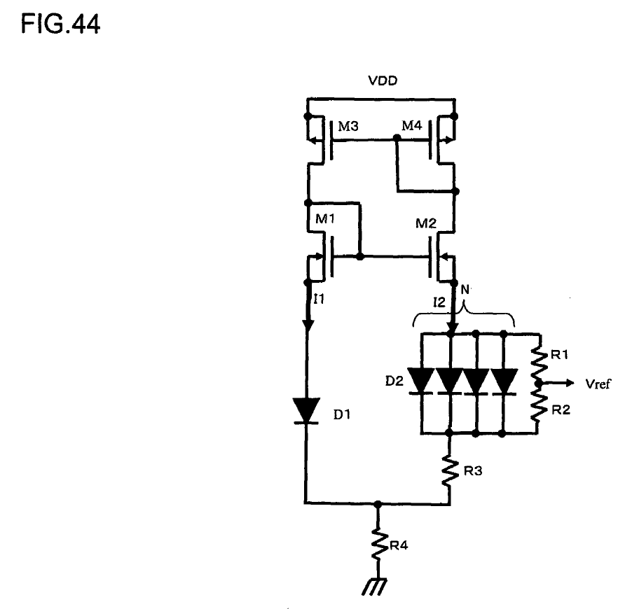

If, in the Example described with reference to FIG. 42, the first current-to-voltage converter (I-V1) and the second current-to-voltage converter (I-V2) are replaced by a first current-to-voltage converter (I-V1) and a second current-to-voltage converter (I-V2) of FIG. 37 that use the original OP amp as control means, respectively, there may be obtained a reference voltage circuit that uses a current mirror circuit in place of the OP amp to exercise control so that preset voltages will be equal to each other. It is noted that, in FIG. 37, the first current-to-voltage converter (I-V1) includes a diode D1, while the second current-to-voltage converter (I-V2) includes a parallel connection of a plurality of diodes D2 and series-connected resistors R1 and R2 and a resistor R3 connected in series with the parallel connection. FIG. 44 shows a specific implementing circuit.

The circuit of FIG. 44 uses current mirror circuits (M1, M2, M3 and M4) in substitution for the OP amp of FIG. 37. Referring to FIG. 44, p-channel MOS transistors M3 and M4 have sources connected to a power supply VDD and have gates connected in common. The p-channel MOS transistor M4 has a gate and a drain coupled together. To the drain of the p-channel MOS transistor M3 is connected the n-channel MOS transistor M1 that has a gate and a drain coupled together. To the drain of the p-channel MOS transistor M4 is connected the n-channel MOS transistor M2.

The first current-to-voltage converter (I-V1), including the diode D1, is connected to the source of the n-channel MOS transistor M1. The second current-to-voltage converter (I-V2), including the parallel connection of the diodes D2 and series-connected resistors R1 and R2, and the resistor R3 connected in series with the parallel connection of D2 and (R1,R2), is connected to the source of the n-channel MOS transistor M2. The first and second current-to-voltage converters are grounded by a common resistor R4.

A mid-point terminal of the series-connected resistors R1 and R2 of the second current-to-voltage converter (I-V2) operates as an output terminal of the reference voltage Vref2.

The operation of the circuit of FIG. 44 is now described. In FIG. 44, a common current I1 flows through the p-channel MOS transistor M3 and through the n-channel MOS transistor M1, while a common current I2 flows through the p-channel MOS transistor M4 and through the n-channel MOS transistor M2. The currents I1 and I2 are set so as to be equal to each other. Thus, the first current-to-voltage converter (I-V1), including the diode D1, is driven by the current I1, while the second current-to-voltage converter (I-V2), including the parallel connection of the diodes D2 and the resistors R1 and R2 connected in series, and the resistor R3 connected in series with the parallel connection, is driven by the current I2. The currents I1 and I2 flow to the ground via the common resistor R4.

When the currents I1 and I2 are equal to each other, a terminal voltage VA of the first current-to-voltage converter (I-V1), including the diode D1, becomes equal to a terminal voltage VB of the second current-to-voltage converter (I-V2), including the parallel connection of the diodes D2 and the resistors R1 and R2 connected in series, and the resistor R3 connected in series with the parallel connection.

In this case, the mid-point terminal voltage of the series-connected resistors R1 and R2 of the first current-to-voltage converter (I-V2) is output as a desired reference voltage Vref.

### EXAMPLE 11-3

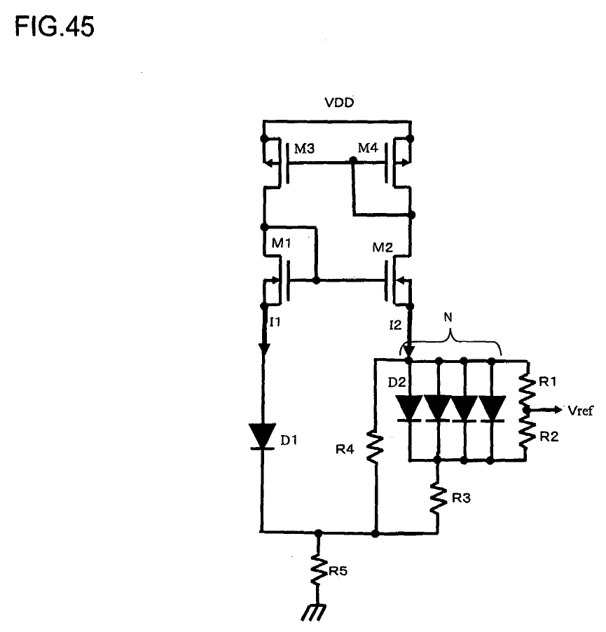

If, in the Example described with reference to FIG. 42, the first current-to-voltage converter (I-V1) and the second current-to-voltage converter (I-V2) are replaced by a first current-to-voltage converter (I-V1) and a second current-to-voltage converter (I-V2) of FIG. 38 that use the original OP amp as control means, respectively, there may be obtained a reference voltage circuit that uses a current mirror circuit in place of the OP amp to exercise control so that preset voltages will be equal to each other. It is noted that, in FIG. 38, the first current-to-voltage converter (I-V1) includes a diode D1, while the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 45 shows a specific implementing circuit.

The circuit of FIG. 45 uses current mirror circuits (M1, M2, M3 and M4) of FIG. 42 in substitution for the OP amp of FIG. 38. Referring to FIG. 45, p-channel MOS transistors M3 and M4 have sources connected to a power supply VDD and have gates connected in common. The p-channel MOS transistor M4 has a gate and a drain coupled together. To the drain of the p-channel MOS transistor M3 is connected the n-channel MOS transistor M1 that has a gate and a drain coupled together. The n-channel MOS transistor M2 is connected to the drain of the p-channel MOS transistor M4 that has a gate and a drain coupled together.

The first current-to-voltage converter (I-V1), including the diode D1, is connected to the source of the n-channel MOS transistor M1. The second current-to-voltage converter (I-V2), including the parallel connection of the a plurality of diodes D2 and the series-connected resistors R1 and R2, the resistor R3 connected in series with the parallel connection of D2 and (R1,R2), and the resistor R4 connected in parallel with the series connection of R3 and the parallel connection of D2 and (R1,R2), is connected to the source of the n-channel MOS transistor M2. The first and second current-to-voltage converters are grounded by a common resistor R6.

A mid-point terminal of the series-connected resistors R1 and R2 of the second current-to-voltage converter (I-V2) operates as an output terminal of the reference voltage Vref.

The operation of the circuit of FIG. 45 is now described. In FIG. 45, a common current I1 flows through the p-channel MOS transistor M3 and through the n-channel MOS transistor M1, while a common current I2 flows through the p-channel MOS transistor M4 and through the n-channel MOS transistor M2. The currents I1 and I2 are set so as to be equal to each other. Thus, the first current-to-voltage converter (I-V1), including the diode D1, is driven by the current I1, while the second current-to-voltage converter (I-V2), including the parallel connection of the a plurality of diodes D2 and the series-connected resistors R1 and R2, the resistor R3 connected in series with the parallel connection and the resistor R4 connected in parallel with the series connection, is driven by the current I2. The currents I1 and I2 flow to the ground via the common resistor R6.

When the currents I1 and I2 are equal to each other, a terminal voltage VA of the first current-to-voltage converter (I-V1), including the diode D1, becomes equal to a terminal voltage VB of the second current-to-voltage converter (I-V2), including the parallel connection of the a plurality of diodes D2 and the series-connected resistors R1 and R2, the resistor R3 connected in series with the parallel connection and the resistor R4 connected in parallel with the series connection.

In this case, the mid-point terminal voltage of the series-connected resistors R1 and R2 of the second current-to-voltage converter (I-V2) is output as a desired reference voltage Vref.

### EXAMPLE 11-4

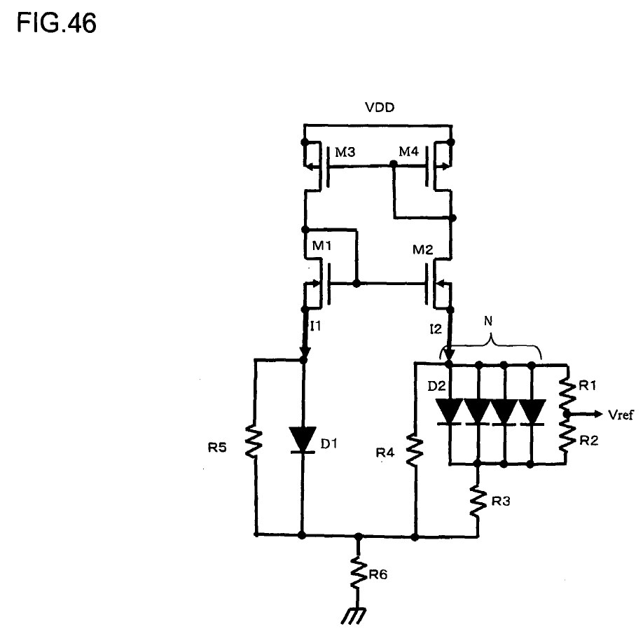

If, in the Example described with reference to FIG. 42, the first current-to-voltage converter (I-V1) and the second current-to-voltage converter (I-V2) are replaced by a first current-to-voltage converter (I-V1) and a second current-to-voltage converter (I-V2) of FIG. 39 that use the original OP amp as control means, respectively, there may be obtained a reference voltage circuit that uses a current mirror circuit in place of the OP amp to exercise control so that preset voltages will be equal to each other. In FIG. 39, the first current-to-voltage converter (I-V1) includes a parallel connection of a diode D1 and a resistor R5, while the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 46 shows a specific implementing circuit.

The circuit of FIG. 46 uses current mirror circuits (M1, M2, M3 and M4) of FIG. 42 in substitution for the OP amp of FIG. 39. Referring to FIG. 46, p-channel MOS transistors M3, M4 have sources connected to a power supply VDD and have gates connected in common. The p-channel MOS transistor M4 has a gate and a drain coupled together. To the drain of the p-channel MOS transistor M3 is connected the n-channel MOS transistor M1 that has a gate and a drain coupled together. The n-channel MOS transistor M2 is connected to the drain of the p-channel MOS transistor M4 that has a gate and a drain coupled together.

The first current-to-voltage converter (I-V1), including the parallel connection of the diode D1 and the resistor R5, is connected to the source of the n-channel MOS transistor M1.

The second current-to-voltage converter (I-V2), including the parallel connection of the a plurality of diodes D2 and the series-connected resistors R1 and R2, the resistor R3 connected in series with the parallel connection of D2 and (R1,R2), and the resistor R4 connected in parallel with the series connection, is connected to the source of the n-channel MOS transistor M2.

The first current-to-voltage converter (I-V1) and the second current-to-voltage converters (I-V2) are grounded by a common resistor R6.

A mid-point terminal of the series-connected resistors R1 and R2 of the second current-to-voltage converter (I-V2) operates as an output terminal of the reference voltage Vref.

The operation of the circuit of FIG. 46 is now described. In FIG. 46, a common current I1 flows through the p-channel MOS transistor M3 and through the n-channel MOS transistor M1, while a common current I2 flows through the p-channel MOS transistor M4 and through the n-channel MOS transistor M2. The currents I1 and I2 are set so as to be equal to each other.

Thus, the first current-to-voltage converter (I-V1), including the parallel connection of the diode D1 and the resistor R5, is driven by the current I1, while the second current-to-voltage converter (I-V2), including the parallel connection of the diodes D2 and the series-connected resistors R1 and R2, the resistor R3 connected in series with the parallel connection and the resistor R4 connected in parallel with the series connection, is driven by the current I2. The currents I1 and I2 flow to the ground via the common resistor R6.

When the currents I1 and I2 are equal to each other, a terminal voltage VA of the first current-to-voltage converter (I-V1), including the parallel connection of the diode D1 and the resistor R5, becomes equal to a terminal voltage VB of the second current-to-voltage converter (I-V2), including the parallel connection of the diodes D2 and the series-connected resistors R1 and R2, the resistor R3 connected in series with the parallel connection and the resistor R4 connected in parallel with the series connection.

In this case, the mid-point terminal voltage of the series-connected resistors R1 and R2 of the second current-to-voltage converter (I-V2) is output as a desired reference voltage Vref.

### EXAMPLE 11-5

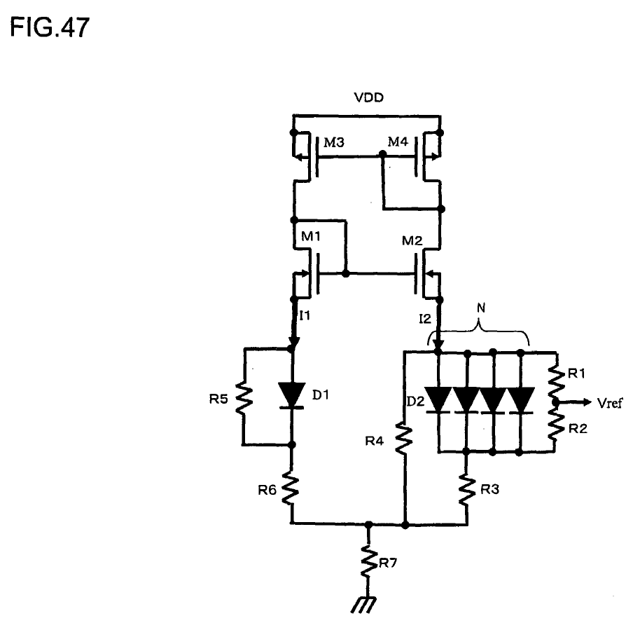

If, in the Example described with reference to FIG. 42, the first current-to-voltage converter (I-V1) and the second current-to-voltage converter (I-V2) are replaced by a first current-to-voltage converter (I-V1) and a second current-to-voltage converter (I-V2) of FIG. 40 that use the original OP amp as control means, respectively, there may be obtained a reference voltage circuit that uses a current mirror circuit in place of the OP amp to exercise control so that preset voltages will be equal to each other. In FIG. 40, the first current-to-voltage converter (I-V1) includes a parallel connection of a diode D1 and a resistor R5 and a resistor R6 connected in series with the parallel connection, while the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 47 shows a specific implementing circuit.

The circuit of FIG. 47 uses current mirror circuits (M1, M2, M3 and M4) of FIG. 42 in substitution for the OP amp (AP1) of FIG. 40. Referring to FIG. 47, p-channel MOS transistors M3, M4 have sources connected to a power supply VDD and have gates connected in common. The p-channel MOS transistor M4 has a gate and a drain coupled together. To the drain of the p-channel MOS transistor M3 is connected the n-channel MOS transistor M1 that has a gate and a drain coupled together. The n-channel MOS transistor M2 is connected to the drain of the p-channel MOS transistor M4 that has a gate and a drain coupled together.

The first current-to-voltage converter (I-V1), including a parallel connection of the diode D1 and the resistor R5 and the resistor R6 connected in series with the parallel connection, is connected to the source of the n-channel MOS transistor M1. The second current-to-voltage converter (I-V2), including the parallel connection of the a plurality of diodes D2 and the series-connected resistors R1 and R2, the resistor R3 connected in series with the parallel connection of D2 and (R1,R2), and the resistor R4 connected in parallel with the series connection of R3 and the parallel connection of D2 and (R1,R2), is connected to the source of the n-channel MOS transistor M2. The first current-to-voltage converter (I-V1) and the second current-to-voltage converters (I-V2) are grounded by a common resistor R7.

A mid-point terminal of the series-connected resistors R1 and R2 of the second current-to-voltage converter (I-V2) operates as an output terminal of the reference voltage Vref.

The operation of the circuit of FIG. 47 is now described. In FIG. 47, a common current I1 flows through the p-channel MOS transistor M3 and through the n-channel MOS transistor M1, while a common current I2 flows through the p-channel MOS transistor M4 and through the n-channel MOS transistor M2. The currents I1 and I2 are set so as to be equal to each other. Thus, the first current-to-voltage converter (I-V1), including the parallel connection of the diode D1 and the resistor R5 and the resistor R6 connected in series with the parallel connection, is driven by the current I1, while the second current-to-voltage converter (I-V2), including the parallel connection of a plurality of diodes D2 and the series-connected resistors R1 and R2, the resistor R3 connected in series with the parallel connection and the resistor R4 connected in parallel with the series connection, is driven by the current I2. The currents I1 and I2 flow to the ground via the common resistor R7.

When the currents I1 and I2 are equal to each other, a terminal voltage VA of the first current-to-voltage converter (I-V1), including the parallel connection of the diode D1 and the resistor R5 and the resistor R6 connected in series with the parallel connection, becomes equal to a terminal voltage VB of the second current-to-voltage converter (I-V2), including the parallel connection of the diodes D2 and the series-connected resistors R1 and R2, the resistor R3 connected in series with the parallel connection and the resistor R4 connected in parallel with the series connection. In this case, the mid-point terminal voltage of the series-connected resistors R1 and R2 of the second current-to-voltage converter (I-V2) is output as a desired reference voltage Vref.

### EXAMPLE 11-6

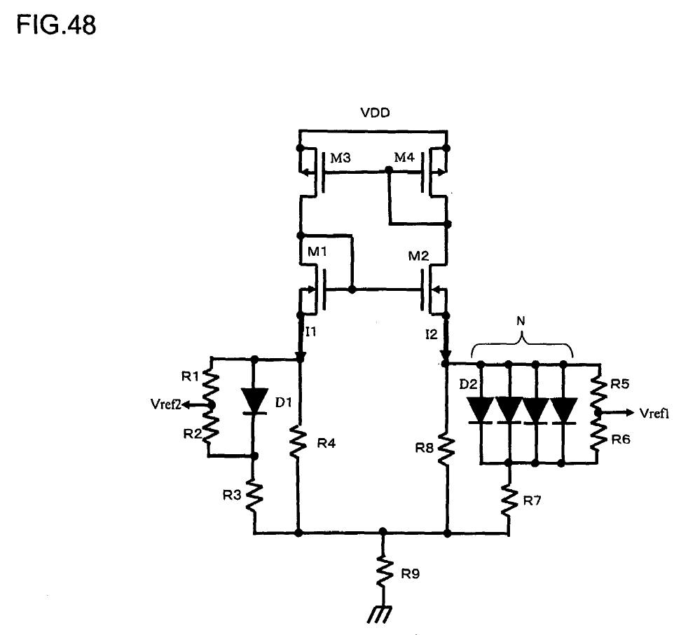

If, in the Example described with reference to FIG. 42, the first current-to-voltage converter (I-V1) and the second current-to-voltage converter (I-V2) are respectively replaced by a first current-to-voltage converter (I-V1) and a second current-to-voltage converter (I-V2) of FIG. 41 that use the original OP amp as control means, there may be obtained a reference voltage circuit that uses a current mirror circuit in place of the OP amp to exercise control so that preset voltages will be equal to each other. It is noted that, in FIG. 4 1, the first current-to-voltage converter (I-V1) includes a parallel connection of a diode D1 and series-connected resistors R1 and R2, a resistor R3 connected in series with the parallel connection and a resistor R4 connected in parallel with the series connection, while the second current-to-voltage converter (I-V2) includes a parallel connection of a plurality of diodes D2 and series-connected resistors R1 and R2, a resistor R7 connected in series with the parallel connection and a resistor R8 connected in parallel with the series connection. FIG. 48 shows a specific implementing circuit.

The circuit of FIG. 48 uses current mirror circuits (M1, M2, M3 and M4) of FIG. 42 in substitution for the OP amp of FIG. 41. Referring to FIG. 48, the p-channel MOS transistors M3 and M4 have sources connected to a power supply VDD and have gates connected in common. The p-channel MOS transistor M4 has a gate and a drain coupled together. To the drain of the p-channel MOS transistor M3 is connected the n-channel MOS transistor M1 that has a gate and a drain coupled together. The n-channel MOS transistor M2 is connected to the drain of the p-channel MOS transistor M4 that has a gate and a drain coupled together.

The first current-to-voltage converter (I-V1), including the parallel connection of the diode D1 and the series-connected resistors R1 and R2, the resistor R3 connected in series with the parallel connection and the resistor R4 connected in parallel with the series connection, is connected between the source of the n-channel MOS transistor M1 and the ground. The second current-to-voltage converter (I-V2), including the parallel connection of the diodes D2 and series-connected resistors R5 and R6, the resistor R7 connected in series with the parallel connection of D2 and (R5, R6) and the resistor R8 connected in parallel with the series connection of R7 and the parallel connection of D2 and (R5, R6), is connected to the source of the n-channel MOS transistor M2. The first current-to-voltage converter (I-V1) and the second current-to-voltage converters (I-V2) are grounded by a common resistor R9.

A mid-point terminal of the series-connected resistors R1 and R2 of the first current-to-voltage converter (I-V1) operates as an output terminal of the reference voltage Vref2, while a mid-point terminal of the series-connected resistors R5 and R6 of the second current-to-voltage converter (I-V2) operates as an output terminal of the reference voltage Vref1.

The operation of the circuit of FIG. 48 is now described. In FIG. 48, a common current I1 flows through the p-channel MOS transistor M3 and through the n-channel MOS transistor M1, while a common current I2 flows through the p-channel MOS transistor M4 and through the n-channel MOS transistor M2. The currents I1 and I2 are set so as to be equal to each other. Thus, the first current-to-voltage converter (I-V1), including the parallel connection of the diode D1 and the series-connected resistors R1 and R2, the resistor R3 connected in series with the parallel connection and the resistor R4 connected in parallel with the series connection, is driven by the current I1, while the second current-to-voltage converter (I-V2), including the parallel connection of the diodes D2 and the series-connected resistors R5 and R6, the resistor R7 connected in series with the parallel connection and the resistor R8 connected in parallel with the series connection, is driven by the current I2. The currents I1 and I2 flow to the ground via the common resistor R9.

When the currents I1 and I2 are equal to each other, a terminal voltage VA of the first current-to-voltage converter (I-V1), including the parallel connection of the diode D1 and the series-connected resistors R1 and R2, the resistor R3 connected in series with the parallel connection and the resistor R4 connected in parallel with the series connection, becomes equal to a terminal voltage VB of the second current-to-voltage converter (I-V2), including the parallel connection of the diodes D2 and the series-connected resistors R5 and R6, the resistor R7 connected in series with the parallel connection and the resistor R8 connected in parallel with the series connection.

In this case, a mid-point terminal voltage of the series-connected resistors R1 and R2 of the first current-to-voltage converter (I-V1) is output as a desired reference voltage Vref2, while a mid-point terminal voltage of the series-connected resistors R5 and R6 of the second current-to-voltage converter (I-V2) is output as a desired reference voltage Vref1

### EXAMPLE 12

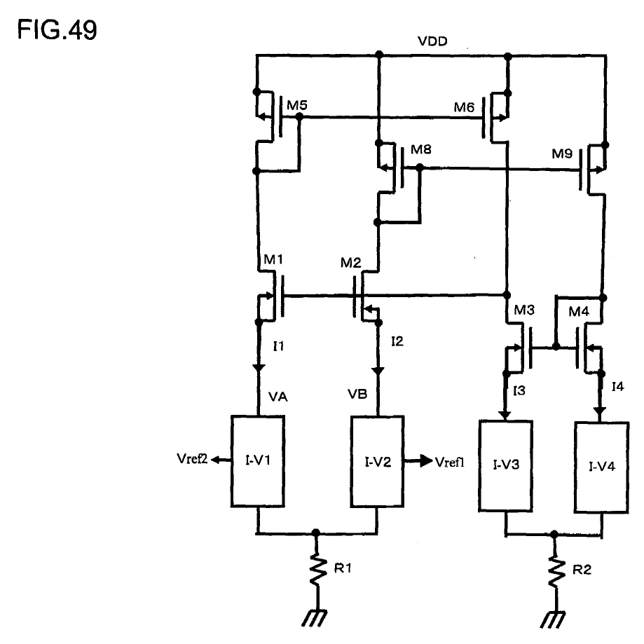

FIG. 49 depicts a diagram, partially shown in blocks, showing an arrangement of a reference voltage circuit according to claim 9 of the present application in a generalized form. In the Example for claim 8 of the present application (FIG. 35), described so far in detail, the OP amp (AP1) is used as control means for controlling preset voltages to be equal to each other. It is however possible to use a current mirror circuit for this purpose in place of the OP amp (AP1). Specifically, FIG. 35, showing a reference voltage circuit employing a basic OP amp as control means, in a block diagram, may be reformulated as shown in FIG. 49.

It should be noted that selecting the first current-to-voltage converter (I-V1) with a smaller number of diodes as the current-to-voltage converter (I-V) in the control circuit as in FIG. 49 is in meeting with the objective of reducing the chip area. However, selection of the second current-to-voltage converter (I-V2) with a larger number of the diodes gives the same favorable effect insofar as the circuit operation is concerned.

A reference voltage Vref1 may be obtained from the mid-point terminal of the second current-to-voltage converter (I-V2) as well. Alternatively, depending on the particular circuit used, a reference voltage Vref2 may be derived from the mid-point terminal of the first current-to-voltage converter (I-V1).

It should be noted that, in FIG. 49, the first current-to-voltage converter (I-V1) and the second current-to-voltage converter (I-V2) are grounded by a common resistor R1, while the third current-to-voltage converter (I-V3) and the fourth current-to-voltage converter (I-V4) are grounded by a common resistor R2. Alternatively, the first to fourth current-to-voltage converters (IV-1) to (IV-4) may be grounded by a sole common resistor R.

In FIG. 49, the first current mirror circuit includes n-channel MOS transistors M1 and M2, while the second current mirror circuit includes n-channel MOS transistors M3 and M4. The third current mirror circuit includes p-channel MOS transistors M5 and M6, while the fourth current mirror circuit includes p-channel MOS transistors M7 and M8.

The transistors M5 and M7 have gates and drains connected in common. The transistors M1 and M5 are cascoded, while the transistors M2 and M7 are also cascoded.

The first current-to-voltage converter (I-V1) and the second current-to-voltage converter (I-V2) are connected to the sources of the transistors M1 and M2, respectively, and are grounded via common resistor R1.

The transistor M4 has a gate and a source coupled together, and is connected to the drain of the transistor M8. The transistor M3 has a drain connected to coupled gates of the transistors M1 and M2, and is connected to the drain of the transistor M6.

The third current-to-voltage converter (I-V3) and the fourth current-to-voltage converter (I-V4) are respectively connected to the sources of the transistors M3 and M4, and are grounded via a common resistor R2. It is proper to use a circuit equivalent to the first current-to-voltage converter (I-V1) or the second current-to-voltage converter (I-V2) as the third current-to-voltage converter or the fourth current-to-voltage converter.

A mid-point voltage of the first current-to-voltage converter (I-V1) and a mid-point voltage of the second current-to-voltage converter (I-V2) are output as reference voltages Vref2 and reference voltage Vref1, respectively.

The operation of the circuit of FIG. 49 is now described. In FIG. 49, a common current I1 flows through the transistors M1 and M5 to cause an equal current I2 to flow through the transistor M3 via the third current mirror circuit.

The second current mirror circuit operates as a current subtraction circuit and controls the first current mirror circuit depending on the large-small relationship of I2 and I1 to cause the two currents I2 and I1 to be equal to each other (I2=I1).

In this case, a terminal voltage VA of the first current-to-voltage converter (I-V1) becomes equal to a terminal voltage VB of the second current-to-voltage converter (I-V2). A reference voltage Vref1 may be obtained at this time from the mid-point terminal of the second current-to-voltage converter (I-V2) as well. Depending on the particular circuit used, a reference voltage Vref2 may be derived from a mid-point terminal of the first current-to-voltage converter (I-V1).

### EXAMPLE 12-1

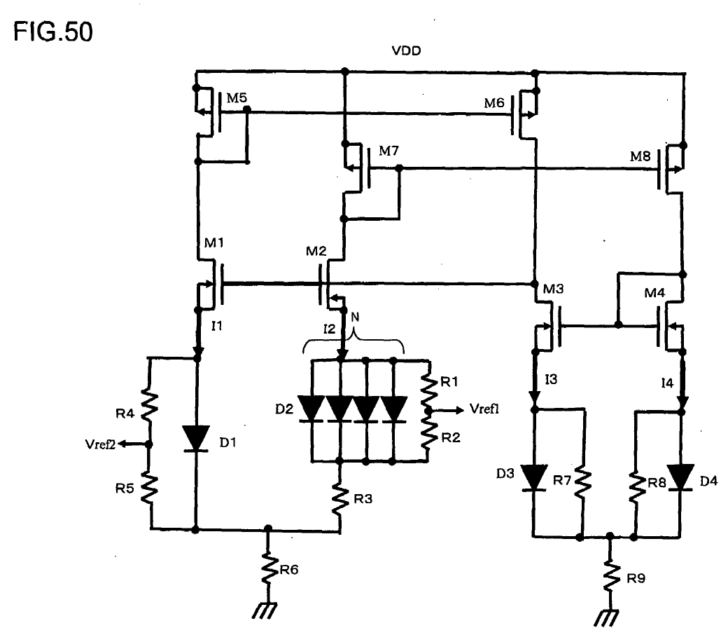

If, in the Example described with reference to FIG. 49, the first current-to-voltage converter (I-V1) and the second current-to-voltage converter (I-V2) arc replaced by a first current-to-voltage converter (I-V1) and a second current-to-voltage converter (I-V2) of FIG. 36 that use the original OP amp as control means, respectively, there may be obtained a reference voltage circuit that uses a current mirror circuit in place of the OP amp to exercise control so that preset voltages will be equal to each other. It is noted that, in FIG. 36, the first current-to-voltage converter (I-V1) includes a parallel connection of a diode D1 and series-connected resistors R4 and R5, while the second current-to-voltage converter (I-V2) includes a parallel connection of a plurality of diodes D2 and series-connected resistors R1 and R2 and a resistor R3 connected in series with the parallel connection. FIG. 50 shows a specific implementing circuit.

The circuit of FIG. 50 uses four current mirror circuits (M1, M2; M3, M4: M5, M6; M7, M8) of FIG. 49 in substitution for the OP amp of FIG. 36. Referring to FIG. 50, p-channel MOS transistors M5, M6; M7, M8 have sources connected to a power supply VDD and have gates connected in common. The p-channel MOS transistor M5 has a gate and a drain coupled together, while the p-channel MOS transistor M7 has a gate and a drain coupled together. To the drain of the p-channel MOS transistor M6 is connected the drain of the n-channel MOS transistor M3. To the drain of the p-channel MOS transistor M8 is connected the n-channel MOS transistor M4 that has a gate and a drain coupled together. The drain of the n-channel MOS transistor M3 is connected to coupled gates of the n-channel MOS transistors M1 and M2.

The first current-to-voltage converter (I-V1), including the parallel connection of the diode D1 and the series-connected resistors R4 and R5, is connected to the source of the n-channel MOS transistor M1. The second current-to-voltage converter (I-V2), including the parallel connection of the a plurality of diodes D2 and the series-connected resistors R1 and R2, and the resistor R3 connected in series with the parallel connection, is connected to the source of the n-channel MOS transistor M2. The first current-to-voltage converter (I-V1) and the second current-to-voltage converters (I-V2) are grounded by a common resistor R6.

A third current-to-voltage converter (I-V3), including a parallel connection of a diode D3 and a resistor R7, is connected to the source of the n-channel MOS transistor M3. A fourth current-to-voltage converters (I-V4), including a parallel connection of a diode D4 and a resistor R8, is connected to the source of the n-channel MOS transistor M4. The third current-to-voltage converter (I-V3) and the fourth current-to-voltage converters (I-V4) are grounded by a common resistor R9.

A mid-point terminal of the series-connected resistors R1 and R2 of the first current-to-voltage converter (I-V1) operates as an output terminal of the reference voltage Vref1, while a mid-point terminal of the series-connected resistors R4 and R5 of the second current-to-voltage converter (I-V2) operates as an output terminal of the reference voltage Vref2.

The operation of the circuit of FIG. 50 is now described: In FIG. 50, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit.

A common current I2 flows through the p-channel MOS transistor M7 and the n-channel MOS transistor M2 to cause an equal current I4 to flow through the n-channel MOS transistor M4 via the p-channel MOS transistor M8 of the fourth current mirror circuit.

The second current mirror circuit operates as a current subtraction circuit (M3, M4) and controls the coupled gates of the n-channel MOS transistors M1 and M2 of the first current mirror circuit, depending on the large-small relationship of I2 and I1, to cause the two currents I2 and I1 to be equal to each other (I2=I1). Hence, the currents I1 and I2 arc set so as to be equal to each other. In this case, the first current-to-voltage converter (I-V1), including the parallel connection of the diode D1 and the resistor R4, is driven by the current I1. The second current-to-voltage converter (I-V2), including the parallel connection of the diodes D2 and series-connected resistors R1 and R2, and the resistor R3 connected in series with the parallel connection, is driven by the current I2.

If the currents I1 and I2 are equal to each other, a terminal voltage VA of the first current-to-voltage converter (I-V1) becomes equal to a terminal voltage VB of the second current-to-voltage converter (I-V2). The first current-to-voltage converter includes the parallel connection of the diode D1 and the resistor R4, while the second current-to-voltage converter includes the parallel connection of the diodes D2 and series-connected resistors R1 and R2, and the resistor R3 connected in series with the parallel connection, as described above.

In this case, the mid-point terminal of the series-connected resistors R1 and R2 of the second current-to-voltage converter (I-V2) and the mid-point terminal of the series-connected resistors R4 and R5 of the first current-to-voltage converter (I-V1) respectively output desired reference voltages Vref1 and Vref2.

### EXAMPLE 12-2

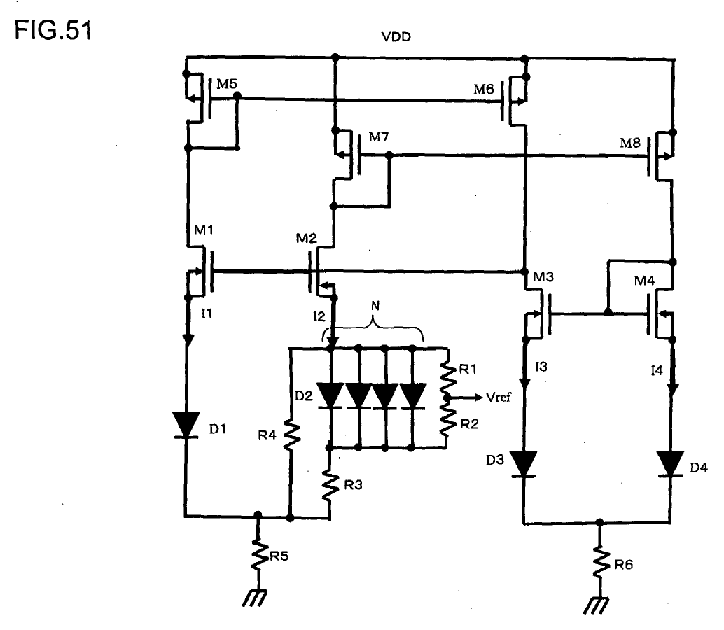

If, in the Example described with reference to FIG. 49, the first current-to-voltage converter (I-V1) and the second current-to-voltage converter (I-V2) are replaced by a first current-to-voltage converter (I-V1) and a second current-to-voltage converter (I-V2) of FIG. 37 that use the original OP amp as control means, respectively, a reference voltage circuit may be obtained which uses a current mirror circuit in place of the OP amp to exercise control so that preset voltages will be equal to each other. It is noted that, in FIG. 37, the first current-to-voltage converter (I-V1) includes a diode D1, while the second current-to-voltage converter (I-V2) includes a parallel connection of a plurality of diodes D2 and series-connected resistors R1 and R2 and a resistor R3 connected in series with the parallel connection. FIG. 51 shows a specific implementing circuit.

The circuit of FIG. 51 uses four current mirror circuits (M1, M2; M3, M4: M5, M6; M7, M8) of FIG. 49 in substitution for the OP amp of FIG. 37. Referring to FIG. 51, p-channel MOS transistors M5, M6; M7, M8 have sources connected to a power supply VDD and have gates connected in common. The p-channel MOS transistor M5 has a gate and a drain coupled together, and the p-channel MOS transistor M7 also has a gate and a drain coupled together. To the drain of the p-channel MOS transistor M6 is connected the drain of the n-channel MOS transistor M3. To the drain of the p-channel MOS transistor M8 is connected the n-channel MOS transistor M4 that has a gate and a drain coupled together. The drain of the n-channel MOS transistor M3 is connected to the coupled gates of the n-channel MOS transistors M1 and M2.

The first current-to-voltage converter (I-V1), including the diode D1, is connected to the source of the n-channel MOS transistor M1. The second current-to-voltage converter (I-V2), including the parallel connection of the diodes D2 and the series-connected resistors R1 and R2, and the resistor R3 connected in series with the parallel connection, is connected to the source of the n-channel MOS transistor M2. The first current-to-voltage converter (I-V1) and the second current-to-voltage converters (I-V2) are grounded by a common resistor R4.

A third current-to-voltage converter (I-V3), including a diode D3, is connected to the source of the n-channel MOS transistor M3. A fourth current-to-voltage converters (I-V4), including a diode D4, is connected to the source of the n-channel MOS transistor M4. The third current-to-voltage converter (I-V3) and the fourth current-to-voltage converters (I-V4) are grounded by a common resistor R5.

A mid-point terminal of the series-connected resistors R1 and R2 of the second current-to-voltage converter (I-V2) operates as an output terminal of the reference voltage Vref.

The operation of the circuit of FIG. 51 is now described. In FIG. 51, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit. A common current I2 flows through the p-channel MOS transistor M7 and the n-channel MOS transistor M2 to cause an equal current I4 to flow through the n-channel MOS transistor M4 via the p-channel MOS transistor M8 of the fourth current mirror circuit. The second current mirror circuit operates as a current subtraction circuit and controls the coupled gates of the n-channel MOS transistors M1 and M2 of the first current mirror circuit depending on the large-small relationship of I2 and I1 to cause the two currents I2 and I1 to be equal to each other (I2=I1).

Hence, the currents I1 and I2 are set so as to be equal to each other. In this case, the first current-to-voltage converter (I-V1), including the diode D1, is driven by the current I1. The second current-to-voltage converter (I-V2), including the parallel connection of the diodes D2 and series-connected resistors R1 and R2, and the resistor R3 connected in series with the parallel connection, is driven by the current I2.

If the currents I1 and I2 are equal to each other, a terminal voltage VA of the first current-to-voltage converter (I-V1) becomes equal to a terminal voltage VB of the second current-to-voltage converter (I-V2). In this case, a mid-point terminal of the series-connected resistors R1 and R2 of the second current-to-voltage converter (I-V2) outputs a desired reference voltage Vref.

### EXAMPLE 12-3

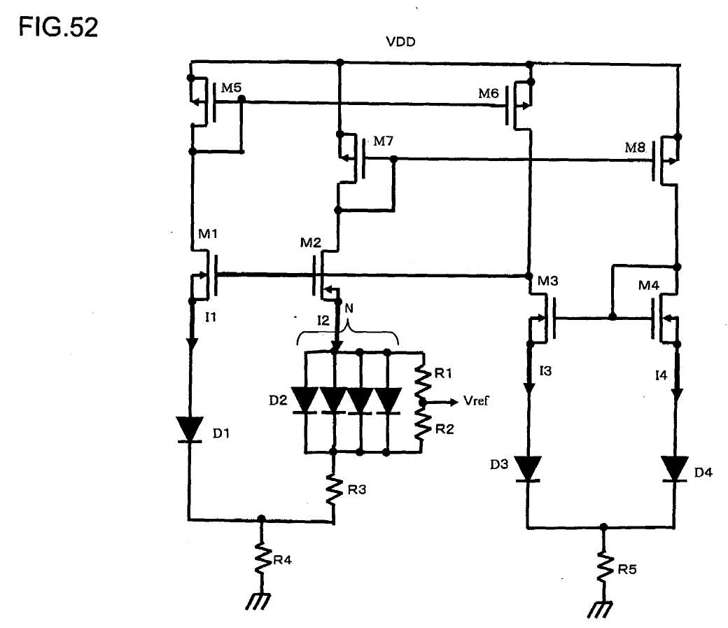

If, in the Example described with reference to FIG. 49, the first current-to-voltage converter (I-V1) and the second current-to-voltage converter (I-V2) are replaced by a first current-to-voltage converter (I-V1) and a second current-to-voltage converter (I-V2) of FIG. 38 that use the original OP amp as control means, respectively, a reference voltage circuit may be obtained which uses a current mirror circuit in place of the OP amp to exercise control so that preset voltages will be equal to each other. It is noted that, in FIG. 38, the first current-to-voltage converter (I-V1) includes a diode D1, while the second current-to-voltage converter (I-V2) includes a parallel connection of a plurality of diodes D2 and series-connected resistors R1 and R2, a resistor R3 connected in series with the parallel connection and the resistor R4 connected in parallel with the series connection. FIG. 52 shows a specific implementing circuit.

The circuit of FIG. 52 uses four current mirror circuits (M1, M2; M3, M4: M5, M6; M7, M8) of FIG. 49 in substitution for the OP amp of FIG. 38. Referring to FIG. 52, p-channel MOS transistors M5, M6; M7, M8 have sources connected to a power supply VDD and have gates connected in common. The p-channel MOS transistor M5 has a gate and a drain coupled together, and the p-channel MOS transistor M7 has a gate and a drain coupled together. To the drain of the p-channel MOS transistor M6 is connected the drain of the n-channel MOS transistor M3. To the drain of the p-channel MOS transistor M8 is connected the n-channel MOS transistor M4 that has a gate and a drain coupled together. The drain of the n-channel MOS transistor M3 is connected to coupled gates of the n-channel MOS transistors M1 and M2.

The first current-to-voltage converter (I-V1), including the diode D1, is connected to the source of the n-channel MOS transistor M1 The second current-to-voltage converter (I-V2), including the parallel connection of the diodes D2 and the series-connected resistors R1 and R2, the resistor R3 connected in series with the parallel connection and the resistor R4 connected in parallel with the series connection, is connected to the source of the n-channel MOS transistor M2. The first current-to-voltage converter (I-V1) and the second current-to-voltage converters (I-V2) are grounded by a common resistor R5.

A third current-to-voltage converter (I-V3), including a diode D3, is connected to the source of the n-channel MOS transistor M3. A fourth current-to-voltage converters (I-V4), including a diode D4, is connected between the source of the n-channel MOS transistor M4 and the ground. The third current-to-voltage converter (I-V3) and the fourth current-to-voltage converters (I-V4) are grounded by a common resistor R6. A mid-point terminal of the series-connected resistors R1 and R2 of the second current-to-voltage converter (I-V2) operates as an output terminal of the reference voltage Vref.

The operation of the circuit of FIG. 52 is now described. In FIG. 52, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit.

A common current I2 flows through the p-channel MOS transistor M7 and the n-channel MOS transistor M2 to cause an equal current I4 to flow through the n-channel MOS transistor M4 via the p-channel MOS transistor M8 of the fourth current mirror circuit.

The second current mirror circuit (M3, M4) operates as a current subtraction circuit and controls the coupled gates of the n-channel MOS transistors M1 and M2 of the first current mirror circuit, depending on the large-small relationship of I2 and I1, to cause the two currents I2 and I1 to be equal to each other (I2=I1).

Hence, the currents I1 and I2 are set so as to be equal to each other. In this case, the first current-to-voltage converter (I-V1), including the diode D1, is driven by the current I1. The second current-to-voltage converter (I-V2), including the parallel connection of the diodes D2 and series-connected resistors R1 and R2, the resistor R3 connected in series with the parallel connection of D2 and (R1,R2), and the resistor R4, connected in parallel with the series connection of R3 and the parallel connection of D2 and (R1,R2), is driven by the current I2.

If the currents I1 and I2 are equal to each other, a terminal voltage VA of the first current-to-voltage converter (I-V1) becomes equal to a terminal voltage VB of the second current-to-voltage converter (I-V2). In this case, a mid-point, terminal of the series-connected resistors R1 and R2 of the second current-to-voltage converter (I-V2) outputs a desired reference voltage Vref.

### EXAMPLE 12-4

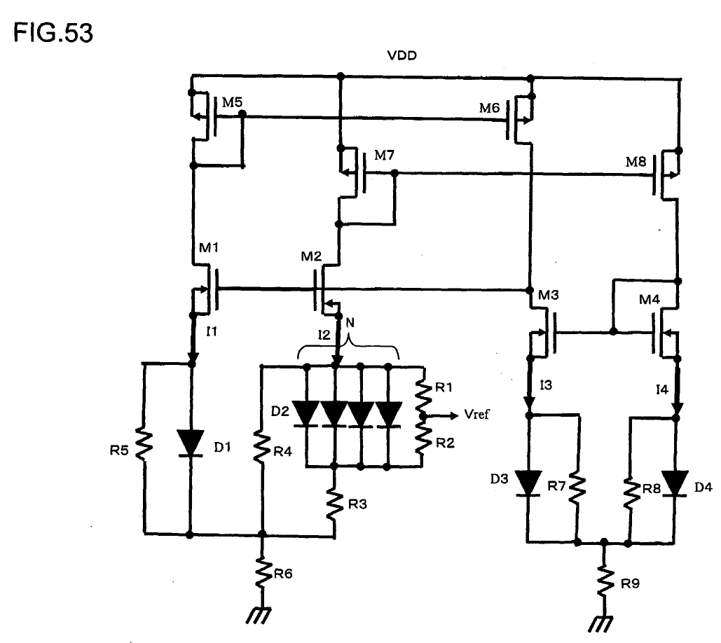

If, in the Example described with reference to FIG. 49, the first current-to-voltage converter (I-V1) and the second current-to-voltage converter (I-V2) are respectively replaced by a first current-to-voltage converter (I-V1) and a second current-to-voltage converter (I-V2) of FIG. 39 that use the original OP amp as control means, a reference voltage circuit may be obtained which uses a current mirror circuit in place of the OP amp to exercise control so that preset voltages will be equal to each other. In FIG. 39, the first current-to-voltage converter (I-V1) includes a parallel connection of a diode D1 and a resistor R5, while the second current-to-voltage converter (I-V2) includes a parallel connection of a plurality of diodes D2 and series-connected resistors R1 and R2, a resistor R3 connected in series with the parallel connection of D2 and (R1,R2), and a resistor R4 connected in parallel with the series connection of R3 and the parallel connection of D2 and (R1,R2). FIG. 53 shows a specific implementing circuit.

The circuit of FIG. 53 uses four current mirror circuits (M1, M2; M3, M4: M5, M6; M7, M8) of FIG. 49 in substitution for the OP amp of FIG. 39. Referring to FIG. 53, the p-channel MOS transistors M5, M6; M7, M8 have sources connected to a power supply VDD and have gates connected in common. The p-channel MOS transistor M5 has a gate and a drain coupled together, and the p-channel MOS transistor M7 has a gate and a drain coupled together. To the drain of the p-channel MOS transistor M6 is connected the drain of the n-channel MOS transistor M3. To the drain of the p-channel MOS transistor M8 is connected the n-channel MOS transistor M4 that has a gate and a drain coupled together. The drain of the n-channel MOS transistor M3 is connected to coupled gates of the n-channel MOS transistors M1 and M2.

The first current-to-voltage converter (I-V1), including the parallel connection of the diode D1 and the resistor R5, is connected to the source of the n-channel MOS transistor M1. The second current-to-voltage converter (I-V2), including the parallel connection of the diodes D2 and series-connected resistors R1 and R2, the resistor R3 connected in series with the parallel connection and the resistor R4 connected in parallel with the series connection, is connected to the source of the n-channel MOS transistor M2. The first current-to-voltage converter (I-V1) and the second current-to-voltage converters (I-V2) are grounded by a common resistor R6. A third current-to-voltage converter (I-V3), including a parallel connection of a diode D3 and a resistor R7, is connected to the source of the n-channel MOS transistor M3. A fourth current-to-voltage converters (I-V4), including a parallel connection of a diode D4 and a resistor R8, is connected between the source of the n-channel MOS transistor M4 and the ground. The third current-to-voltage converter (I-V3) and the fourth current-to-voltage converters (I-V4) are grounded by a common resistor R9.

A mid-point terminal of the series-connected resistors R1 and R2 of the second current-to-voltage converter (I-V2) operates as an output terminal of the reference voltage Vref.

The operation of the circuit of FIG. 53 is now described. In FIG. 53, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit.

A common current I2 flows through the p-channel MOS transistor M7 and the n-channel MOS transistor M2 to cause an equal current I4 to flow through the n-channel MOS transistor M4 via the p-channel MOS transistor M8 of the fourth current mirror circuit. The second current mirror circuit operates as a current subtraction circuit and controls the coupled gates of the n-channel MOS transistors M1 and M2 of the first current mirror circuit, depending on the large-small relationship of I2 and I1, to cause the two currents I2 and I1 to be equal to each other (I2=I1).

Hence, the currents I1 and I2 are set so as to be equal to each other. In this case, the first current-to-voltage converter (I-V1), including the parallel connection of the diode D1 and the resistor R5, is driven by the current I1. The second current-to-voltage converter (I-V2), including the parallel connection of the diodes D2 and series-connected resistors R1 and R2, the resistor R3 connected in series with the parallel connection and the resistor R4, connected in parallel with the series connection, is driven by the current I2.

If the currents I1 and I2 are equal to each other, a terminal voltage VA of the first current-to-voltage converter (I-V1) becomes equal to a terminal voltage VB of the second current-to-voltage converter (I-V2). In this case, a mid-point terminal of the series-connected resistors R1 and R2 of the second current-to-voltage converter (I-V2) outputs a desired reference voltage Vref.

### EXAMPLE 12-5

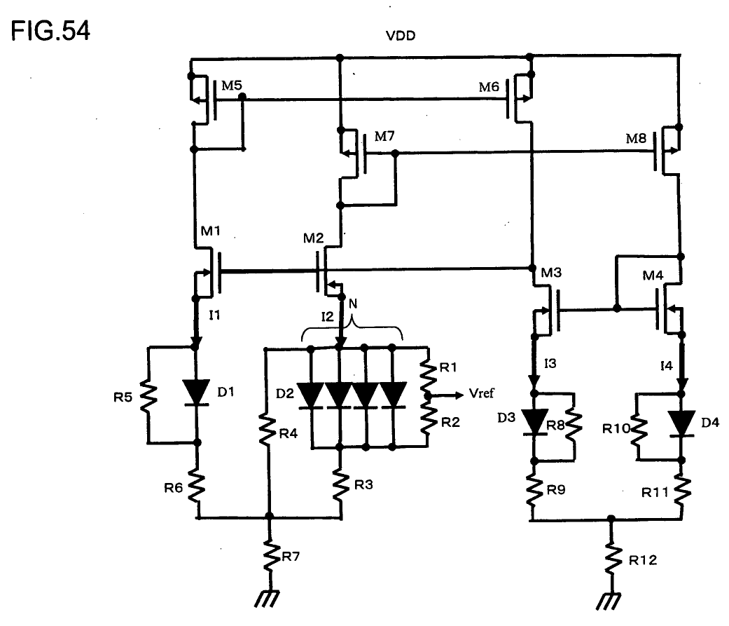

If, in the Example described with reference to FIG. 49, the first current-to-voltage converter (I-V1) and the second current-to-voltage converter (I-V2) are respectively replaced by a first current-to-voltage converter (I-V1) and a second current-to-voltage converter (I-V2) of FIG. 40 that use the original OP amp as control means, a reference voltage circuit may be obtained which uses a current mirror circuit in place of the OP amp to exercise control so that preset voltages will be equal to each other. It is noted that, in FIG. 40, the first current-to-voltage converter (I-V1) includes a parallel connection of a diode D1 and a resistor R5, while the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 54 shows a specific implementing circuit.

The circuit of FIG. 54 uses four current mirror circuits (M1, M2; M3, M4: M5, M6; M7, M8) of FIG. 49 in substitution for the OP amp of FIG. 40. Referring to FIG. 54, the p-channel MOS transistors M5, M6; M7, M8 have sources connected to a power supply VDD and have gates connected in common. The p-channel MOS transistor M5 has a gate and a drain coupled together, and the p-channel MOS transistor M7 has a gate and a drain coupled together. To the drain of the p-channel MOS transistor M6 is connected the drain of the n-channel MOS transistor M3. To the drain of the p-channel MOS transistor M8 is connected the n-channel MOS transistor M4 that has a gate and a drain coupled together. The drain of the n-channel MOS transistor M3 is connected to coupled gates of the n-channel MOS transistors M1 and M2.

The first current-to-voltage converter (I-V1), including the parallel connection of the diode D1 and the resistor R5, is connected to the source of the n-channel MOS transistor M1. The second current-to-voltage converter (I-V2), including the parallel connection of the a plurality of diodes D2 and the series-connected resistors R1 and R2, the resistor R3 connected in series with the parallel connection and the resistor R4 connected in parallel with the series connection, is connected to the source of the n-channel MOS transistor M2. The first current-to-voltage converter (I-V1) and the second current-to-voltage converters (I-V2) are grounded by a common resistor R7.

A third current-to-voltage converter (I-V3), including a parallel connection of a diode D3 and a resistor R8, and a resistor R9 connected in series with the parallel connection of D3 and R8, is connected to the source of the n-channel MOS transistor M3. A fourth current-to-voltage converters (I-V4), including a parallel connection of a diode D4 and a resistor R10 and a resistor R11 connected in series with the parallel connection of D4 and R10, is connected between the source of the n-channel MOS transistor M4 and the ground. The third current-to-voltage converter (I-V3) and the fourth current-to-voltage converters (I-V4) are grounded by a common resistor R12.

A mid-point terminal of the series-connected resistors R1 and R2 of the second current-to-voltage converter (I-V2) operates as an output terminal of the reference voltage Vref.

The operation of the circuit of FIG. 54 is now described. In FIG. 54, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit. A common current I2 flows through the p-channel MOS transistor M7 and the n-channel MOS transistor M2 to cause an equal current I4 to flow through the n-channel MOS transistor M4 via the p-channel MOS transistor M8 of the fourth current mirror circuit. The second current mirror circuit (M3, M4) operates as a current subtraction circuit and controls the coupled gates of the n-channel MOS transistors M1 and M2 of the first current mirror circuit depending on the large-small relationship of I2 and I1 to cause the two currents I2 and I1 to be equal to each other (I2=I1).

Hence, the currents I1 and I2 are set so as to be equal to each other. In this case, the first current-to-voltage converter (I-V1), including the parallel connection of the diode D1 and the resistor R5 and the resistor R6 connected in series with the parallel connection, is driven by the current I1. The second current-to-voltage converter (I-V2), including the parallel connection of the diodes D2 and series-connected resistors R1 and R2, the resistor R3 connected in series with the parallel connection of D2 and (R1,R2), and the resistor R4 connected in parallel with the series connection of R3 and the parallel connection of D2 and (R1,R2), is driven by the current I2. If the currents I1 and I2 are equal to each other, a terminal voltage VA of the first current-to-voltage converter (I-V1) becomes equal to a terminal voltage VB of the second current-to-voltage converter (I-V2). In this case, a mid-point terminal of the series-connected resistors R1 and R2 of the second current-to-voltage converter (I-V2) outputs a desired reference voltage Vref.

### EXAMPLE 12-6

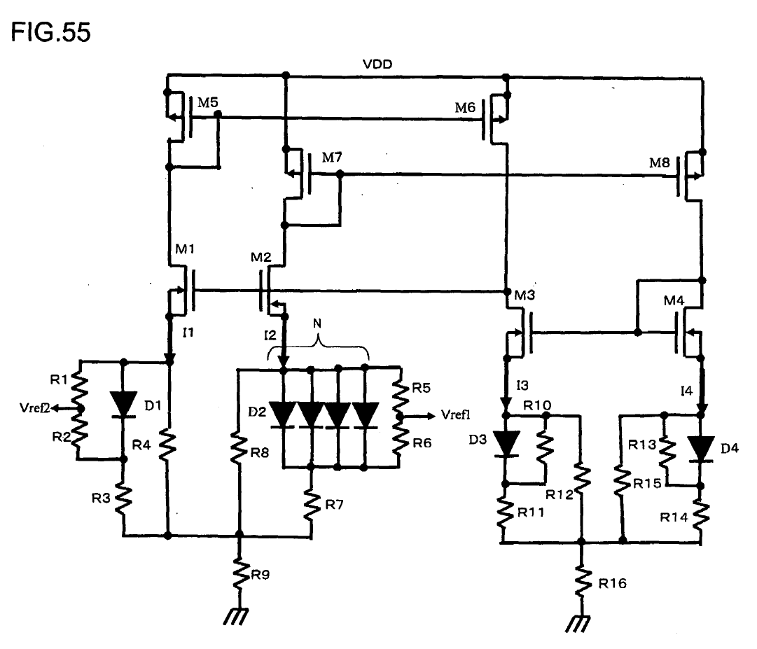

If, in the Example described with reference to FIG. 49, the first current-to-voltage converter (I-V1) and the second current-to-voltage converter (I-V2) are respectively replaced by a first current-to-voltage converter (I-V1) and a second current-to-voltage converter (I-V2) of FIG. 41 that use the original OP amp as control means, a reference voltage circuit may be obtained which uses a current mirror circuit in place of the OP amp to exercise control so that preset voltages will be equal to each other. It is noted that, in FIG. 41, the first current-to-voltage converter (I-V1) includes a parallel connection of a diode D1 and series-connected resistors R1 and R2, a resistor R3 connected in series with the parallel connection and a resistor R4 connected in parallel with the series connection. The second current-to-voltage converter (I-V2) includes a parallel connection of a plurality of diodes D2 and series-connected resistors R5 and R6, a resistor R7 connected in series with the parallel connection of D2 and (R5, R6) and a resistor R8 connected in parallel with the series connection of R7 and the parallel connection of D2 and (R5, R6). FIG. 55 shows a specific implementing circuit.

The circuit of FIG. 55 uses four current mirror circuits (M1, M2; M3, M4: M5, M6; M7, M8) of FIG. 49 in substitution for the OP amp of FIG. 41. Referring to FIG. 55, the p-channel MOS transistors M5, M6; M7, M8 have sources connected to a power supply VDD and have gates connected in common. The p-channel MOS transistor M5 has a gate and a drain coupled together, and the p-channel MOS transistor M7 has a gate and a drain coupled together. To the drain of the p-channel MOS transistor M6 is connected the drain of the n-channel MOS transistor M3. To the drain of the p-channel MOS transistor M8 is connected the n-channel MOS transistor M4 that has a gate and a drain coupled together. The drain of the n-channel MOS transistor M3 is connected to coupled gates of the n-channel MOS transistors M1 and M2.

The first current-to-voltage converter (I-V1), including the parallel connection of the diode D1 and the resistors R1 and R2 connected in series, the resistor R3 connected in series with the parallel connection and the resistor R4 connected in parallel with the series connection, is connected to the source of the n-channel MOS transistor M1. The second current-to-voltage converter (I-V2), including the parallel connection of the diodes D2 and the series-connected resistors R5 and R6, the resistor R7 connected in series with the parallel connection and the resistor R8 connected in parallel with the series connection, is connected to the source of the n-channel MOS transistor M2. The first current-to-voltage converter (I-V1 ) and the second current-to-voltage converters (I-V2) are grounded by a common resistor R9.

A third current-to-voltage converter (I-V3), including a parallel connection of a diode D3 and a resistor R10, a resistor R11 connected in series with the parallel connection of D3 and R10, and a resistor R12 connected in parallel with the series connection of R11 and the parallel connection of D3 and R10, is connected to the source of the n-channel MOS transistor M3. A fourth current-to-voltage converters (I-V4), including a parallel connection of a diode D4 and a resistor R13, a resistor R14 connected in series with the parallel connection of D4 and R13, and a resistor R15 connected in parallel with the series connection of R14 and the parallel connection of D4 and R13, is connected between the source of the n-channel MOS transistor M4 and the ground. The third current-to-voltage converter (I-V3) and the fourth current-to-voltage converters (I-V4) are grounded by a common resistor R16.

A mid-point terminal of the series-connected resistors R5 and R6 of the second current-to-voltage converter (I-V2) and a mid-point terminal of the series-connected resistors R1 and R2 of the first current-to-voltage converter (I-V1) operate as output terminals for the reference voltage Vref1 and the reference voltage Vref2, respectively.

The operation of the circuit of FIG. 55 is now described. In FIG. 55, a common current I1 flows through the p-channel MOS transistor M5 and the n-channel MOS transistor M1 to cause an equal current I3 to flow through the n-channel MOS transistor M3 via the p-channel MOS transistor M6 of the third current mirror circuit. A common current I2 flows through the p-channel MOS transistor M7 and the n-channel MOS transistor M2 to cause an equal current I4 to flow through the n-channel MOS transistor M4 via the p-channel MOS transistor M5 of the fourth current mirror circuit. The second current mirror circuit (M3, M4) operates as a current subtraction circuit and controls the coupled gates of the n-channel MOS transistors M1 and M2 of the first current mirror circuit depending on the large-small relationship of I2 and I1 to cause the two currents I2 and I1 to be equal to each other (I2=I1).

Hence, the currents I1 and I2 are set so as to be equal to each other. In this case, the first current-to-voltage converter (I-V1), including the parallel connection of the diode D1 and the series-connected resistors R1 and R2, the resistor R3 connected in series with the parallel connection and the resistor R4 connected in parallel with the series connection, is driven by the current I1. The second current-to-voltage converter (I-V2), including the parallel connection of the diodes D2 and series-connected resistors R5 and R6, the resistor R7 connected in series with the parallel connection and the resistor R8 connected in parallel with the series connection, is driven by the current I2.

If the currents I1 and I2 are equal to each other, a terminal voltage VA of the first current-to-voltage converter (I-V1) becomes equal to a terminal voltage VB of the second current-to-voltage converter (I-V2). In this case, a mid-point terminal of the series-connected resistors R1 and R2 of the first current-to-voltage converter (I-V1) outputs a desired reference voltage Vref2, while a mid-point terminal of the series-connected resistors R5 and R6 of the second current-to-voltage converter (I-V2) outputs a desired reference voltage Vref1.

### EXAMPLE 13

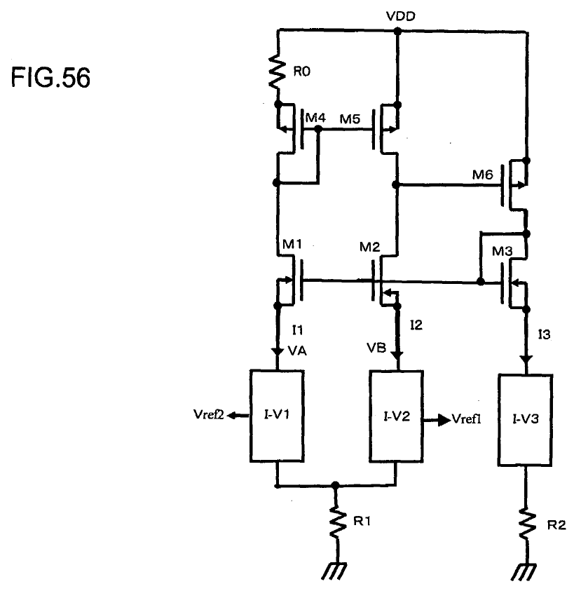

FIG. 56 depicts a diagram, partially shown in blocks, showing an arrangement of a reference voltage circuit according to claim 9 of the present application in a generalized form. In the Example for claim 8 of the present application (FIG. 35), described so far in detail, the OP amp (AP1) is used as control means for controlling preset voltages to be equal to each other. It is however possible to use a current mirror circuit, in place of the OP amp (AP1), as control means for controlling preset voltages to be equal to each other. Specifically, FIG. 35, showing a reference voltage circuit employing a basic OP amp as control means, in a block diagram, may be reformulated as shown in FIG. 56. It should be noted that selecting the first current-to-voltage converter (I-V1) with a smaller number of diodes as the third current-to-voltage converter (I-V3) in the control circuit as in FIG. 56 is in meeting with the objective of reducing the chip area. However, selection of the second current-to-voltage converter (I-V2) with a larger number of the diodes gives the same favorable effect insofar as the circuit operation is concerned.

A reference voltage Vref1 may be obtained from the mid-point terminal of the second current-to-voltage converter (I-V2) as well. Alternatively, depending on the particular circuit used, a reference voltage Vref2 may also be derived from a mid-point terminal of the first current-to-voltage converter (I-V1).

In FIG. 56, the n-channel MOS transistor M3 has a gate and a drain connected in common. The n-channel MOS transistors M1 and M2 constitute a first current mirror circuit.

The p-channel MOS transistor M4 has a gate and a drain connected in common, while having a source connected via a source resistor R0 to a power supply. The p-channel MOS transistor M4 forms a second current mirror circuit along with the p-channel MOS transistor M5.

The second current mirror circuit (M4, M5) is a Widlar current mirror circuit, that is, a non-linear current mirror circuit.

The gate of the p-channel MOS transistor M6 is connected to the drain of the p-channel MOS transistor M5.

The transistors M1 and M4 are cascoded, and the transistors M2 and M5 are cascoded, while the transistors M3 and M6 are also cascoded.

The first current-to-voltage converter (I-V1) and the second current-to-voltage converter (I-V2) are connected respectively to the sources of the transistors M1 and M2, and are grounded by a common resistor R1. The third current-to-voltage converter (I-V3) is connected in series with a resistor R2 and thence grounded.

A mid-point voltage of the second current-to-voltage converter (I-V2) is output as the reference voltage Vref1. Alternatively, a mid-point voltage of the first current-to-voltage converter (I-V1) may be output as the reference voltage Vref2.

The operation of the circuit of FIG. 56 is now described. In FIG. 56, a common current I1 flows through the transistors M1 and M4, and a common current I2 flows through the transistors M2 and M5, while a common current I3 flows also through the transistors M3 and M6.

The second current mirror circuit (M4, M5) is a Widlar current mirror circuit. Hence, if the current I1 that flows through the transistor M4 increases slightly, the current I2 flowing through the transistor M5 increases rapidly.

The current I3 that flows through the transistor M6 then decreases rapidly. The currents I1 and I2 that are in a mirror relationship with respect to the current I3 flowing through the transistor M3 also decrease simultaneously. The steady circuit state is reached when the current I1 flowing through the transistor M4, and the current I2 flowing through the transistor M5 and the current I3 flowing through the transistor M6 are in equilibrium with one another.

Under this control, a terminal voltage VA of the first current-to-voltage converter (I-V1) becomes equal to a terminal voltage VB of the second current-to-voltage converter (I-V2) in case the two currents I1 and I2 become equal to each other.

A reference voltage Vref1 is obtained at this time from the mid-point terminal voltage of the second current-to-voltage converter (I-V2). Depending on the particular circuit used, a reference voltage Vref2 may be derived from the mid-point terminal of the first current-to-voltage converter (I-V1) as well.

### EXAMPLE 13-1

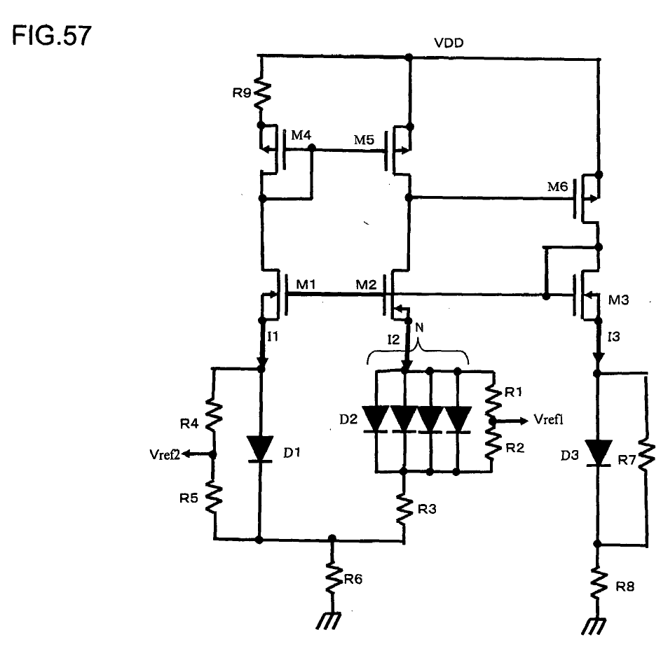

If, in the Example described with reference to FIG. 56, the first current-to-voltage converter (I-V1) and the second current-to-voltage converter (I-V2) are replaced by a first current-to-voltage converter (I-V1) and a second current-to-voltage converter (I-V2) of FIG. 36 that use the original OP amp as control means, respectively, a reference voltage circuit may be obtained which uses a current mirror circuit in place of the OP amp to exercise control so that preset voltages will be equal to each other. It is noted that, in FIG. 36, the first current-to-voltage converter (I-V1 ) includes a parallel connection of a diode D1 and series-connected resistors R4 and R5, while the second current-to-voltage converter (I-V2) includes a parallel connection of a plurality of diodes D2 and series-connected resistors R1 and R2 and a resistor R3 connected in series with the parallel connection. FIG. 57 shows a specific implementing circuit.

The circuit of FIG. 57 uses two current mirror circuits (M1, M2, M3; M4: M5, (M6)) of FIG. 56 in substitution for the OP amp of FIG. 36. Referring to FIG. 57, the n-channel MOS transistor M3, having a gate and a drain coupled together, forms a first current mirror circuit with the n-channel MOS transistors M1 and M2. The p-channel MOS transistor M4, having a gate and a drain coupled together, has a source connected via a source resistor R0 to a power supply VDD. The p-channel MOS transistors M4 and M5 have gates coupled together to form a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The drain of the n-channel MOS transistor M1 is connected to the drain of the p-channel MOS transistor M4 that has a gate and a drain coupled together.

The first current-to-voltage converter (I-V1), including the parallel connection of the diode D1 and the series-connected resistors R4 and R5, is connected to a source of the n-channel MOS transistor M1. The second current-to-voltage converter (I-V2), including the parallel connection of the diodes D2 and the series-connected resistors R1 and R2, and the resistor R3 connected in series with the parallel connection of D2 and (R1, R2), is connected to a source of the n-channel MOS transistor M2. The first current-to-voltage converter (I-V1) and the second current-to-voltage converter (I-V2) are grounded via a common resistor R6.

A third current-to-voltage converter (I-V3), including a parallel connection of a diode D3 and a resistor R7, is connected to a source of the n-channel MOS transistor M3, and is grounded via a series resistor R8.

A mid-point terminal of the series-connected resistors R4 and R5 of the first current-to-voltage converter (I-V1) and a mid-point terminal of the series-connected resistors R1 and R2 of the second current-to-voltage converter (I-V2) operate as output terminals of the reference voltage Vref2 and the reference voltage Vref1, respectively.

The operation of the circuit of FIG. 57 is now described. In FIG. 57, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

The second current mirror circuit (M4, M5) is a Widlar current mirror circuit. Hence, if the current I1 that flows through the transistor M4 increases slightly, the current I2 flowing through the transistor M5 increases rapidly. The current I3 that flows through the transistor M6 then decreases rapidly. The currents I1 and I2 that are in a mirror relationship with respect to the current I3 flowing through the transistor M3 are also decreased simultaneously. The steady circuit state is reached when the current I1 flowing through the transistor M4, and the current I2 flowing through the transistor M5 and the current I3 flowing through the transistor M6 are in equilibrium with one another.

When the two currents I1 and I2 become equal to each other, under this control, a terminal voltage VA of the first current-to-voltage converter (I-V1), including the parallel connection of the diode D1 and the series-connected resistors R4 and R5, becomes equal to a terminal voltage VB of the second current-to-voltage converter (I-V2), including the parallel connection of a plurality of diodes D2 and the series-connected resistors R1 and R2 and the resistor R3 connected in series with the parallel connection.

In this case, a mid-point terminal of the series-connected resistors R1 and R2 of the second current-to-voltage converter (I-V2) outputs a desired reference voltage Vref1, while a mid-point terminal of the series-connected resistors R4 and R5 of the first current-to-voltage converter (I-V1) outputs a desired reference voltage Vref1.

### EXAMPLE 13-2

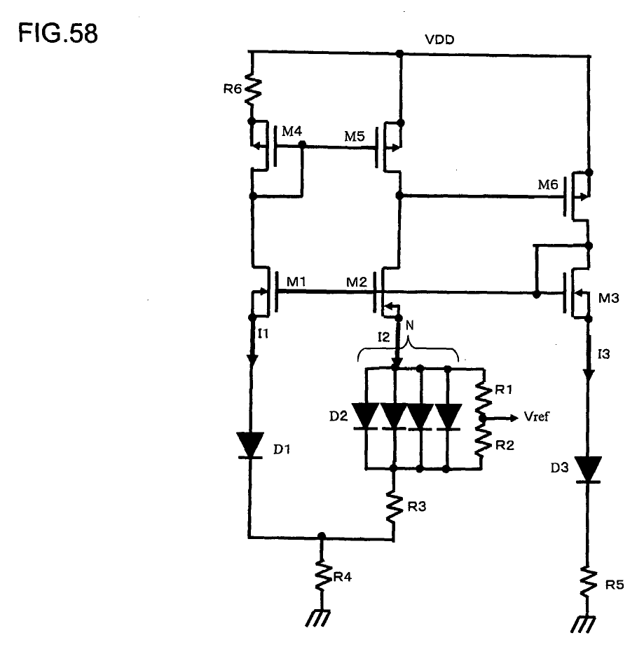

If, in the Example described with reference to FIG. 56, the first current-to-voltage converter (I-V1) and the second current-to-voltage converter (I-V2) are respectively replaced by a first current-to-voltage converter (I-V1) and a second current-to-voltage converter (I-V2) of FIG. 37 that use the original OP amp as control means, a reference voltage circuit may be obtained which uses a current mirror circuit in place of the OP amp to exercise control so that preset voltages will be equal to each other. It is noted that, in FIG. 37, the first current-to-voltage converter (I-V1) includes a diode D1, while the second current-to-voltage converter (I-V2) includes a parallel connection of a plurality of diodes D2 and series-connected resistors R1 and R2 and a resistor R3 connected in series with the parallel connection. FIG. 58 shows a specific implementing circuit.

The circuit of FIG. 58 uses two current mirror circuits (M1, M2, M3; M4: M5, (M6)) of FIG. 56 in substitution for the OP amp of FIG. 37. Referring to FIG. 58, the n-channel MOS transistor M3, having a gate and a drain coupled together, forms a first current mirror circuit along with the n-channel MOS transistors M1 and M2. The p-channel MOS transistor M4, having a gate and a drain coupled together, has a source connected via a source resistor R6 to a power supply VDD. The p-channel MOS transistors M4 and M5 have gates coupled together to form a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The drain of the n-channel MOS transistor M1 is connected to the drain of the p-channel MOS transistor M4 that has a gate and a drain coupled together.

The first current-to-voltage converter (I-V1), including the diode D1, is connected to a source of the n-channel MOS transistor M1. The second current-to-voltage converter (I-V2), including the parallel connection of the diodes D2 and the series-connected resistors R1, R2 and the resistor R3 connected in series with the parallel connection, is connected between a source of the n-channel MOS transistor M2 and the ground. The first current-to-voltage converter (I-V1) and the second current-to-voltage converter (I-V2) are grounded via a common resistor R4.

A third current-to-voltage converter (I-V3), including a diode D3, is connected to a source of the n-channel MOS transistor M3, and is grounded via a series resistor R5.

A mid-point terminal of the series-connected resistors R1 and R2 of the second current-to-voltage converter (I-V2) operates as output terminal of the reference voltage Vref.

The operation of the circuit of FIG. 58 is now described. In FIG. 58, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

The second current mirror circuit (M4, M5) is a Widlar current mirror circuit. Hence, if the current I1 that flows through the transistor M4 increases slightly, the current I2 flowing through the transistor M5 increases rapidly. The current I3 that flows through the transistor M6 then decreases rapidly. The currents I1 and I2 that are in a mirror relationship with respect to the current I3 flowing through the transistor M3 are also decreased simultaneously. The steady circuit state is reached when the current I1 flowing through the transistor M4, the current. I2 flowing through the transistor M5 and the current I3 flowing through the transistor M6 are in equilibrium with one another.

When the two currents I1 and I2 become equal to each other, under this control, a terminal voltage VA of the first current-to-voltage converter (I-V1), including the diode D1, becomes equal to a terminal voltage VB of the second current-to-voltage converter (I-V2), including the parallel connection of the diodes D2 and the series-connected resistors R1 and R2 and the resistor R3 connected in series with the parallel connection.

In this case, a mid-point terminal of the series-connected resistors R1 and R2 of the second current-to-voltage converter (I-V2) outputs a desired reference voltage Vref.

### EXAMPLE 13-3

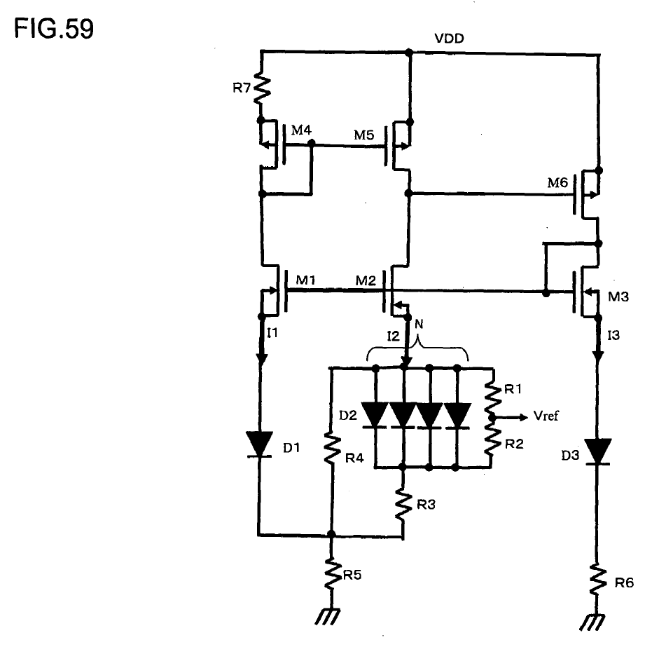

If, in the Example described with reference to FIG. 56, the first current-to-voltage converter (I-V1) and the second current-to-voltage converter (I-V2) are respectively replaced by a first current-to-voltage converter (I-V1) and a second current-to-voltage converter (I-V2) of FIG. 38 that use the original OP amp as control means, a reference voltage circuit may be obtained which uses a current mirror circuit in place of the OP amp to exercise control so that preset voltages will be equal to each other. It is noted that, in FIG. 38, the first current-to-voltage converter (I-V1) includes a diode D1, while the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 59 shows a specific implementing circuit.

The circuit of FIG. 59 uses two current mirror circuits (M1, M2, M3; M4: M5, (M6)) of FIG. 56 in substitution for the OP amp of FIG. 38. Referring to FIG. 59, the n-channel MOS transistor M3, having a gate and a drain coupled together, forms a first current mirror circuit along with the n-channel MOS transistors M1 and M2. The p-channel MOS transistor M4, having a gate and a drain coupled together, has a source connected via a source resistor R7 to a power supply VDD. The p-channel MOS transistors M4 and M5 have gates coupled together to form a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The drain of the n-channel MOS transistor M1 is connected to the drain of the p-channel MOS transistor M4 that has a gate and a drain coupled together.

The first current-to-voltage converter (I-V1), including the diode D1, is connected to a source of the n-channel MOS transistor M1. The second current-to-voltage converter (I-V2), including the parallel connection of a plurality of diodes D2 and the series-connected resistors R1 and R2, the resistor R3 connected in series with the parallel connection and the resistor R4 connected in parallel with the series connection, is connected to a source of the n-channel MOS transistor M2. The first current-to-voltage converter (I-V1) and the second current-to-voltage converter (I-V2) are grounded via a series resistor R5.

A mid-point terminal of the series-connected resistors R1 and R2 of the second current-to-voltage converter (I-V2) operates as output terminal of the reference voltage Vref.

The operation of the circuit of FIG. 59 is now described. In FIG. 59, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

The second current mirror circuit (M4, M5) is a Widlar current mirror circuit. Hence, if the current I1 that flows through the transistor M4 increases slightly, the current I2 flowing through the transistor M5 increases rapidly. The current I3 that flows through the transistor M6 then decreases rapidly. The currents I1 and I2 that are in a mirror relationship with respect to the current I3 flowing through the transistor M3 are also decreased simultaneously. The steady circuit state is reached when the current I1 flowing through the transistor M4, the current I2 flowing through the transistor M5 and the current I3 flowing through the transistor M6 are in equilibrium with one another.

When the two currents I1 and I2 become equal to each other, under this control, a terminal voltage VA of the first current-to-voltage converter (I-V1), including the diode D1, becomes equal to a terminal voltage VB of the second current-to-voltage converter (I-V2), including the parallel connection of the diodes D2 and the series-connected resistors R1 and R2, the resistor R3 connected in series with the parallel connection and the resistor R4 connected in parallel with the series connection.

In this case, a mid-point terminal of the series-connected resistors R1 and R2 of the second current-to-voltage converter (I-V2) outputs a desired reference voltage Vref.

### EXAMPLE 13-4

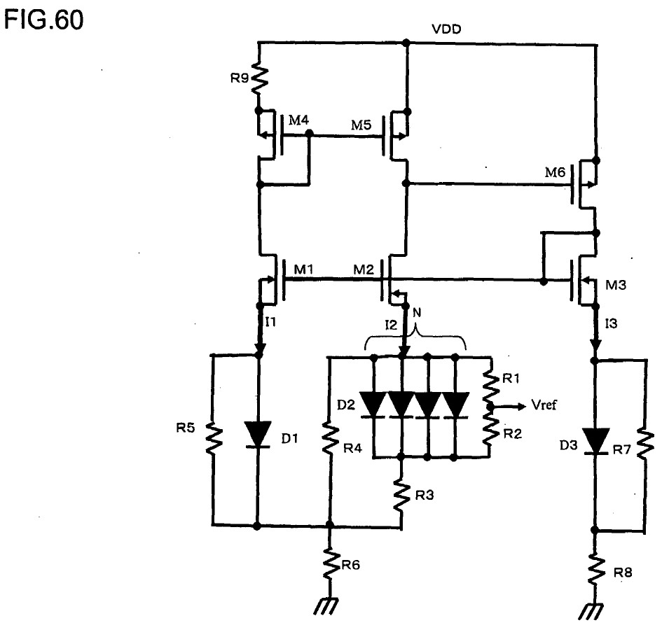

If, in the Example described with reference to FIG. 56, the first current-to-voltage converter (I-V1) and the second current-to-voltage converter (I-V2) are replaced by a first current-to-voltage converter (I-V1) and a second current-to-voltage converter (I-V2) of FIG. 39 that use the original OP amp as control means, respectively, a reference voltage circuit may be obtained which uses a current mirror circuit in place of the OP amp to exercise control so that preset voltages will be equal to each other. It is noted that, in FIG. 39, the first current-to-voltage converter (I-V1) includes a parallel connection of a diode D1 and a resistor R5, while the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 60 shows a specific implementing circuit.

The circuit of FIG. 59 uses two current mirror circuits (M1, M2, M3; M4: M5, (M6)) of FIG. 56 in substitution for the OP amp (AP1) of FIG. 39. Referring to FIG. 60, the n-channel MOS transistor M3, having a gate and a drain coupled together, forms a first current mirror circuit along with the n-channel MOS transistors M1 and M2. The p-channel MOS transistor M4, having a gate and a drain coupled together, has a source connected via a source resistor R9 to a power supply VDD. The p-channel MOS transistors M4 and M5 have gates coupled together to form a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The drain of the n-channel MOS transistor M1 is connected to the drain of the p-channel MOS transistor M4 that has a gate and a drain coupled together.

The first current-to-voltage converter (I-V1), including the parallel connection of the diode D1 and the resistor R5, is connected to a source of the n-channel MOS transistor M1. The second current-to-voltage converter (I-V2), including the parallel connection of the diodes D2 and the series-connected resistors R1 and R2, the resistor R3 connected in series with the parallel connection and the resistor R4 connected in parallel with the series connection, is connected to a source of the n-channel MOS transistor M2. The first current-to-voltage converter (I-V1) and the second current-to-voltage converter (I-V2) are grounded via a series resistor R6. A third current-to-voltage converter (I-V3), including a parallel connection of a diode D3 and a resistor R7, is connected to a source of the n-channel MOS transistor M3, and is grounded via a series resistor R8.

A mid-point terminal of the series-connected resistors R1 and R2 of the second current-to-voltage converter (I-V2) operates as output terminal of the reference voltage Vref.

The operation of the circuit of FIG. 60 is now described. In FIG. 60, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

The second current mirror circuit (M4, M5) is a Widlar current mirror circuit. Hence, if the current I1 that flows through the transistor M4 increases slightly, the current I2 flowing through the transistor M5 increases rapidly. The current I3 that flows through the transistor M6 then decreases rapidly. The currents I1 and I2 that are in a mirror relationship with respect to the current I3 flowing through the transistor M3 are also decreased simultaneously. The steady circuit state is reached when the current I1 flowing through the transistor M4, the current I2 flowing through the transistor M5 and the current I3 flowing through the transistor M6 are in equilibrium with one another. When the two currents I1 and I2 become equal to each other, under this control, a terminal voltage VA of the first current-to-voltage converter (I-V1), including the parallel connection of the diode D1 and the resistor R5, becomes equal to a terminal voltage VB of the second current-to-voltage converter (I-V2), including the parallel connection of a plurality of diodes D2 and the series-connected resistors R1 and R2, the resistor R3 connected in series with the parallel connection and the resistor R4 connected in parallel with the series connection.

In this case, a mid-point terminal of the series-connected resistors R1 and R2 of the second current-to-voltage converter (I-V2) outputs a desired reference voltage Vref.

### EXAMPLE 13-5

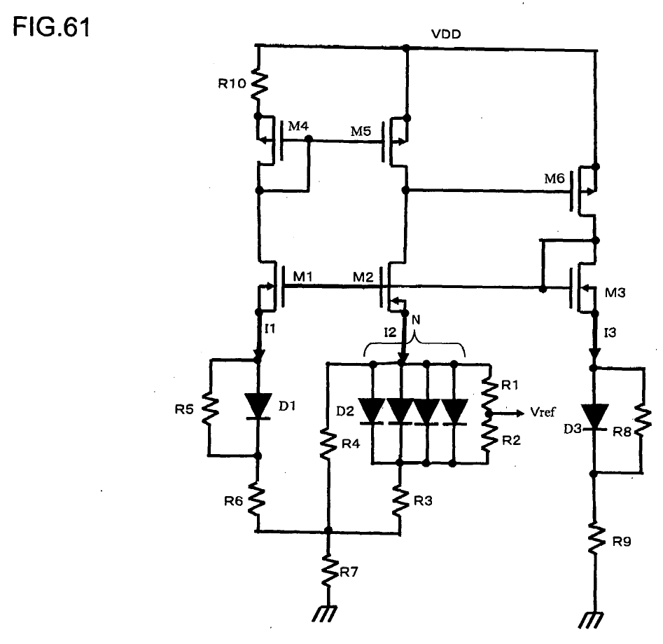

If, in the Example described with reference to FIG. 56, the first current-to-voltage converter (I-V1) and the second current-to-voltage converter (I-V2) are replaced by a first current-to-voltage converter (I-V1) and a second current-to-voltage converter (I-V2) of FIG. 40 that use the original OP amp as control means, respectively, a reference voltage circuit may be obtained which uses a current mirror circuit in place of the OP amp to exercise control so that preset voltages will be equal to each other. It is noted that, in FIG. 40, the first current-to-voltage converter (I-V1) includes a parallel connection of a diode D1 and a resistor R5 and a resistor R6 connected in series with the parallel connection, while the second current-to-voltage converter (I-V2) includes a parallel connection of a plurality of diodes D2 and series-connected resistors R1 and R2, a resistor R3 connected in series with the parallel connection and a resistor R4 connected in parallel with the series connection. FIG. 61 shows a specific implementing circuit.

The circuit of FIG. 61 uses two current mirror circuits (M1, M2, M3; M4: M5, (M6)) of FIG. 56 in substitution for the OP amp of FIG. 40. Referring to FIG. 61, the n-channel MOS transistor M3, having a gate and a drain coupled together, forms a first current mirror circuit along with the n-channel MOS transistors M1 and M2. The p-channel MOS transistor M4, having a gate and a drain coupled together, has a source connected via a source resistor R10 to a power supply VDD. The p-channel MOS transistors M4 and M5 have gates coupled together to form a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The drain of the n-channel MOS transistor M1 is connected to the drain of the p-channel MOS transistor M4 that has a gate and a drain coupled together.

The first current-to-voltage converter (I-V1), including the parallel connection of the diode D1 and the resistor R5 and the resistor R6 connected in series with the parallel connection, is connected between a source of the n-channel MOS transistor M1 and the ground. The second current-to-voltage converter (I-V2), including the parallel connection of the diodes D2 and the series-connected resistors R1 and R2, the resistor R3 connected in series with the parallel connection and the resistor R4 connected in parallel with the series connection, is connected to a source of the n-channel MOS transistor M2. The first current-to-voltage converter (I-V1) and the second current-to-voltage converter (I-V2) are grounded via a common resistor R7.

A third current-to-voltage converter (I-V3), including a parallel connection of a diode D3 and a resistor R8 and a resistor (part of R9) connected in series with the parallel connection, is connected to the source of the n-channel MOS transistor M3, and is grounded via the series resistor (part of R9).

A mid-point terminal of the series-connected resistors R1 and R2 of the second current-to-voltage converter (I-V2) operates as output terminal of the reference voltage Vref.

The operation of the circuit of FIG. 61 is now described. In FIG. 61, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

The second current mirror circuit is a Widlar current mirror circuit. Hence, if the current I1 that flows through the transistor M4 increases slightly, the current I2 flowing through the transistor M5 increases rapidly. The current I3 that flows through the transistor M6 then decreases rapidly. The currents I1 and I2 that are in a mirror relationship with respect to the current I3 flowing through the transistor M3 also decrease simultaneously. The steady circuit state is reached when the current I1 flowing through the transistor M4, the current I2 flowing through the transistor M5 and the current I3 flowing through the transistor M6 are in equilibrium with one another.

When the two currents I1 and I2 become equal to each other, under this control, a terminal voltage VA of the first current-to-voltage converter (I-V1), including the parallel connection of the diode D1 and the resistor R5 and the resistor R6 connected in series with the parallel connection, becomes equal to a terminal voltage VB of the second current-to-voltage converter (I-V2), including the parallel connection of the diodes DZ and the series-connected resistors R1 and R2, the resistor R3 connected in series with the parallel connection and the resistor R4 connected in parallel with the series connection. In this case, a mid-point terminal of the series-connected resistors R1 and R2 of the second current-to-voltage converter (I-V2) outputs a desired reference voltage Vref.

### EXAMPLE 13-6

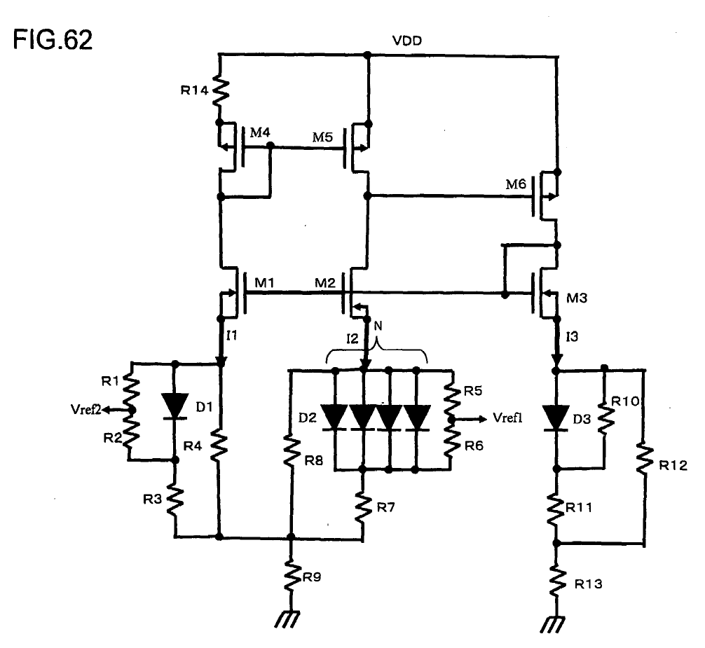

If, in the Example described with reference to FIG. 56, the first current-to-voltage converter (I-V1) and the second current-to-voltage converter (I-V2) are replaced by a first current-to-voltage converter (I-V1) and a second current-to-voltage converter (I-V2) of FIG. 41 that use the original OP amp as control means, respectively, a reference voltage circuit may be obtained which uses a current mirror circuit in place of the OP amp to exercise control so that preset voltages will be equal to each other. It is noted that, in FIG. 41, the first current-to-voltage converter (I-V1) includes a parallel connection of a diode D1 and series-connected resistors R1 and R2, a resistor R3 connected in parallel with the parallel connection and a resistor R4 connected in parallel with the series connection, while the second current-to-voltage converter (I-V2) includes a parallel connection of a plurality of diodes D2 and series-connected resistors R5 and R6, a resistor R7 connected in series with the parallel connection and a resistor R8 connected in parallel with the series connection. FIG. 62 shows a specific implementing circuit.

The circuit of FIG. 62 uses two current mirror circuits (M1, M2, M3; M4: M5, (M6)) of FIG. 56 in substitution for the OP amp of FIG. 41. Referring to FIG. 62, the n-channel MOS transistor M3, having a gate and a drain coupled together, forms a first current mirror circuit along with the n-channel MOS transistors M1 and M2. The p-channel MOS transistor M4, having a gate and a drain coupled together, has a source connected via a source resistor R14 to a power supply VDD. The p-channel MOS transistors M4 and M5 have gates coupled together to form a Widlar current mirror circuit.

The p-channel MOS transistor M6 has a gate connected to a drain of the p-channel MOS transistor M5, while having a drain connected to coupled gates of the n-channel MOS transistors M1, M2 and M3.

The drain of the n-channel MOS transistor M1 is connected to the drain of the p-channel MOS transistor M4 that has a gate and a drain coupled together.

The first current-to-voltage converter (I-V1), including the parallel connection of the diode D1 and the series-connected resistors R1 and R2, the resistor R3 connected in parallel with the parallel connection and the resistor R4 connected in parallel with the series connection, is connected to a source of the n-channel MOS transistor M1. The second current-to-voltage converter (I-V2), including the parallel connection of the diodes D2 and the series-connected resistors R5 and R6, the resistor R7 connected in series with the parallel connection and the resistor R8 connected in parallel with the series connection, is connected to a source of the n-channel MOS transistor M2. The first current-to-voltage converter (I-V1) and the second current-to-voltage converter (I-V2) are grounded via a common resistor R9.

A third current-to-voltage converter (I-V3), including a parallel connection of a diode D3 and a resistor R10, a resistor R11 connected in series with the parallel connection and a resistor R12 connected in parallel with the series connection, is connected to the source of the n-channel MOS transistor M3, and is grounded via the series resistor R13.

A mid-point terminal of the series-connected resistors R1 and R2 of the first current-to-voltage converter (I-V1) operates as output terminal of the reference voltage Vref2, while a mid-point terminal of the series-connected resistors R5 and R6 of the second current-to-voltage converter (I-V2) operates as output terminal of the reference voltage Vref1.

The operation of the circuit of FIG. 62 is now described. In FIG. 62, a common current I1 flows through the p-channel MOS transistor M4 and the n-channel MOS transistor M1. A common current I2 flows through the p-channel MOS transistor M5 and the n-channel MOS transistor M2, while a common current I3 flows through the p-channel MOS transistor M6 and the n-channel MOS transistor M3.

The second current mirror circuit (M4, M5) is a Widlar current mirror circuit. Hence, if the current I1 that flows through the transistor M4 increases slightly, the current I2 flowing through the transistor M5 increases rapidly. The current I3 that flows through the transistor M6 then decreases rapidly. The currents I1 and I2 that are in a mirror relationship with respect to the current I3 flowing through the transistor M3 are also decreased simultaneously. The steady circuit state is reached when the current I1 flowing through the transistor M4, the current I2 flowing through the transistor M5 and the current I3 flowing through the transistor M6 are in equilibrium with one another.

When the two currents I1 and I2 become equal to each other, under this control, a terminal voltage VA of the first current-to-voltage converter (I-V1), including the parallel connection of a diode D1 and series-connected resistors R1 and R2, the resistor R3 connected in parallel with the parallel connection and the resistor R4 connected in parallel with the series connection, becomes equal to a terminal voltage VB of the second current-to-voltage converter (I-V2), including the parallel connection of the diodes D2 and the series-connected resistors R5 and R6, the resistor R7 connected in series with the parallel connection and the resistor R8 connected in parallel with the series connection.

In this case, a mid-point terminal of the series-connected resistors R1 and R2 of the first current-to-voltage converter (I-V1) outputs a desired reference voltage Vref1, while a mid-point terminal of the series-connected resistors R5 and R6 of the second current-to-voltage converter (I-V2) outputs a desired reference voltage Vref1.

Among examples of practical use of the present invention, there are a variety of reference voltage generating circuits. In particular, the power supply voltages to LSIs tend to be decreased in keeping up with ultra-miniaturization of integrated circuit processes. Hence, there persist needs for stabilized reference voltage generating circuits that are subjected to only minor variations with temperature and that may be run in operation with a power supply voltage of about IV. The present invention responds to these needs.

The disclosures of the aforementioned Patent and Non-Patent Documents are incorporated by reference herein. The particular exemplary embodiments or examples may be modified or adjusted within the gamut of the entire disclosure of the present invention, inclusive of claims, based on the fundamental technical concept of the invention. Further, variegated combinations or selection of elements disclosed herein may be made within the framework of the claims. The present invention may encompass various modifications or corrections that may occur to those skilled in the art in accordance with the gamut of the entire disclosure of the present invention, inclusive of claims and the technical concept of the present invention.

What is claimed is:

1. A reference voltage circuit comprising:
a first current-to-voltage converter;
a second current-to-voltage converter;
a current mirror circuit that supplies currents to the first and second current-to-voltage converters; and
a control circuit that exercises control so that a preset output voltage of the first current-to-voltage converter will be equal to a preset output voltage of the second current-to-voltage converter;
at least one of a mid-point terminal voltage of the first current-to-voltage converter and a mid-point terminal voltage of the second current-to-voltage converter being used as a reference voltage.

2. The reference voltage circuit according to claim 1, wherein
the first current-to-voltage converter includes:
a diode; and
a resistor connected in parallel with the diode; and
the second current-to-voltage converter includes:
a plurality of diodes connected in parallel;
a first resistor connected in parallel with the parallel connected diodes; and
a second resistor connected in series with the parallel connection of the diodes and the first resistor;
a mid-point terminal voltage of the first resistor of the second current-to-voltage converter being used as the reference voltage.

3. The reference voltage circuit according to claim 1, wherein
the first current-to-voltage converter includes a diode; and
the second current-to-voltage converter includes:
a plurality of diodes connected in parallel;
a first resistor connected in parallel with the parallel connected diodes; and
a second resistor connected in series with the parallel connection of the diodes and the first resistor;
a mid-point terminal voltage of the first resistor of the second current-to-voltage converter being used as the reference voltage.

4. The reference voltage circuit according to claim 1, wherein
the first current-to-voltage converter includes a diode; and
the second current-to-voltage converter includes:
a plurality of diodes connected in parallel;
a first resistor connected in parallel with the diodes;
a second resistor connected in series with the parallel connection of the diodes and the first resistor; and
a third resistor connected in parallel with the series connection of the second resistor and the parallel connection of the diodes and the first resistor;
a mid-point terminal voltage of the first resistor of the second current-to-voltage converter being used as a reference voltage.

5. The reference voltage circuit according to claim 1, wherein
the first current-to-voltage converter includes:
a diode; and
a first resistor connected in parallel with the diode; and
the second current-to-voltage converter includes:
a plurality of diodes connected in parallel
a first resistor connected in parallel with the diodes;
a second resistor connected in series with the parallel connection of the diodes and the first resistor; and
a third resistor connected in parallel with the series connection of the second resistor and the parallel connection of the diodes and the first resistor;
a mid-point terminal voltage of the first resistor of the second current-to-voltage converter being used as a reference voltage.

6. The reference voltage circuit according to claim 1, wherein
the first current-to-voltage converter includes:
a diode;
a first resistor connected in parallel with the diode; and
a second resistor connected in series with the parallel connection of the diode and the first resistor; and
the second current-to-voltage converter includes:
a plurality of diodes connected in parallel
a third resistor connected in parallel with the parallel-connected diodes;
a fourth resistor connected in series with the parallel connection of the parallel-connected diodes and the third resistor; and
a fifth resistor connected in parallel with the series connection of the fourth resistor and the parallel connection of the parallel-connected diodes and the third resistor;
a mid-point terminal voltage of the third resistor of the second current-to-voltage converter being used as a reference voltage.

7. The reference voltage circuit according to claim 1, wherein
the first current-to-voltage converter includes:
a diode;
a first resistor connected in parallel with the diode; and
a second resistor connected in series with the parallel connection of the diode and the first resistor; and
a third resistor connected in parallel with the series connection of the second resistor and the parallel connection of the diode and the first resistor; and
the second current-to-voltage converter includes:
a plurality of diodes connected in parallel;
a fourth resistor connected in parallel with the parallel-connected diodes;
a fifth resistor connected in series with the parallel connection of the parallel-connected diodes and the fourth resistor; and
a sixth resistor connected in parallel with the series connection of the fifth resistor and the parallel connection of the parallel-connected diodes and the fourth resistor;
at least one of a mid-point terminal voltage of the parallel-connected first resistor of the first current-to-voltage converter and a mid-point terminal voltage of the parallel-connected fourth resistor of the second current-to-voltage converter being used as a reference voltage.

8. A reference voltage circuit comprising:
a first current-to-voltage converter;
a second current-to-voltage converter;
a resistor connected in common to the first current-to-voltage converter and the second current-to-voltage converter;
a current mirror circuit that supplies currents to the first current-to-voltage converter and the second current-to-voltage converter; and
a control circuit that exercises control so that a preset output voltage of the first current-to-voltage converter and a preset output voltage of the second current-to-voltage converter will be equal to each other;
a mid-point terminal voltage at least one of the first current-to-voltage converter and the second current-to-voltage converter being used as a reference voltage.

9. The reference voltage circuit according to claim 8, wherein
the first current-to-voltage converter includes:
a diode; and
a resistor connected in parallel with the diode; and
the second current-to-voltage converter includes:
a plurality of diodes connected in parallel;
a first resistor connected in parallel with the parallel connected diodes; and
a second resistor connected in series with the parallel connection of the diodes and the first resistor;
a mid-point terminal voltage of the first resistor of the second current-to-voltage converter being used as the reference voltage.

10. The reference voltage circuit according to claim 8, wherein
the first current-to-voltage converter includes a diode; and
the second current-to-voltage converter includes:
a plurality of diodes connected in parallel;
a first resistor connected in parallel with the parallel connected diodes; and
a second resistor connected in series with the parallel connection of the diodes and the first resistor;
a mid-point terminal voltage of the first resistor of the second current-to-voltage converter being used as the reference voltage.

11. The reference voltage circuit according to claim 8, wherein
the first current-to-voltage converter includes a diode; and
the second current-to-voltage converter includes:
a plurality of diodes connected in parallel;
a first resistor connected in parallel with the diodes;
a second resistor connected in series with the parallel connection of the diodes and the first resistor; and
a third resistor connected in parallel with the series connection of the second resistor and the parallel connection of the diodes and the first resistor;
a mid-point terminal voltage of the first resistor of the second current-to-voltage converter being used as a reference voltage.

12. The reference voltage circuit according to claim 8, wherein
the first current-to-voltage converter includes:
a diode; and
a first resistor connected in parallel with the diode; and
the second current-to-voltage converter includes:
a plurality of diodes connected in parallel;
a first resistor connected in parallel with the diodes;
a second resistor connected in series with the parallel connection of the diodes and the first resistor; and
a third resistor connected in parallel with the series connection of the second resistor and the parallel connection of the diodes and the first resistor;
a mid-point terminal voltage of the first resistor of the second current-to-voltage converter being used as a reference voltage.

13. The reference voltage circuit according to claim 8, wherein
the first current-to-voltage converter includes:
a diode;
a first resistor connected in parallel with the diode; and
a second resistor connected in series with the parallel connection of the diode and the first resistor; and
the second current-to-voltage converter includes:
a plurality of diodes connected in parallel;
a third resistor connected in parallel with the parallel-connected diodes;
a fourth resistor connected in series with the parallel connection of the parallel-connected diodes and the third resistor; and
a fifth resistor connected in parallel with the series connection of the fourth resistor and the parallel connection of the parallel-connected diodes and the third resistor;
a mid-point terminal voltage of the third resistor of the second current-to-voltage converter being used as a reference voltage.

14. The reference voltage circuit according to claim 8, wherein
the first current-to-voltage converter includes:
a diode;
a first resistor connected in parallel with the diode; and
a second resistor connected in series with the parallel connection of the diode and the first resistor; and
a third resistor connected in parallel with the series connection of the second resistor and the parallel connection of the diode and the first resistor; and
the second current-to-voltage converter includes:
a plurality of diodes connected in parallel;
a fourth resistor connected in parallel with the parallel-connected diodes;
a fifth resistor connected in series with the parallel connection of the parallel-connected diodes and the fourth resistor; and
a sixth resistor connected in parallel with the series connection of the fifth resistor and the parallel connection of the parallel-connected diodes and the fourth resistor;
at least one of a mid-point terminal voltage of the parallel-connected first resistor of the first current-to-voltage converter and a mid-point terminal voltage of the parallel-connected fourth resistor of the second current-to-voltage converter being used as a reference voltage.

15. The reference voltage circuit according to claim 1, wherein
the control circuit includes an operational amplifier; a non-inverting input terminal and an inverting input terminal of the operational amplifier receiving two terminal voltages; an output terminal of the operational amplifier being connected to a common gate of the current mirror circuit.

16. The reference voltage circuit according to claim 8, wherein
the control circuit includes an operational amplifier; a non-inverting input terminal and an inverting input terminal of the operational amplifier receiving two terminal voltages; an output terminal of the operational amplifier being connected to a common gate of the current mirror circuit.

17. The reference voltage circuit according to claim 1, wherein
the control circuit includes a first current mirror circuit and a second current mirror circuit,
the first current mirror circuit including transistors differing in polarity from transistors of the second current mirror circuit,
first and second transistors of the first current mirror circuit having sources connected to the first and second current-to-voltage converters,
the first transistor having a gate and a drain connected in common and being connected to a drain of a third transistor of the second current mirror circuit,
a fourth transistor of the second current mirror circuit having a gate and a drain connected in common,
the fourth transistor being connected to a drain of the second transistor.

18. The reference voltage circuit according to claim 8, wherein
the control circuit includes a first current mirror circuit and a second current mirror circuit,
the first current mirror circuit including transistors differing in polarity from transistors of the second current mirror circuit,
first and second transistors of the first current mirror circuit having sources connected to the first and second current-to-voltage converters,
the first transistor having a gate and a drain connected in common and being connected to a drain of a third transistor of the second current mirror circuit,
a fourth transistor of the second current mirror circuit having a gate and a drain connected in common,
the fourth transistor being connected to a drain of the second transistor.

19. The reference voltage circuit according to claim 1, wherein
the control circuit includes first to fourth current mirror circuits,
the transistors of the first and second current mirror circuits being of the same polarity,
the transistors of the third and fourth current mirror circuits being of the same polarity and different in polarity from the transistors of the first and second current mirror circuits;
the sources of first and second transistors constituting the first current mirror circuit being respectively connected to the first and second current-to-voltage converters,
the coupled gates of the first and second transistors being connected to the drain of the third transistor out of the third and fourth transistors that constitute the second current mirror circuit,
the fourth transistor having a gate and a drain connected in common,
the drain of the first transistor and the drain of the second transistor being respectively connected to the fifth and seventh transistors, both having the gates and the drains connected in common, out of fifth and sixth transistors that constitute the third current mirror circuit and seventh and eighth transistors that constitute the fourth current mirror circuit,
the drain of the first transistor and the drain of the second transistor being respectively connected via the sixth and eighth transistors to the third and fourth transistors,
the sources of the third and fourth transistors being respectively connected to third and fourth current-to-voltage converters equivalent to the first current-to-voltage converter or to the second current-to-voltage converter.

20. The reference voltage circuit according to claim 8, wherein
the control circuit includes first to fourth current mirror circuits,
the transistors of the first and second current mirror circuits being of the same polarity,
the transistors of the third and fourth current mirror circuits being of the same polarity and different in polarity from the transistors of the first and second current mirror circuits,
the sources of first and second transistors constituting the first current mirror circuit being respectively connected to the first and second current-to-voltage converters,
the coupled gates of the first and second transistors being connected to the drain of the third transistor out of the third and fourth transistors that constitute the second current mirror circuit,
the fourth transistor having a gate and a drain connected in common,
the drain of the first transistor and the drain of the second transistor being respectively connected to the fifth and seventh transistors, both having the gates and the drains connected in common, out of fifth and sixth transistors that constitute the third current mirror circuit and seventh and eighth transistors that constitute the fourth current mirror circuit,
the drain of the first transistor and the drain of the second transistor being respectively connected via the sixth and eighth transistors to the third and fourth transistors,
the sources of the third and fourth transistors being respectively connected to third and fourth current-to-voltage converters equivalent to the first current-to-voltage converter or to the second current-to-voltage converter.

21. The reference voltage circuit according to claim 1, wherein
the control circuit includes:
first and second current mirror circuits,
first to third transistors that constitute the first current mirror circuit differing in polarity from fourth to sixth transistors that constitute the second current mirror circuit,
the sources of the first and second transistors in the first current mirror circuit being respectively connected to the first and second current-to-voltage converters,
the coupled gates of the first and second transistors being connected to the gate and the drain of the third transistor connected in common,
the source of the third transistor being connected to a third current-to-voltage converter equivalent to the first or second current-to-voltage converter,
the fourth transistor in the second current mirror circuit having a gate and a drain connected in common and connected to the drain of the first transistor,
the fourth transistor having a source connected via a resistor to a power supply,
the fourth and fifth transistors having gates connected in common to form a reverse Widlar current mirror circuit,
the fifth transistor having a drain connected to a drain of the second transistor and to a gate of the sixth transistor,
the sixth transistor having a drain connected to a drain of the third transistor and having a source connected to a power supply.

22. The reference voltage circuit according to claim 8, wherein
the control circuit includes:
first and second current mirror circuits,
first to third transistors that constitute the first current mirror circuit differing in polarity from fourth to sixth transistors that constitute the second current mirror circuit,
the sources of the first and second transistors in the first current mirror circuit being respectively connected to the first and second current-to-voltage converters,
the coupled gates of the first and second transistors being connected to the gate and the drain of the third transistor connected in common,
the source of the third transistor being connected to a third current-to-voltage converter equivalent to the first or second current-to-voltage converter,
the fourth transistor in the second current mirror circuit having a gate and a drain connected in common and connected to the drain of the first transistor,
the fourth transistor having a source connected via a resistor to a power supply,
the fourth and fifth transistors having gates connected in common to form a reverse Widlar current mirror circuit,
the fifth transistor having a drain connected to a drain of the second transistor and to a gate of the sixth transistor,
the sixth transistor having a drain connected to a drain of the third transistor and having a source connected to a power supply.

23. The reference voltage circuit according to claim 1, wherein
the diode is a diode-connected bipolar transistor.

24. The reference voltage circuit according to claim 8, wherein
the diode is a diode-connected bipolar transistor.

25. A semiconductor device including the reference voltage circuit as set forth in claim 1.

26. A semiconductor device including the reference voltage circuit as set forth in claim 8.
